(19) United States
(12) Patent Application Publication
(10) Pub. No.: US 2023/0166257 A1
(43) Pub. Date: Jun. 1, 2023

(54) MICROFLUIDIC DEVICES WITH GAS CHANNELS FOR SAMPLE NEBULIZATION

(71) Applicant: INTABIO, LLC, Washington, DC (US)

(72) Inventors: Scott Mack, Boulder Creek, CA (US); Wesley Chang, Fremont, CA (US); Eric Gwerder, Pleasanton, CA (US); Ian Walton, Redwood City, CA (US); Donald Wesley Arnold, Livermore, CA (US)

(21) Appl. No.: 17/920,881

(22) PCT Filed: Apr. 27, 2021
(86) PCT No.: PCT/US2021/029292

§ 371 Date: Oct. 24, 2022

Related U.S. Application Data
(60) Provisional application No. 63/016,880, filed on Apr. 28, 2020.

(51) Int. Cl. B01L 3/00; H01J 49/16

(52) U.S. Cl. CPC B01L 3/502784; B01L 3/502776; H01J 49/165; B01L 2300/12; B01L 2300/0867; B01L 2200/0636

(57) ABSTRACT

Methods, devices, and systems for performing nebulization of a sample from a fluid channel of a microfluidic device are described. The systems or devices disclosed herein may comprise microfluidic devices that comprise a gas channel used for nebulization of the sample at a fluid outlet of the microfluidic device. In some instances, the disclosed devices may be designed to perform isoelectric focusing followed by further characterization of the separated analytes using electrospray ionization coupled with nebulization to introduce the samples into a mass spectrometer. The disclosed methods, devices, and systems provide for fast, accurate separation and characterization of protein analyte mixtures or other biological molecules by isoelectric point.

### CROSS-REFERENCE TO RELATED APPLICATION

This application claims priority to U.S. Patent Application No. 63/016,880, filed Apr. 28, 2020, which is entitled, “Microfluidic Devices with Gas Channels for Sample Nebulization”. The '880 application is incorporated by reference herein in its entirety.

### BACKGROUND

Separation of analyte components from a more complex analyte mixture on the basis of an inherent quality of the analytes and providing sets of fractions that are enriched for states of that quality is a key part of analytical chemistry. Simplifying complex mixtures in this manner reduces the complexity of downstream analysis. However, complications can arise when attempting to interface known enrichment methods and/or devices with analytical equipment and/or techniques, such as mass spectrometry. For example, a method to introduce samples into a mass spectrometer is electrospray ionization (ES I). In ESI, however, the formation of large droplets can introduce contaminants and negatively impact the analytical performance of mass spectrometry.

### SUMMARY

Recognized herein is a need for methods, devices, and systems for reducing droplet size and contamination prior to and during the introduction of samples into a mass spectrometer. Disclosed herein are methods, devices, and systems for sample processing and characterization, and various uses thereof. In a first aspect, this disclosure relates to methods, devices, and systems for performing separation and characterization of analytes in a mixture of analytes, and more specifically to devices (and related methods and systems) for nebulizing samples prior to or during electrospray ionization. In a second aspect, this disclosure relates to microfluidic devices (and related methods and systems) designed to perform one or more separation reactions (e.g., isoelectric focusing) followed by mobilization, nebulization, and electrospray ionization of the separated analytes for characterization by mass spectrometry.

Provided herein are methods, devices, and systems that enable improved quantitative performance for the separation and analysis of analytes in an analyte mixture, with potential applications in biomedical research, clinical diagnostics, and pharmaceutical manufacturing. For example, rigorous characterization of biologic drugs and drug candidates (e.g., proteins) are required by regulatory agencies. The methods and devices described herein may be suitable for characterizing proteins and/or other analytes. In some instances, the methods and devices described herein may relate to characterizing an analyte mixture wherein one or more enrichment steps are performed to separate an analyte mixture into enriched analyte fractions. In some instances, the methods and devices described herein may relate to performing one or more enrichment steps to separate an analyte mixture into enriched analyte fractions in a multiplexed format for high throughput characterization of samples. In some instances, the methods and devices described herein relate to characterizing an analyte mixture wherein one or more enrichment steps are performed to separate an analyte mixture into enriched analyte fractions that are subsequently introduced into a mass spectrometer via an electrospray ionization interface. In some instances, the methods and devices described herein include the use of one or more gas channels to nebulize a sample during electrospray ionization, thereby decreasing the droplet size of the sample introduced into an analytical instrument (e.g., mass spectrometer). In some instances, the methods and devices described herein include the use of one or more microfluidic devices that include one or more gas channels to nebulize a sample during electrospray ionization. The disclosed methods and devices may provide improvements in convenience, reproducibility, and/or analytical performance of analyte separation and characterization.

In an aspect, disclosed herein is a microfluidic chip comprising: a) a substrate, wherein the substrate comprises: i) a fluid channel comprising a distal end that is in fluid communication with an electrospray ionization orifice; and ii) a gas channel comprising a distal end that is in fluid communication with a gas outlet orifice disposed adjacent to the electrospray ionization orifice; wherein an angle between the distal end of the fluid channel and the distal end of the gas channel ranges from about 0 degrees to about 30 degrees.

In some embodiments, the electrospray ionization orifice is disposed on an edge or corner or tip of the substrate. In some embodiments, the gas outlet orifice is disposed an edge of the substrate adjacent to the electrospray ionization orifice. In some embodiments, the substrate comprises two or more gas channels, each of which comprises a distal end that is in fluid communication with a gas outlet orifice. In some embodiments, the two or more gas outlet orifices are disposed adjacent to and symmetrically about the electrospray ionization orifice. In some embodiments, the angle ranges from about 10 degrees to about 20 degrees. In some embodiments, the angle is about 15±5 degrees. In some embodiments, the gas outlet orifice is configured to perform nebulization of a solution expelled from the electrospray ionization orifice. In some embodiments, the microfluidic device comprises three or more gas channels each comprising a gas outlet orifice disposed adjacent to the electrospray ionization orifice. In some embodiments, at least one of the three or more gas channels are disposed within the substrate, and at least one of the three or more gas channels are disposed within an auxiliary component of the microfluidic chip that is positioned adjacent to the substrate such that the at least one gas channels are not located within a same plane as the substrate. In some embodiments, the at least one of the three or more gas channels disposed within the auxiliary component are positioned such that their gas outlet orifices lie in a plane that is substantially perpendicular to that of the substrate and are positioned symmetrically about and adjacent to the electrospray ionization orifice. In some embodiments, the at least one of the three or more gas channels that are disposed within the auxiliary component are positioned such that their gas outlet orifices lie in one or more planes that are rotated relative to that of the substrate and are positioned in a radially-symmetric pairwise manner about and adjacent to the electrospray ionization orifice. In some embodiments, the fluid channel comprises a separation channel. In some embodiments, the microfluidic chip is configured to perform an isoelectric focusing or electrophoretic separation of a sample comprising a mixture of analytes in the fluid channel. In some embodiments, the fluid channel has a width ranging from about 20 μm to about 600 μm. In some embodiments, the fluid channel has a depth ranging from about 10 μm to about 100 μm. In some embodiments, the fluid channel has a length ranging from about 0.25 cm to about 30 cm. In some embodiments, the electrospray ionization orifice has a substantially square, rectangular, circular, ovoid, or lozenge-shaped cross-section. In some embodiments, the electrospray ionization orifice has a maximum cross-sectional dimension ranging from about 10 μm to about 100 μm. In some embodiments, the gas channel has a width ranging from about 20 μm to about 200 μm. In some embodiments, the gas channel has a depth ranging from about 10 μm to about 100 μm. In some embodiments, the gas channel has a length ranging from about 0.2 cm to about 20 cm. In some embodiments, the gas outlet orifice has a substantially square, rectangular, circular, ovoid, or lozenge-shaped cross-section. In some embodiments, the gas outlet orifice has a maximum cross-sectional dimension ranging from about 10 μm to about 50 μm. In some embodiments, the gas outlet orifice is disposed within 100 μm of the electrospray ionization orifice. In some embodiments, the gas outlet orifice is disposed within 50 μm of the electrospray ionization orifice. In some embodiments, the gas outlet orifice is disposed within 10 μm of the electrospray ionization orifice. In some embodiments, the substrate is fabricated from glass, silicon, a polymer, or any combination thereof.

In another aspect of the present disclosure, provided herein is a microfluidic chip comprising: a) a substrate, wherein the substrate comprises: i) two or more gas channels of different lengths, each configured to deliver a gas to a gas outlet orifice; wherein a dimension of at least one of the two or more gas channels is adjusted along a portion of its length so that each of the two or more gas channels has about the same hydrodynamic flow resistance.

In some embodiments, a cross-sectional area of at least one of the two or more gas channels is adjusted along a portion of its length. In some embodiments, a minimum difference in length of the two or more gas channels ranges from about 1 cm to about 10 cm. In some embodiments, a maximum difference in length of the two or more gas channels ranges from about 1 cm to about 10 cm. In some embodiments, the substrate further comprises a fluid channel comprising a distal end that is in fluid communication with an electrospray ionization orifice. In some embodiments, the two or more gas outlet orifices are disposed symmetrically about and adjacent to the electrospray ionization orifice and are configured to perform nebulization of a solution expelled from the electrospray ionization orifice. In some embodiments, the electrospray ionization orifice is disposed on an edge or corner of the substrate. In some embodiments, the two or more gas outlet orifices are disposed on an edge of the substrate adjacent to the electrospray ionization orifice. In some embodiments, the fluid channel comprises a separation channel. In some embodiments, the microfluidic chip is configured to perform isoelectric focusing or electrophoretic separations. In some embodiments, the gas is a nebulizer gas. In some embodiments, the nebulizer gas comprises, air, nitrogen, oxygen, nitrous oxide, fluorourethane, helium, argon, methanol, or any combination thereof. In some embodiments, the microfluidic chip further comprises a hydrophobic coating on at least a portion of an edge of the substrate or corner of the substrate on which the electrospray ionization orifice is disposed.

In another aspect, disclosed herein is a microfluidic chip comprising: a substrate, wherein the substrate comprises: i) a fluid channel comprising a proximal end that is in fluid communication with a fluid inlet port and a distal end that is in fluid communication with an electrospray ionization orifice; and ii) at least two gas channels, each comprising a proximal end that is in fluid communication with a gas inlet port and a distal end in fluid communication with a gas outlet orifice; wherein the at least one fluid inlet port and the at least two gas inlet ports are disposed along a first edge of the substrate.

In some embodiments, the electrospray ionization orifice is positioned on a second edge of the substrate. In some embodiments, the electrospray ionization orifice is positioned on a corner of the substrate that does not comprise the first edge. In some embodiments, the substrate is less than about 2.0 mm thick. In some embodiments, the fluid channel comprises a separation channel configured to perform an electrophoretic separation. In some embodiments, the fluid channel comprises a separation channel configured to perform an isoelectric focusing separation. In some embodiments, the substrate comprises a first separation channel and a second separation channel, wherein a distal end of the first separation channel is in fluid communication with a proximal end of the second separation channel, and wherein a distal end of the second separation channel is in fluid communication with the electrospray ionization orifice. In some embodiments, the first separation channel is configured to perform a chromatographic separation, and wherein the second separation channel is configured to perform an electrophoretic separation. In some embodiments, the first separation channel is configured to perform a chromatographic separation, and wherein the second separation channel is configured to perform an isoelectric focusing separation. In some embodiments, the fluid channel comprises a separation channel configured to perform isoelectric focusing separation of a sample comprising a mixture of analytes, and the substrate further comprises a mobilization electrolyte channel that is in fluid communication with a distal end of the separation channel and is configured to provide electrophoretic introduction of a mobilization electrolyte at the distal end of the separation channel.

Disclosed herein, in another aspect, is a method for performing electrospray ionization from a microfluidic chip comprising: a) providing a microfluidic chip comprising a substrate, wherein the substrate comprises: i) at least one fluid channel comprising a distal end that is in fluid communication with an electrospray ionization orifice; and ii) at least one gas channel configured to deliver a gas to a gas outlet orifice that is adjacent to the electrospray ionization orifice; b) flowing a solution through the at least one fluid channel such that the solution is expelled from the electrospray ionization orifice; and c) flowing a gas through the at least one gas channel such that the gas is expelled from the gas outlet orifice; wherein a temperature of the substrate is controlled by a temperature of the gas flowing through the at least one gas channel.

In some embodiments, the temperature of the gas ranges from about 4° C. to about 100° C. In some embodiments, the temperature of the substrate ranges from about 10° C. to about 50° C. In some embodiments, the average temperature of the substrate is held at 30±5° C. In some embodiments, the at least one fluid channel comprises a separation channel. In some embodiments, the separation channel is configured to perform an isoelectric focusing separation of a sample comprising a mixture of analytes. In some embodiments, the separation channel is configured to perform an electrophoretic separation of a sample comprising a mixture of analytes. In some embodiments, an electrospray ionization performance achieved when the microfluidic chip is configured to introduce a sample into a mass spectrometer is characterized by a less than a 1.0% standard error fluctuation in total mass spectrometric signal intensity. In some embodiments, an electrospray ionization performance when the microfluidic chip is configured to introduce a sample into a mass spectrometer is characterized by a less than a 0.1% standard error fluctuation in total mass spectrometric signal intensity.

In yet another aspect, disclosed herein is a method for providing stable electrospray ionization performance comprising: a) providing a microfluidic chip comprising a substrate, wherein the substrate comprises: (i) a fluid channel having a distal end that is in fluid communication with an electrospray ionization orifice, and (ii) a gas channel having a distal end that is in fluid communication with a gas outlet orifice; b) flowing a solution through the fluid channel; c) flowing a gas through the gas channel; and d) controlling a flow rate of the gas and a flow rate of the solution such that a ratio of volumetric flow rates for the gas and solution ranges from 1000:1 to 1,000,000:1. In some embodiments, the ratio of volumetric flow rates for the gas and solution ranges from 10,000:1 to 1,000,000:1. In some embodiments, the ratio of volumetric flow rates for the gas and solution ranges from 10,000:1 to 500,000:1, and more particularly from 10,000:1 to 300,000:1.

In some embodiments, the flow of solution is controlled by pressure, gravity, an electrokinetic force, or any combination thereof. In some embodiments, the flow of gas is provided by a compressed gas source. In some embodiments, the volumetric flow rate for the solution is less than 25 μL/min. In some embodiments, the microfluidic chip comprises two or more gas channels, each comprising a distal end that is in fluid communication with a gas outlet orifice, and wherein the two or more gas outlet orifices are disposed symmetrically about and adjacent to the electrospray ionization orifice. In some embodiments, the electrospray ionization orifice is disposed on an edge or corner of the substrate. In some embodiments, the one or more gas outlet orifices are disclosed adjacent to the electrospray ionization orifice on an edge of the substrate. In some embodiments, an electrospray ionization performance achieved when the microfluidic chip is configured to introduce a sample into a mass spectrometer is characterized by a less than a 1.0% standard error fluctuation in total mass spectrometric signal intensity. In some embodiments, an electrospray ionization performance when the microfluidic chip is configured to introduce a sample into a mass spectrometer is characterized by a less than a 0.1% standard error fluctuation in total mass spectrometric signal intensity.

In another aspect, disclosed herein is a method for providing stable electrospray ionization performance comprising: a) providing a microfluidic chip comprising a substrate, wherein the substrate comprises: (i) a fluid channel having a distal end that is in fluid communication with an electrospray ionization orifice, and (ii) a gas channel having a distal end that is in fluid communication with a gas outlet orifice; b) flowing a solution through the fluid channel; c) flowing a gas through the gas channel; and d) controlling a flow rate of the gas and a flow rate of the solution such that a ratio of flow velocity for the gas at the gas outlet orifice and flow velocity for the solution at the electrospray ionization orifice ranges from 100:1 to 1,000,000:1. In some embodiments, the ratio of flow velocity for the gas at the gas outlet orifice and flow velocity for the solution at the electrospray ionization orifice ranges from 500:1 to 5,000:1.

In some embodiments, the ratio of flow velocity for the gas at the gas outlet orifice and flow velocity for the solution at the electrospray ionization orifice ranges from 1,000:1 to 3,000:1.

In yet another aspect, provided herein is a microfluidic cartridge comprising: a) a microfluidic chip comprising at least one fluid port and at least two gas ports disposed on an edge of the microfluidic chip; and b) a microfluidic cartridge component that is in fluid communication with the microfluidic chip and is configured to encompass at least a portion of the microfluidic chip, the microfluidic cartridge component comprising at least one fluid port and at least two gas ports that align with the at least one fluid port and at least two gas ports of the microfluidic chip.

In some embodiments, the microfluidic cartridge further comprises one or more elastomeric components disposed between the edge of the microfluidic chip and a surface of the cartridge; and wherein the one or more elastomeric components form a substantially leak-proof seal between the at least one fluid port and at least two gas ports of the microfluidic chip and the at least one fluid port and at least two gas ports of the microfluidic cartridge component upon application of force. In some embodiments, the edge of the microfluidic chip is less than about 2.0 mm thick. In some embodiments, the edge of the microfluidic chip is about 1±0.1 mm thick.

In another aspect, disclosed herein is a system comprising: a) a microfluidic cartridge comprising two or more fluid ports and configured to be removeable from the system; and b) an instrument comprising two or more fluid interconnects; wherein each of the two or more fluid interconnects is configured to provide a substantially leak-proof fluid coupling between a fluid line of the instrument and a fluid port of the microfluidic cartridge upon application of force to an assembly comprising the two or more fluid interconnects and the two or more fluid ports of the microfluidic cartridge, and wherein the substantially leak-proof fluid couplings are maintained when a relative fluid pressure within two of the two or more fluid lines varies by a factor of at least 10-fold.

In some embodiments, the substantially leak-proof fluid couplings are maintained when the relative fluid pressure within two of the two or more fluid lines varies by a factor of at least 100-fold. In some embodiments, each of the two or more fluid interconnects comprises an independently spring-loaded fitting. In some embodiments, the independently spring-loaded fittings comprise a flat face-sealing fitting that mates with a fluid port comprising a hole in the microfluidic cartridge.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A provides a non-limiting schematic illustration of a microfluidic chip comprising multiple channels for multiple isoelectric focusing reactions according to one aspect of the present disclosure.

FIG. 1B provides a non-limiting schematic illustration of a fluid channel network of an exemplary microfluidic chip for performing a separation reaction and comprising an electrospray tip according to another aspect of the present disclosure.

FIGS. 2A-2B provide non-limiting schematic illustrations of a microfluidic chip comprising a gas channel and a separation channel, with inlet ports positioned at an edge of the device. FIG. 2A shows a footprint of the microfluidic chip. FIG. 2B shows a top-down view of the fluid channel and gas outlet orifices.

FIGS. 3A-3D provide non-limiting schematic illustrations of alterable aspects (e.g., design parameters) of the microfluidic chips described herein. FIG. 3A shows an angle between a distal end of the fluid channel and a distal end of the gas channel. FIG. 3B shows a diameter of the gas outlet orifice. FIG. 3C shows a proximity between a distal end of the fluid channel and a distal end of the gas channel. FIG. 3D shows an angle between an edge of the microfluidic chip and a distal end of the gas channel.

FIGS. 4A-4B provide non-limiting examples of micrographs of one design of a microfluidic chip comprising a substrate comprising symmetric gas channels that are adjacent to a fluid channel (e.g., an end of a separation channel). FIG. 4A shows a micrograph of one design of a microfluidic chip. FIG. 4B shows a micrograph of another design of a microfluidic chip.

FIGS. 5A-5C provide additional non-limiting schematic illustrations of an example microfluidic chip comprising a separation channel and a gas channel. FIG. 5A shows a footprint of the microfluidic chip. FIG. 5B shows a top-down view of the fluid channel and gas outlet orifices. FIG. 5C shows an isometric view of the fluid channel and gas outlet orifices.

FIGS. 6A-6C provide additional non-limiting schematic illustrations of another example of a microfluidic chip comprising a separation channel and a gas channel. FIG. 6A shows a footprint of the microfluidic chip. FIG. 6B shows a top-down view of the fluid channel and gas outlet orifices. FIG. 6C shows an isometric view of the fluid channel and gas outlet orifices.

FIGS. 7A-7C provide additional non-limiting schematic illustrations of yet another example of a microfluidic chip comprising a separation channel and a gas channel. FIG. 7A shows a footprint of the microfluidic chip. FIG. 7B shows a top-down view of the fluid channel and gas outlet orifices. FIG. 7C shows an isometric view of the fluid channel and gas outlet orifices.

FIGS. 8A-8C provide additional non-limiting schematic illustrations of yet another example of a microfluidic chip comprising a separation channel and a gas channel. FIG. 8A shows a footprint of the microfluidic chip. FIG. 8B shows a top-down view of the fluid channel and gas outlet orifices. FIG. 8C shows an isometric view of the fluid channel and gas outlet orifices.

FIGS. 9A-9B provide additional non-limiting schematic illustrations of yet another example of a microfluidic chip comprising a separation channel and a gas channel, with inlet ports on opposite edges of a substrate described herein. FIG. 9A shows a footprint of the microfluidic chip. FIG. 9B shows a top-down view of the fluid channel and gas outlet orifices.

FIGS. 10A-10C provide additional non-limiting schematic illustrations of another example of a microfluidic chip comprising a separation channel and a gas channel. FIG. 10A shows a footprint of the microfluidic chip. FIG. 10B and FIG. 10C show top-down enlarged views of the fluid channel and gas outlet orifices.

FIGS. 11A-11C provide additional non-limiting schematic illustrations of another example of a microfluidic chip comprising a separation channel and a gas channel. FIG. 11A shows a footprint of the microfluidic chip. FIG. 11B and FIG. 11C show isometric enlarged views of a gas inlet portion and a distal outlet portion, respectively.

FIGS. 12A-12D provide example schematics (FIGS. 12A-12C) and an image (FIG. 12D) of various distal ends (tips) of microfluidic chips. FIG. 12A shows a schematic of an unshaped tip with gas and fluidic orifices. FIG. 12B shows a schematic of a faceted shaped tip with gas and fluid orifices. FIG. 12C shows a schematic of a rounded shaped tip with gas and fluid orifices. FIG. 12D shows an image of a faceted shaped tip with gas and fluid orifices.

FIG. 13 provides example images of the fluid orifice of a microfluidic chip comprising a fluid outlet channel and symmetric gas channels during electrospray ionization.

FIGS. 14A-14B provide additional example images of the fluid orifice of a microfluidic chip comprising a fluid outlet channel and symmetric gas channels during electrospray ionization. FIG. 14A shows an image of illumination near the electrospray ionization orifice. FIG. 14B shows an image of illumination near an electrode plate.

FIG. 15 provides examples of results from numerical simulation illustrating gas flow velocities around a fluid outlet channel orifice of a device described herein. Panel A shows the simulation results for a device described herein. Panel B shows the simulation results for another device described herein. Panel C shows the simulation results for another device described herein. Panel “Concentric” shows the simulation results for another device described herein. Panel D shows the simulation results for another device described herein. Panel E shows the simulation results for another device described herein. Panel F shows the simulation results for another device described herein. Panel G shows the simulation results for another device described herein.

FIG. 16 provides examples of results from numerical simulation illustrating gas shear rates around a fluid outlet channel orifice of a device described herein. Panel A shows the simulation results for a device described herein. Panel B shows the simulation results for another device described herein. Panel C shows the simulation results for another device described herein. Panel “Concentric” shows the simulation results for another device described herein. Panel D shows the simulation results for another device described herein. Panel E shows the simulation results for another device described herein. Panel F shows the simulation results for another device described herein. Panel G shows the simulation results for another device described herein.

FIG. 17 provides examples of results from numerical simulation illustrating velocity fields around a fluid outlet channel orifice of a device described herein. Panel A shows the simulation results for a device described herein. Panel B shows the simulation results for another device described herein. Panel C shows the simulation results for another device described herein. Panel “Concentric” shows the simulation results for another device described herein. Panel D shows the simulation results for another device described herein. Panel E shows the simulation results for another device described herein.

FIG. 18 provides examples of results from numerical simulation illustrating gas pressure fields around a fluid outlet channel orifice of a device described herein. Panel A shows the simulation results for a device described herein. Panel B shows the simulation results for another device described herein. Panel C shows the simulation results for another device described herein.

Panel “Concentric” shows the simulation results for another device described herein. Panel D shows the simulation results for another device described herein. Panel E shows the simulation results for another device described herein. Panel F shows the simulation results for another device described herein. Panel G shows the simulation results for another device described herein.

FIG. 19 shows a plot comparing the gas pressure for multiple device designs as a function of distance from the electrospray tip.

FIGS. 20A-20E schematically illustrate a design for a microfluidic cartridge-to-instrument interface and components thereof. FIG. 20A shows an exploded view. FIG. 20B shows a view of the assembled unit. FIG. 20C shows a cross-sectional view of the assembly in an unloaded position. FIG. 20D shows a cross-sectional view of the assembly in a contacted position. FIG. 20E shows a cross-sectional view of the assembly in a sealed configuration.

FIGS. 21A-21C schematically illustrate a perspective view of the fitting assemblies of a microfluidic cartridge-to-instrument interface. FIG. 21A shows a perspective view of the assembly in an unloaded position. FIG. 21B shows a perspective view of the assembly in a contacted position. FIG. 21C shows a perspective view of the assembly in a sealed configuration.

FIGS. 22A-22C schematically illustrate a design for connecting a microfluidic chip and a cartridge component to assemble a microfluidic cartridge, in which the interface comprises an elastomeric component. FIG. 22A schematically shows the microfluidic chip secured to the cartridge. FIG. 22B shows a schematic of the elastomeric component. FIG. 22C shows a schematic view of a set of connected elastomeric components.

FIG. 23 shows an example of a software architecture system described herein.

FIG. 24 shows an example block diagram of an integrated system described herein.

FIG. 25 shows an example block diagram of another integrated system described herein.

### DETAILED DESCRIPTION

Disclosed herein are methods, devices, and systems for nebulizing a sample while introducing the sample to an analytical instrument (e.g., mass spectrometer). One or more methods, devices, and systems disclosed herein may additionally include performing an isoelectric focusing reaction (or other separation reaction) on a mixture of analytes, followed by mobilization and introduction of the separated analytes to a mass spectrometer. The introduction of the separated analytes may be introduced using electrospray ionization, and nebulization of the sample may provide for greater precision, control, and improved analytical performance of downstream analytical approaches (e.g., mass spectrometry). The methods, devices, and systems disclosed herein may additionally enable fast, accurate separation and characterization of protein analyte mixtures or other biological molecules by isoelectric point (or other physicochemical properties).

In an aspect, disclosed herein are microfluidic chips that comprise a substrate having a separation channel and a gas channel. In some instances, the separation channel is used to perform an isoelectric focusing reaction and comprises a distal end that is in fluid communication with a fluid channel outlet. The fluid channel outlet can be a part of or comprise an electrospray ionization orifice, which may be used to interface the sample or separated sample into an analytical instrument (e.g., mass spectrometer). The microfluidic chips used herein may additionally comprise inlet ports that are in fluid communication with the gas channel and the separation channel, and the inlet ports may be positioned along an edge of the substrate (i.e., the face of the substrate defined by the largest and smallest dimension (e.g., length and depth) of the substrate footprint). The inlet ports may be fluidically and/or electrically coupled to channels or reservoirs comprising reagents to perform one or more reactions, e.g., separation reactions, mobilization reactions, electrospray ionization, etc. In some instances, the substrate comprises an electrospray ionization (ESI) tip, which is used to emit the sample (or separated sample) via mobilization and ESI. The ESI tip may be disposed on an edge of the substrate. In some instances, the ESI tip and the outlet of the gas channel (e.g., the gas outlet orifice) are disposed adjacent to one another on the edge of the substrate. In some instances, the sample (or separated sample) is introduced into an analytical instrument (e.g., mass spectrometer).

In some instances, the gas channel is used to nebulize the sample (or separated sample) from the ESI tip during ESI. Nebulization is achieved by the shear and inertial forces created by the gas jet to break a continuous liquid stream into small droplets. Nebulization of the sample (or separated sample) may be used to improve quantitative measurement of the sample (or separated sample) under nanoflow, where the sample (or separated sample) is flowed through the ESI tip at approximately nanoliter-scale flow rates (e.g., nanoliter(s)/min). Nebulization of the sample (or separated sample) may be used to improve quantitative measurement of the sample (or separated sample) under microflow, where the sample (or separated sample) is flowed through the ESI tip at approximately microliter-scale flow rates (e.g., microliter(s)/min). In some instances, nebulization of the sample (or separated sample) reduces ion suppression, increases ionization across ionic species, reduces contamination, provides for more stable electrospray performance, decouples the droplet formation from the ESI potential, and/or provides greater accuracy. In some instances, the gas channel integrated into the microfluidic chip allows for greater precision in the placement of the gas for nebulization relative to the separation channel or ESI tip, laminar flow of the gas, greater dimensional control, etc. In some instances, the gas channel may be used for cleaning or drying of the ESI tip, or for directing waste products from the separation channel or ESI tip away from a downstream analytical unit (e.g., mass spectrometer). In some instances, the gas channel is used to control the temperature of the substrate (e.g., by altering the temperature of the gas flowing through the gas channel).

Integration of the gas channel in a substrate of a device may provide particular utility and advantages. For instance, greater precision in the placement of the gas flow in relation to the fluid channel orifice may be achieved, as compared to an external unit that is configured to couple to the device. For instance, the placement of the gas channel orifice relative to the fluid channel orifice, using standard fabrication approaches, may achieve a precision of placement of +/−approximately 2 μm, as compared to an external unit that achieves a precision of placement of approximately +/−100 μm. Moreover, integration of gas channels in a microfluidic format may be advantageous in achieving laminar flow of the gas, which may aid in eliminating or preventing vortexing or turbulent flow at or near the fluid channel orifice, which can provide for more stable electrospray. Additionally, the proximity of the gas flow to the liquid/separation channel flow more effectively imparts the effects of gas flow onto the liquid flow.

In another aspect of the present disclosure, provided herein is a microfluidic chip that comprises a separation channel and a gas channel, in which a portion of the gas channel is substantially parallel to a portion of the separation channel. In some instances, the gas channel and the separation channel are disposed on the substrate, such that an angle (also “convergence angle” herein) between a distal end of the separation channel (or a distal end of the fluid outlet channel (also “fluid discharge channel” herein)) connected to the separation channel, and a distal end of the gas channel ranges from approximately 0 degrees to about 45 degrees.

In some instances, the angle between the distal end of the gas channel and the distal end of the fluid outlet channel is about 0 degrees (parallel, non-convergent), about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees. In some instances, the angle between the distal end of the gas channel and the distal end of the fluid outlet channel is at least about 0 degrees, at least about 5 degrees, at least about 10 degrees, at least about 15 degrees, at least about 20 degrees, at least about 25 degrees, at least about 30 degrees, at least about 35 degrees, at least about 40 degrees, at least about 45 degrees, at least about 50 degrees, at least about 55 degrees, at least about 60 degrees, at least about 65 degrees, at least about 70 degrees, at least about 75 degrees, at least about 80 degrees, at least about 85 degrees, or at least about 90 degrees. In some instances, the angle between the distal end of the gas channel and the distal end of the fluid outlet channel is at most about 90 degrees, at most about 85 degrees, at most about 80 degrees, at most about 75 degrees, at most about 70 degrees, at most about 65 degrees, at most about 60 degrees, at most about 55 degrees, at most about 50 degrees, at most about 45 degrees, at most about 40 degrees, at most about 35 degrees, at most about 30 degrees, at most about 25 degrees, at most about 20 degrees, at most about 15 degrees, at most about 10 degrees, at most about 5 degrees, or at most about 0 degrees. The angle may fall within a range of the values listed herein, e.g., between about 10 degrees and 30 degrees.

In another aspect, disclosed herein is a microfluidic chip comprising a substrate comprising a gas channel and at least one inlet port, which inlet port is positioned along the edge of the substrate. In some instances, the substrate comprises a gas channel, a separation channel, and the gas channel and separation channel each comprise an inlet port located on the edge of the substrate. In some instances, the substrate comprises a fluid channel and two gas channels and at least one fluid inlet port (e.g., connected to the separation channel) and at least two gas inlet ports, in which the ports are located along a first edge of the substrate.

In another aspect of the present disclosure, provided herein is a microfluidic chip comprising two or more gas channels, wherein each of the gas channels has a different length and is configured to deliver gas to a gas outlet orifice (also “outlet of a gas channel” herein), which orifices are disposed on an edge or, in some instances, a corner of the substrate. In some instances, the gas flow out of two gas outlet orifices (of the one or more gas channels) are configured to converge in the fluid path of a liquid out of a fluid outlet orifice (of the fluid channel). In some instances, the total length of the gas channels may differ, and the cross-sectional area of all or a portion of each of the two or more gas channels may be adjusted such that each of the two or more gas channels has about the same hydrodynamic flow resistance. In some instances, the gas channel may be narrowed at the exit to increase the liner flow rate of the gas flow. In some instances, the gas channel may be configured to achieve supersonic (faster than sound) flow speeds at its exit. In some instances, this configuration may consist of a narrowing gas channel section, followed by a more narrow “choke” section, and then an expanding section to achieve supersonic flow speeds.

In some instances, the microfluidic chip comprises a fluid channel (e.g., separation channel) that is in fluid communication (e.g., at a distal end) with a fluid outlet channel, which fluid outlet channel comprises a fluid outlet orifice that can function as an ESI orifice. In some instances, the fluid outlet orifice is disposed on an edge or a corner of the substrate, and the outlets of the gas channel may be disposed adjacently to the fluid outlet orifice, on the edge or corner of the substrate. In some instances, the corner on which the ESI orifice is positioned comprises the edge on which the fluid outlet orifice is positioned. In other instances, the corner on which the ESI orifice is positioned does not comprise the edge on which the fluid outlet orifice is positioned. In some instances, the flow rate of the gas in the gas channel and/or the flow rate of the liquid in the fluid channel can be controlled or adjusted such that a ratio of the volumetric flow rates for the gas and liquid ranges from 1000:1 to 1,000,000:1. In some instances, the flow velocity of the gas in the gas channel and/or the flow velocity of the liquid in the fluid channel can be controlled or adjusted such that a ratio of the flow velocities for the gas and liquid ranges from 100:1 to 10,000:1.

In another aspect, provided herein is a cartridge component that is configured to interface with a microfluidic chip in an assembled microfluidic cartridge. The microfluidic chip may comprise two or more fluid ports disposed on an edge of a substrate of the device, and the cartridge component may comprise two or more fluid ports disposed on a surface or edge of the cartridge, which fluid ports are configured to interface with the fluid ports of the microfluidic chip. In some instances, the fluid ports of the cartridge component align with those of the microfluidic chip, e.g., when the chip is secured in the assembled microfluidic cartridge. The assembled microfluidic cartridge may comprise one or more elastomeric components positioned between the edge of the microfluidic chip and the surface of the cartridge component (e.g., at the interfaces of the aligned fluid ports). In some instances, the application of a force to an assembly comprising the microfluidic chip and the cartridge component is used to secure the microfluidic chip in the assembled microfluidic cartridge and to establish fluidic communication between the ports of the microfluidic chip and the ports of the cartridge. In some instances, the assembled microfluidic cartridge is configured to provide a substantially leak-proof fluid coupling between the cartridge component and the microfluidic chip. In some instances, the leak-proof fluid coupling is maintained upon introduction of gas into a gas channel of the microfluidic chip.

In another aspect, disclosed herein is an interface design for removably connecting a microfluidic cartridge to an instrument system, which interface design is configured to establish fluid communication between at least one channel of the microfluidic cartridge and a fluid line external to the microfluidic cartridge. The interface design may comprise one or more fluid interconnects, in which each of the fluid interconnects is configured to provide substantially leak-proof fluid coupling between the external fluid line (e.g., of an instrument, connected to a reservoir, etc.) and a fluid port of the microfluidic cartridge. In some instances, in which an assembled microfluidic cartridge comprising a cartridge component and the microfluidic chip is used, the interface comprises one or more fluid interconnects, in which each of the fluid interconnects is configured to provide substantially leak-proof fluid coupling between the external fluid line and the assembled microfluidic cartridge, which may in turn provide substantially leak-proof fluid communication with the cartridge component and/or microfluidic chip of the microfluidic cartridge. The substantially leak-proof fluid couplings may be maintained when a relative fluid pressure within two of the two or more external fluid lines varies by a factor of at least 10-fold, as will be described below. In some instances, the interface design comprises at least one independently spring-loaded fitting, which may be used to establish fluidic communication between the microfluidic cartridge and the external fluid line. In some instances, the cartridge may simultaneously deliver gas and liquid to the chip.

In some embodiments of the present disclosure, the microfluidic chip comprises a planar substrate, which planar substrate comprises two or more separation channels for parallel, multiplexed separation reactions and optionally, two or more gas channels for parallel, multiplexed nebulization of the separated samples for downstream analysis (e.g., via ESI-MS). In a preferred aspect, the separation reactions are isoelectric focusing reactions. In another preferred aspect, the analyte mixtures comprise protein analyte mixtures, and the performance of two or more isoelectric focusing reactions in parallel enables fast, accurate separation of the protein components in the analyte mixture and characterization of the individual protein components according to their isoelectric points (pIs). In some instances, the use of imaging, e.g., whole channel imaging, in combination with pI markers to visualize the positions of the pI markers in the pH gradient used for isoelectric focusing allows for more accurate determinations of the pIs for the separated protein components of the analyte mixture.

In certain embodiments of the present disclosure, the methods and systems for operating the microfluidic devices or cartridges use two or more high voltage power supplies (or a single multiplexed high voltage power supply), which enables independent control of the separation reaction or experimental conditions in each separation channel of the microfluidic chip. Thus, in some instances, the microfluidic chip may be used to perform separation and characterization of two or more different samples under the same set of separation or experimental conditions in parallel. In some instances, the microfluidic chip may be used to perform separation and characterization of two or more aliquots of the same sample under two or more different reaction or experimental conditions in parallel. In some instances, a subset of the separation channels on the device may be used to perform separations of a plurality of samples under the same set of separation or experimental conditions, and, alternatively or in addition to, a different subset of the separation channels on the device may be used to perform separation and characterization of a plurality of aliquots from the same sample under a plurality of different reaction or experimental conditions in parallel. In some instances, the device comprises, for each subset of the separation channels, one or more gas channels that are used to nebulize the sample in each of the separation channels for introduction of the separated samples into a mass spectrometer (e.g., via nebulization during ESI).

The conditions may be the same or may differ across the separation channels of the microfluidic chip and may comprise a buffer selection, an electrolyte selection, a pH gradient selection, a voltage setting, a current setting, an electric field strength setting, a time course for varying a voltage setting, a current setting, an electric field strength setting, an isoelectric focusing reaction, or a combination thereof.

In some instances, the system may further comprise an autosampler or fluid handling system configured for automated, independently controlled loading of sample aliquots and/or other reagents (e.g., for separation reactions, mobilization, electrospray ionization, gas for nebulization) into one or more inlet ports. In some instances, the system may further comprise a fluid flow controller configured to provide, e.g., independently controlled pressure-driven flow through two or more channels (e.g., for delivering reagents to the fluid channel and/or gas channel). In some instances, the system may further comprise an autosampler or fluid flow controller configured to flush, wash, rinse, or evacuate a fluid channel following a separation reaction (e.g., isoelectric focusing reaction). In some instances, following the flush, wash, rinse, or evacuation of the separation channel, the autosampler or fluid flow controller may be configured to automatically introduce another sample (e.g., a different sample or another aliquot of the same sample) into the two or more separation channels. In some instances, the autosampler or fluid flow controller may be configured to automatically re-introduce a sample, reaction reagents, or a combination thereof into the one or more separation channels if a failure (e.g., bubble formation or introduction, incorrectly prepared sample, underfilled reagent reservoir, or a combination thereof) is detected (e.g., via the voltage or current monitoring). In such cases, following the detection of the failure, the autosampler or fluid flow controller may flush out the separation channel where the failure occurred, re-introduce a sample, reaction reagents, or a combination thereof, and the separation reaction may be re-initiated (e.g., via application of an electric field by one or more of the independently controlled voltage supplies).

In some instances, the system may further comprise an imaging module configured to acquire a series of one or more images of the separation channel and/or the gas channel or outlets of any of the channels. In some instances, the field-of-view of the images may comprise all or a portion of the separation channel or gas channel. In some instances, the field-of-view of the images may comprise all or a portion of the fluid channel or fluid channel outlet. In some instances, the imaging may comprise continuous imaging while the separation reaction, mobilization reaction, and/or electrospray ionization is performed. In some instances, the imaging may comprise intermittent imaging while the separation reaction, mobilization reaction, and/or electrospray ionization is performed.

In some instances, the imaging may comprise continuous or intermittent imaging while the electrospray ionization and/or nebulization is performed. In some instances, the imaging may comprise acquiring UV absorbance images. In some instances, the imaging may comprise fluorescence images, e.g., of either native fluorescence or fluorescence due to the presence of exogenous fluorescent labels attached to the analytes. In some instances, the imaging may be used to determine a parameter of the ESI or Taylor cone formed during ESI. In some instances, the parameter comprises a shape of the Taylor cone, ESI jet, ESI plume, nebulization efficiency, a flow velocity, a droplet size, a gas pressure, a liquid pressure, ESI stability, ESI emitter contamination, bubbles in fluid flow.

In another aspect of the present disclosure, systems are described that may comprise a microfluidic chip designed to perform one or more separation reactions, e.g., isoelectric focusing reactions, to separate a sample comprising a mixture of analytes into its individual components, followed by electrospray ionization of the separated analytes, which electrospray ionization comprises or is performed in parallel with nebulization of the sample. In some instances, the microfluidic chip may be housed in a cartridge that further comprises, e.g., high-voltage electrode connections, reagent reservoirs, valves, securing mechanisms, fittings, channels, etc. In some instances, the microfluidic chip may comprise a substantially planar substrate, where the planar substrate comprises at least one gas channel and a separation channel configured to perform the separation reaction, e.g., isoelectric focusing reaction. In some instances, the gas channel is used for nebulization of the sample during electrospray ionization. In some instances, the gas channel is used for moving a liquid in the separation channel away from the separation channel (e.g., away from an analytical instrument, e.g., mass spectrometer, toward a waste receptacle, etc.). In some instances, the substrate further comprises an electrospray ionization tip at a distal end of the separation channel, and the gas channel may be used for cleaning or drying the electrospray tip.

In some instances, a first end of one or more separation channels of the plurality of separation channels is electrically and/or fluidically coupled to an electrode (e.g., anolyte) reservoir using a fixture, which fixture may comprise a membrane. In some instances, a second end of one or more separation channels is electrically and/or fluidically coupled to an electrode (e.g., catholyte reservoir) using a fixture, which fixture may comprise a membrane. The membrane may be disposed within the electrode reservoir at or adjacent to a plane that defines or is parallel to a surface of the electrode reservoir, which plane may intersect an inlet fluid channel and outlet fluid channel. In some instances, the system may further comprise an analytical instrument such as a mass spectrometer. The disclosed methods, devices, and systems enable improvements in the reproducibility and quantitative accuracy of the separation data, and also improved correlation between the separation data and downstream analytical characterization data, e.g., that obtained using a mass spectrometer or other analytical instrument.

Another feature of the disclosed methods, devices, and systems, as indicated above, is the use of imaging to monitor separation reactions in a separation channel for the purpose of detecting the presence of analyte peaks and/or to determine when the separation reaction has reached completion. In some instances, images may be acquired for all or a portion of the separation channel. In some instances, imaging of all or a portion of the separation channel may be performed while the separation step and/or a mobilization step are performed. In some instances, the images may be used to detect the presence of one or more markers or indicators, e.g., isoelectric point (pI) standards, within the separation channel and thus determine the pIs for one or more analytes. In some instances, the images may be used to detect a failure in a separation channel (e.g. bubble formation). In some instances, data derived from such images may be used to determine when a separation reaction is complete (e.g., by monitoring peak velocities, peak positions, and/or peak widths) and subsequently trigger a mobilization step.

In some instances, the mobilization step may comprise introduction of a mobilization buffer or a mobilization electrolyte into the separation channel. In some instances, the mobilization buffer or mobilization electrolyte may be introduced using hydrodynamic pressure. In some instances, the mobilization buffer or mobilization electrolyte may be introduced by means of electrophoresis. In some instances, the mobilization buffer or mobilization electrolyte may be introduced by means of a combination of electrophoresis and hydrodynamic pressure. In some instances, the mobilization of a series of one or more separated analyte bands may comprise causing the separated analyte bands to migrate towards an outlet or distal end of the separation channel. In some instances, the mobilization of a series of one or more separated analyte bands may comprise causing the separated analyte bands to migrate towards an outlet or distal end of the separation channel that is in fluid communication with a downstream analytical instrument. In some instances, the outlet or distal end of the separation channel may be in fluid communication with an electrospray ionization (ESI) interface such that the migrating analyte peaks are injected into a mass spectrometer. In some instances, the image data used to detect analyte peak positions and determine analyte pIs may also be used to correlate analyte separation data with mass spectrometry data. In some instances, the image data used to detect analyte peak positions may be used to yield information on the mobilization reaction and/or to correlate the mobilization information with the mass spectrometry data.

Another key feature of the disclosed methods, devices, and systems, as indicated above, is the use of imaging to monitor nebulization of the sample (e.g., during an electrospray ionization reaction). The imaging may be used to detect the presence of a Taylor cone. In some instances, images may be acquired for all or a portion of the separation channel, electrospray ionization tip, or the region between the device (e.g., microfluidic chip) and an analytical instrument (e.g., mass spectrometer or grounded electrode plate). In some instances, imaging of all or a portion of the ESI tip may be performed while the ESI is performed. In some instances, the images may be used to detect the presence of a Taylor cone. In some instances, the images may be used to determine a parameter of the Taylor cone, e.g., a droplet size, a shape of the Taylor cone, a size of the Taylor cone, a shape of the ESI jet, a size of the ESI jet, a shape of the ESI plume, a size of the ESI plume, a flow velocity, a gas pressure, a liquid pressure.

In preferred aspects, the disclosed methods may be performed in a microfluidic device format, thereby allowing for processing of extremely small sample volumes and integration of two or more sample processing and separation steps. In another preferred aspect, the disclosed microfluidic devices and cartridges comprise an integrated interface for coupling to a downstream analytical instrument, e.g., an ESI interface for performing mass spectrometry on the separated analytes. In some instances, the disclosed methods may be performed in a more conventional capillary format.

Various aspects of the disclosed methods, devices, and systems described herein may be applied to any of the particular applications set forth below. It shall be understood that different aspects of the disclosed methods, devices, and systems can be appreciated individually, collectively, or in combination with each other.

Definitions: Unless otherwise defined, all of the technical terms used herein have the same meaning as commonly understood by one of ordinary skill in the art in the field to which this disclosure belongs.

As used in this specification and the appended claims, the singular forms “a”, “an”, and “the” include plural references unless the context clearly dictates otherwise. Any reference to “or” herein is intended to encompass “and/or” unless otherwise stated. Similarly, the terms “comprise”, “comprises”, “comprising”, “include”, “includes”, and “including” are not intended to be limiting.

As used herein, the phrases “including, but not limited to . . . ” and “one non-limiting example is . . . ” are meant to be inclusive of variations and derivatives of the given example, as commonly understood by one of ordinary skill in the art in the field to which this disclosure belongs.

As used herein, the term ‘about’ a number refers to that number plus or minus 10% of that number. The term ‘about’ when used in the context of a range refers to that range minus 10% of its lowest value and plus 10% of its greatest value.

As used herein, the terms “characterization” and “analysis” may be used interchangeably. To “characterize” or “analyze” may generally mean to assess a sample, for example, to determine one or more properties of the sample or components thereof, or to determine the identity of the sample.

As used herein, the terms “chip” and “device” may be used interchangeably herein.

As used herein, the terms “analyte” and “species” may be used interchangeably. An analyte generally means a molecule, biomolecule, chemical, macromolecule, etc., that differs from another molecule, biomolecule, chemical, macromolecule, etc. in a measurable property. For example, two species may have a slightly different mass, hydrophobicity, charge or net charge, isoelectric point, efficacy, or may differ in terms of chemical modifications, protein modifications, etc.

As used herein, a “fluid channel” generally refers to a channel of a device (e.g., a microfluidic chip) that is configured to convey a fluid, e.g., a gas or a liquid (such as a solution) within a channel. In some instances, the fluid is conveyed from a proximal end of a channel toward a distal end of the channel.

As used herein, a “gas channel” generally refers to a fluid channel that is configured to convey a gas within the channel. In some instances, the gas is conveyed from a proximal end of a channel toward a distal end of the channel.

As used herein, a “microfluidic device” generally refers to a microfluidic chip, e.g., a glass or polymer substrate comprising one or more fluid channels. In some instance, a “microfluidic device” may further comprise additional components such as a holder in which the microfluidic chip is mounted to facilitate ease of handling. In some instances, “microfluidic device” may refer to a microfluidic chip attached to, or mounted within, a more complex “cartridge component” that may comprise additional functional features such as reagent reservoirs, valves, fluid connectors, etc., to create a “microfluidic cartridge”. In some instances, an assembly comprising a microfluidic chip and a cartridge component may be referred to as a “microfluidic device” or a “microfluidic cartridge”.

Samples: The disclosed methods, devices, systems, and software may be used for separation and characterization of analytes obtained from any of a variety of biological or non-biological samples. Examples include, but are not limited to, tissue samples, cell culture samples, whole blood samples (e.g., venous blood, arterial blood, or capillary blood samples), plasma, serum, saliva, interstitial fluid, urine, sweat, tears, protein samples derived from industrial enzyme or biologic drug manufacturing processes, environmental samples (e.g., air samples, water samples, soil samples, surface swipe samples), and the like. In some embodiments, the samples may be processed using any of a variety of techniques known to those of skill in the art prior to analysis using the disclosed methods and devices for integrated chemical separation and characterization. For example, in some embodiments the samples may be processed to extract proteins or nucleic acids. Samples may be collected from any of a variety of sources or subjects, e.g., bacteria, virus, plants, animals, or humans.

Sample volumes: In some instances of the disclosed methods and devices, the use of a microfluidic device format may enable the processing of very small sample volumes. In some embodiments, the sample volume loaded into the device and used for analysis may range from about 0.1 μl to about 1 ml. In some embodiments, the sample volume loaded into the device and used for analysis may be at least 0.1 μl, at least 1 μl, at least 2.5 μl, at least 5 μl, at least 7.5 μl, at least 10 μl, at least 25 μl, at least 50 μl, at least 75 μl, at least 100 μl, at least 250 μl, at least 500 μl, at least 750 μl, or at least 1 ml. In some embodiments, the sample volume loaded into the device and used for analysis may be at most 1 ml, at most 750 μl, at most 500 μl, at most 250 μl, at most 100 μl, at most 75 μl, at most 50 μl, at most 25 μl, at most 10 μl, at most 7.5 μl, at most 5 μl, at most 2.5 μl, at most 1 μl, or at most 0.1 μl. Any of the lower and upper values described in this paragraph may be combined to form a range included within the present disclosure, for example, in some embodiments the sample volume loaded into the device and used for analysis may range from about 5 μl to about 500 μl. Those of skill in the art will recognize that sample volume used for analysis may have any value within this range, e.g., about 18 μl.

Analytes: In some instances, a sample may comprise a plurality of analyte species. In some instances, all or a portion of the analyte species present in the sample may be enriched prior to or during analysis. In some instances, these analytes can be, for example, glycans, carbohydrates, nucleic acid molecules (e.g., DNA, RNA), peptides, polypeptides, recombinant proteins, intact proteins, protein isoforms, digested proteins, fusion proteins, antibody-drug conjugates, protein-drug conjugates, metabolites or other biologically relevant molecules. In some instances, these analytes can be small molecule drugs. In some instances, these analytes can be protein molecules in a protein mixture, such as a biologic protein pharmaceutical (e.g., enzyme pharmaceutical or antibody pharmaceutical) and/or a lysate collected from cells isolated from culture or in vivo.

Microfluidic devices: Disclosed herein are devices designed to perform nebulization of a sample or separated sample (e.g., a mixture of analytes separated via isoelectric focusing) at or near a fluid orifice of a substrate of a device. In some instances, the disclosed devices are microfluidic devices comprising a substrate having a separation channel and one or more gas channels, which gas channels are used to nebulize the sample, e.g., a sample comprising separated analytes using a separation reaction, such as isoelectric focusing. The nebulization of the sample may be used to break up liquid (e.g., via breaking surface tension of a droplet) at or near a fluid orifice (e.g., at or near a distal end of the separation channel or a distal end of a fluid outlet channel that is fluidically coupled to a separation channel) into small liquid droplets, such as to achieve nanoflow or substantially nanoscale volume emission of the sample. In some instances, the fluid orifice comprises or is configured to be an electrospray tip, and nebulization of the sample may be used to achieve nanoflow during electrospray ionization.

In some instances, the device may comprise a substrate that has multiple gas channels. The substrate may comprise 1, 2, 3, 4, 5, 6, 7, 8, 9, 10, 11, 12, 13, 14, 15, 16, 17, 18, 19, 20, or more gas channels. The substrate may comprise at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, or at least 20 gas channels. The substrate may comprise at most 20, at most 19, at most 18, at most 17, at most 16, at most 15, at most 14, at most 13, at most 12, at most 11, at most 10, at most 9, at most 8, at most 7, at most 6, at most 5, at most 4, at most 3, at most 2, or at most 1 channels. The substrate can vary and have a range of different gas channels, e.g., between 2 and 4 gas channels.

As described herein, the position of the one or more gas channel outlets (also “gas outlet orifices” herein) may be positioned adjacent to the outlet orifice of a fluid channel (also “fluid channel orifice” herein), which may comprise or be configured to serve as an electrospray ionization orifice. In some instances, the gas channel outlet is positioned about 0 μm, about 1 μm, about 2 μm, about 3 μm, about 4 μm, about 5 μm, about 6 μm, about 7 μm, about 8 μm, about 9 μm, about 10 μm, about 15 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm or more from the fluid channel orifice. In some instances, the gas channel outlet is positioned at least about 0 μm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 15 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm or more from the fluid channel orifice. In some instances, the gas channel outlet is positioned at most about 400 μm, at most about 350 μm, at most about 300 μm, at most about 250 μm, at most about 200 μm, at most about 150 μm, at most about 100 μm, at most about 90 μm, at most about 80 μm, at most about 70 μm, at most about 60 μm, at most about 50 μm, at most about 40 μm, at most about 30 μm, at most about 20 μm, at most about 15 μm, at most about 10 μm, at most about 9 μm, at most about 8 μm, at most about 7 μm, at most about 6 μm, at most about 5 μm, at most about 4 μm, at most about 3 μm, at most about 2 μm, at most about 1 μm, at most about 0 μm from the fluid channel orifice. The gas channel outlet may be positioned in a range of values from the fluid channel orifice, e.g., between 10 μm and 100 μm.

In some embodiments, the separation and gas channel may exit the chip in a substantially coplanar orientation. In some embodiments, the separation and gas channels may substantially non-co-planar. In some embodiments, the separation channel may protrude out of the plane formed by the gas channels by a distance between 0 and 500 um. In some embodiments, the intersection between the fluid separation and gas channels may be shaped such that the exit plane of the gas channels is recessed into the microfluidic device relative to the separation channel. In some preferred embodiments, the separation channel nominally exits at a corner of the chip and bisects the corner relative to the adjacent edges. In some embodiments, the exits of gas channels that terminate along each of the adjacent edges of the substrate form a plane that is necessarily (by geometry) recessed when viewed at the orifice of the separation channel and along the axis of the separation channel.

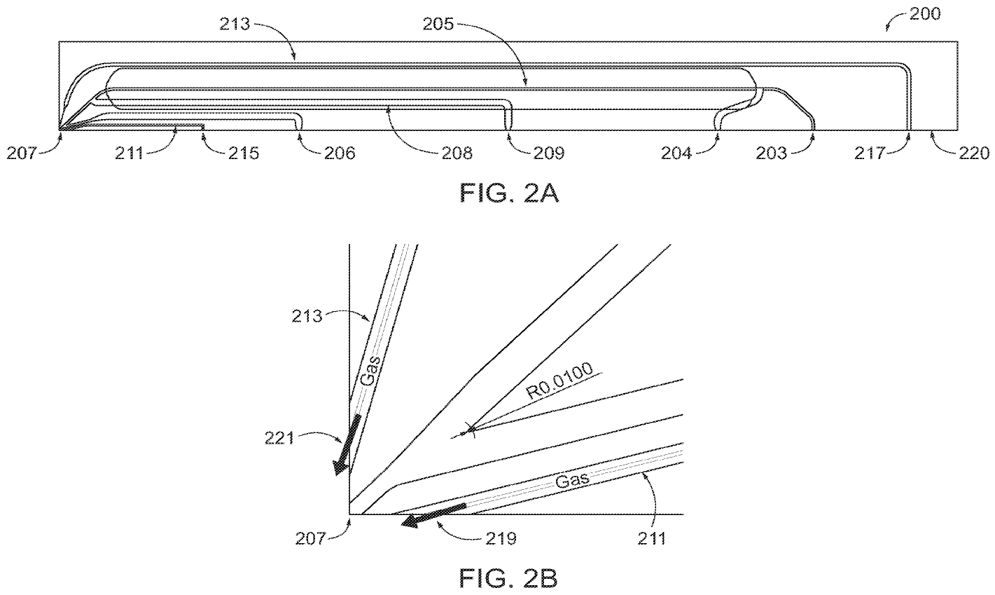

As described herein, the gas outlet orifice or the fluid channel orifice may each be positioned at an edge or corner or tip of the substrate. The edge of the substrate may, in some instances, be defined by the face of the substrate with the longest and shortest dimension (e.g., the face of the substrate defined by the length and thickness of the device, see, e.g., FIG. 2A). The substrate may have a feature in the shape of a trapezoid or tip. In preferred embodiments, the substrate comprises a fluid channel orifice and two gas outlet orifices which are fluidically coupled to two gas channels. In some instances, the two gas outlet orifices are positioned symmetrically from the fluid channel orifice or an axis defined by the fluid flow path exiting the fluid channel orifice. In other instances, the gas outlet orifices are positioned asymmetrically from the fluid channel orifice or an axis defined by the fluid flow path exiting the fluid channel orifice.

The footprint of the substrate may take any useful geometry, e.g., rectangular, circular, ellipsoidal, triangular, square, rhomboid, 5-sided polygon etc. In preferred aspects, the substrate may have a substantially rectangular footprint. In some instances, the longest dimension of the substantially rectangular footprint ranges from about 10 to about 100 mm. In some instances, the shortest dimension of the substantially rectangular footprint ranges from about 2 to about 50 mm. In some instances, the thickness of the substantially rectangular footprint ranges from about 0.5 mm to about 2 mm. In some embodiments, the thickness of the substantially rectangular footprint can be 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, or 2 mm. In some embodiments, the substrate exit orifice may be further shaped into a wedge, pyramid, cone or other three dimensional shape. The shape may include a flat feature where some or all of the channels (gas or fluid) exit. In some embodiments, the substrate surface may be chemically modified to alter its surface energy or become more hydrophobic or hydrophilic. In some embodiments, the surface may maintain a prescribed contact angle with fluids. In some embodiments, surfaces may be prepared to be microroughened as a part of the modification, by laser processing, co-deposition of nanoparticulate other means known in the art, to enhance hydrophobicity or hydrophilicity.

The cross-section of any of the channels and/or orifices described herein (e.g., fluid channels, gas channels) may take on any useful geometry, e.g., circular, rectangular, ellipsoidal, triangular, square, rhomboid, etc. In certain preferred embodiments, the cross-sectional shape of the electrospray ionization orifice is substantially square or rectangular.

In some instances, it may be useful to use more than one gas channel for nebulization. For example, it may be particularly useful to have two or more gas channels for nebulization with gas outlets on opposite sides of the fluid outlet orifice. In some instances, the substrate may comprise a pair or pairs of gas channels that flank the fluid outlet orifice. In some instances, the substrate may comprise four or more gas channels. In such cases, at least two of the four or more gas channels may be disposed within an auxiliary component and may be positioned such that the gas outlet orifices lie in one or more planes that are rotated relative to that of the substrate. For instance, a pair of gas channels and their gas outlet orifices may be positioned relative to the fluid outlet orifice such that the gas channels are radially-symmetric from the fluid channel and fluid outlet orifice. In one such example, the fluid channel orifice may be surrounded by two orthogonal or perpendicular planes of gas channel orifices, wherein each of the gas outlets are radially symmetric from the fluid channel orifice. In another example, the fluid channel orifice may be surrounded by two planes of gas channel orifices, wherein one or more of the planes are rotated relative to the substrate and are positioned in a radially-symmetric pairwise manner about and adjacent to the electrospray ionization orifice. In certain embodiments, the gas channel may comprise an annular cross-section, such that the gas channel orifice is concentric with the outlet of the fluid orifice.

The gas flow from the one or more gas channels may be configured to nebulize the sample at the fluid orifice or at a distance from the fluid orifice. For example, the gas may nebulize the sample at a distance of about 1 micrometer (μm), about 5 μm, about 10 μm, about 15 μm, about 20 μm, about 25 μm, about 30 μm, about 35 μm, about 40 μm, about 45 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm from the fluid orifice (e.g., at an axial distance, in which the axis is the axis of the direction of the fluid leaving the fluid orifice). The gas may nebulize the sample at a distance less than about 1000 μm, about 950 μm, about 900 μm, about 850 μm, about 800 μm, about 750 μm, about 700 μm, about 650 μm, about 600 μm, about 550 μm, about 500 μm, about 450 μm, about 400 μm, about 350 μm, about 300 μm, about 250 μm, about 200 μm, about 150 μm, about 100 μm, about 90 μm, about 80 μm, about 70 μm, about 60 μm, about 50 μm, about 40 μm, about 30 μm, about 20 μm, about 15 μm, about 10 μm, about 5 μm, about 1 μm or less from the fluid orifice. The gas may nebulize the sample at a distance in a range of the values described herein, e.g., between about 50 μm and 300 μm. In some embodiments, the gas flow to nebulize the sample is immediately adjacent to the fluid orifice.

The microfluidic chip may comprise a substrate that has multiple inlet ports, which may be used to provide reagents to the channels. The reagents, as described elsewhere herein, may comprise anolyte solutions, catholyte solutions, electrolyte solutions, buffers, mobilization reagents, sample or sample reagents, air or gas (to the gas channel(s)), etc. Each channel of the substrate may comprise its own inlet port, or in some instances, two or more channels that can be connected, and the connected channels may share an inlet port. In some instances, the inlet ports are positioned along an edge of the substrate (see, e.g., FIGS. 2A, 5A, 6A, 7A, and 8A). In some instances, the substrate may comprise at least four inlet ports that are positioned along the edge of the substrate. The substrate may comprise 1, 2, 3, 4, 5, 6, 7, 8, 9, 10, 20, 30, 40, 50 or more inlet ports. The substrate may comprise at least 1, at least 2, at least 3, at least 4, at least 5, at least 6, at least 7, at least 8, at least 9, at least 10, at least 20, at least 30, at least 40, at least 50 or more inlet ports. The substrate may comprise at most 50, at most 40, at most 30, at most 20, at most 10, at most 9, at most 8, at most 7, at most 6, at most 5, at most 4, at most 3, at most 2, at most 1 inlet ports. The substrate may comprise a range of inlet ports, e.g., between about 2 and 8 inlet ports, each of which, or a subset of which, may be positioned along the edge of the substrate.

In certain instances, the disclosed devices are microfluidic chips comprising multiple separation channels and gas channels. In such instances, the microfluidic chips are designed to perform a plurality of analyte separation reactions in parallel, i.e., within a plurality of separation channels within the device, followed by (i) mobilization and (ii) electrospray ionization combined with nebulization.

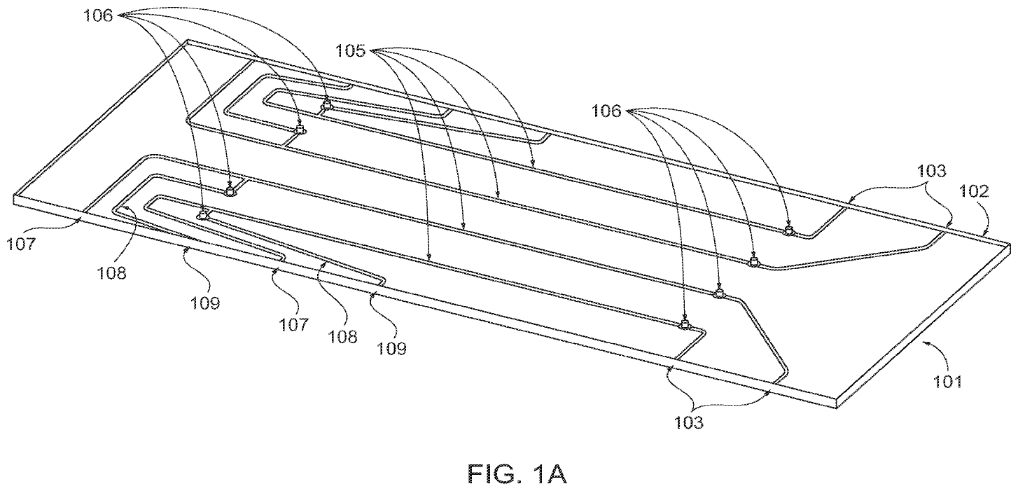

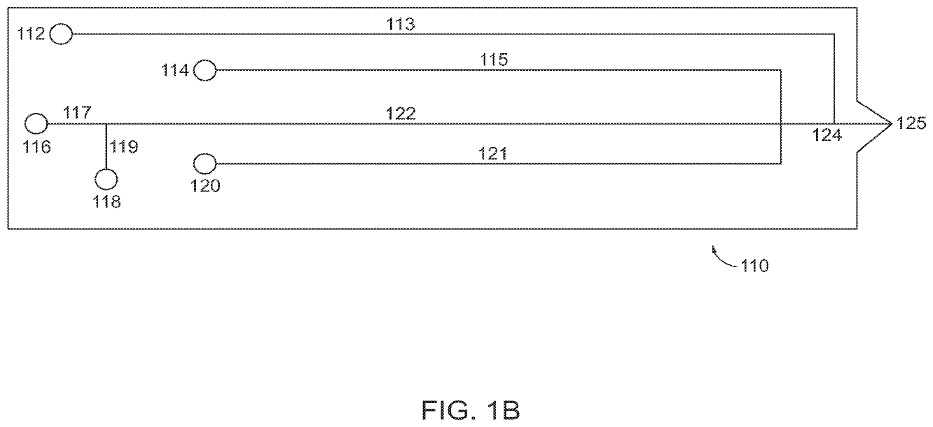

FIG. 1A provides a non-limiting schematic illustration of a microfluidic chip comprising a four-channel isoelectric focusing design according to one aspect of the present disclosure, as will be discussed in more detail in Example 1 below.

FIG. 1B provides a non-limiting schematic illustration of a fluid channel network of an exemplary microfluidic chip for performing a separation reaction and comprising an electrospray tip according to a second aspect of the present disclosure, as will be described in more detail Example 3 below.

FIGS. 2A-2B provide a non-limiting schematic illustration of a microfluidic chip comprising a gas channel and a separation channel, with inlet ports positioned at an edge of the device, as will be discussed in more detail in Example 4 below.

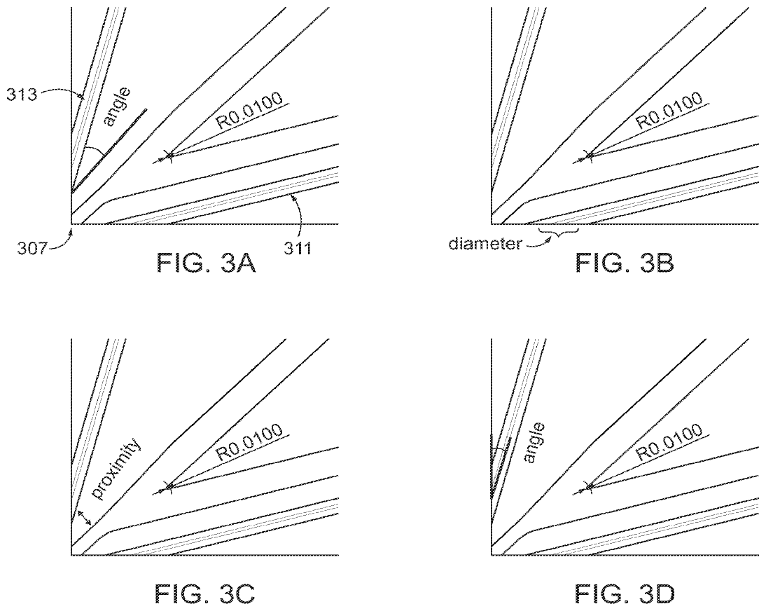

FIGS. 3A-3D provide non-limiting schematic illustrations of alterable aspects (e.g., design parameters) of the microfluidic chips described herein, as will be discussed in more detail in Example 5 below.

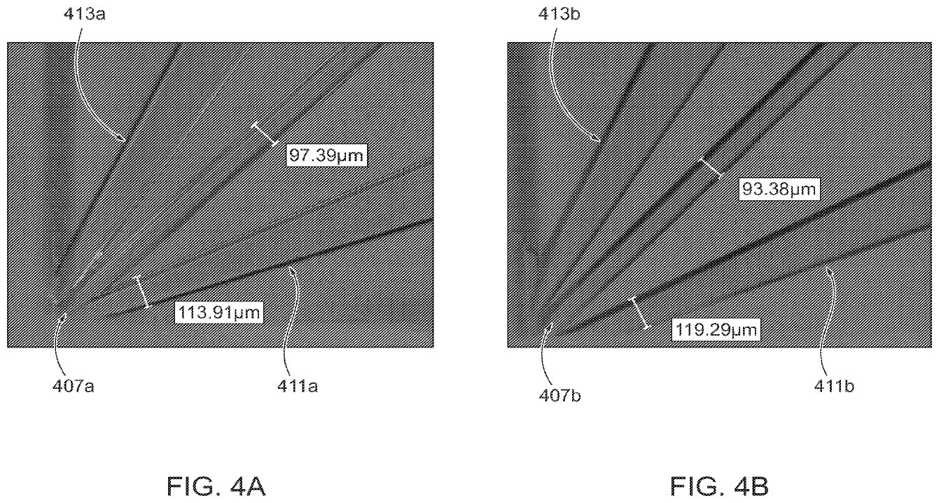

FIGS. 4A-4B provide non-limiting examples of micrographs of one design of a microfluidic chip comprising a substrate comprising a symmetric gas channels that are adjacent to a fluid channel (e.g., an end of a separation channel).

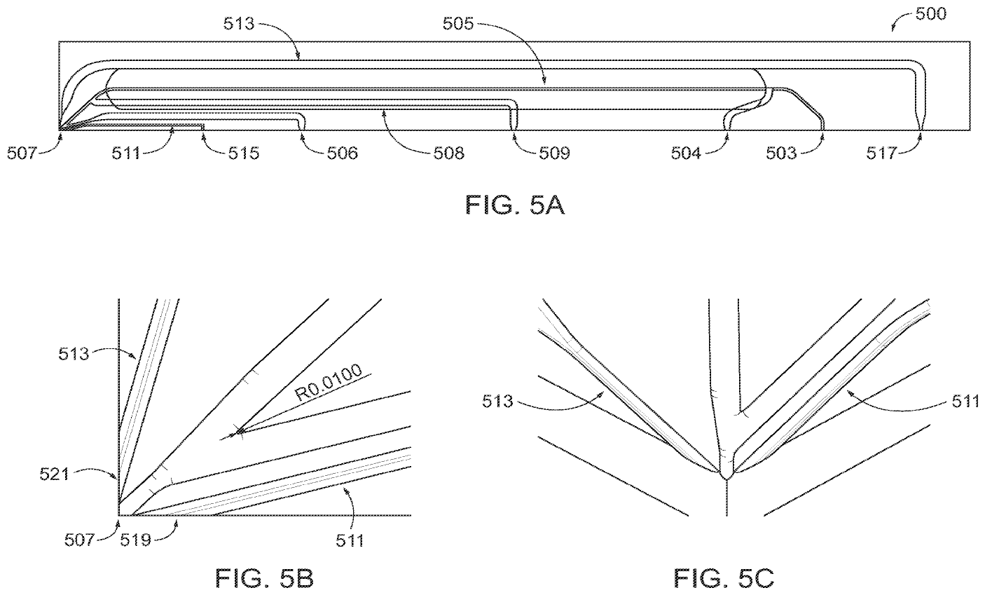

FIGS. 5A-5C provide additional non-limiting schematic illustrations of an example microfluidic chip comprising a separation channel and a gas channel.

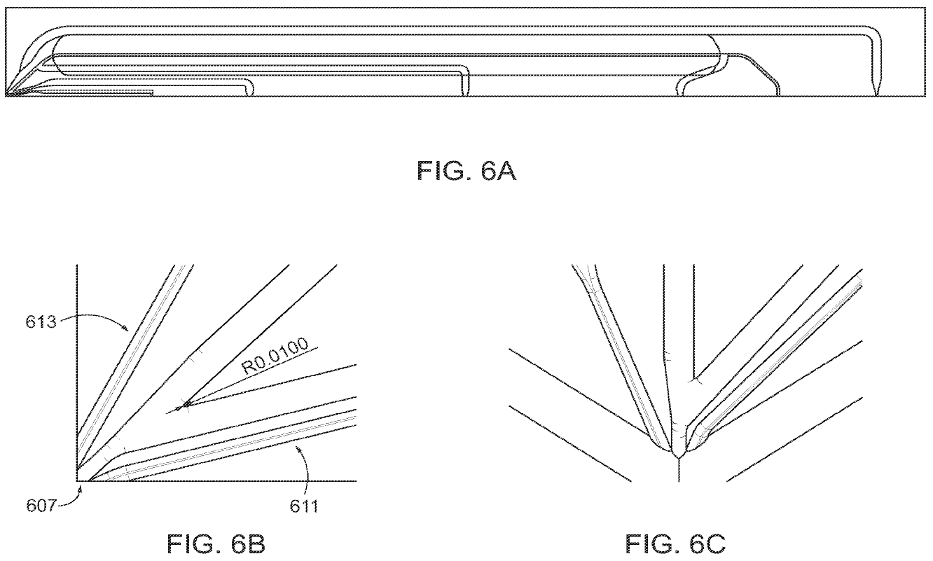

FIGS. 6A-6C provide additional non-limiting schematic illustrations of another example microfluidic chip comprising a separation channel and a gas channel.

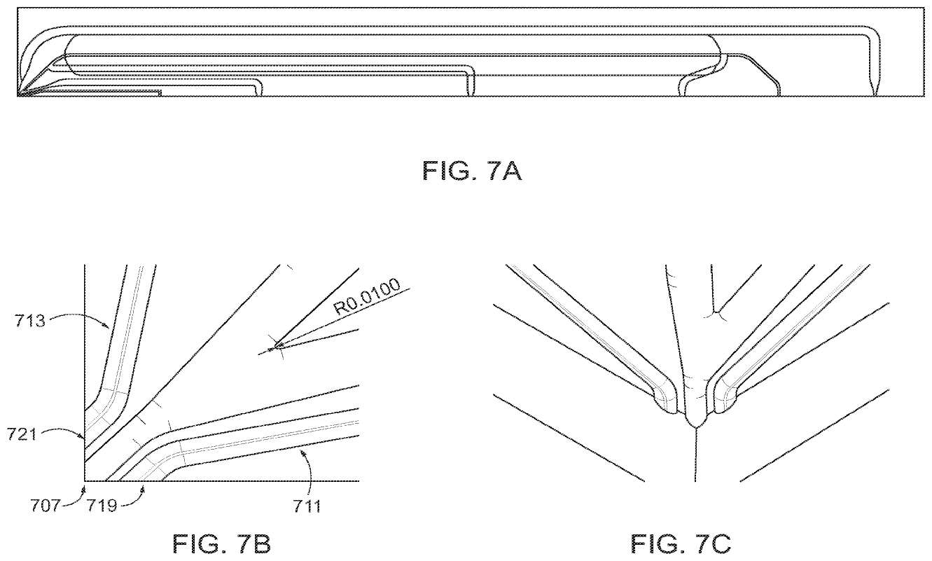

FIGS. 7A-7C provide additional non-limiting schematic illustrations of yet another example microfluidic chip comprising a separation channel and a gas channel.

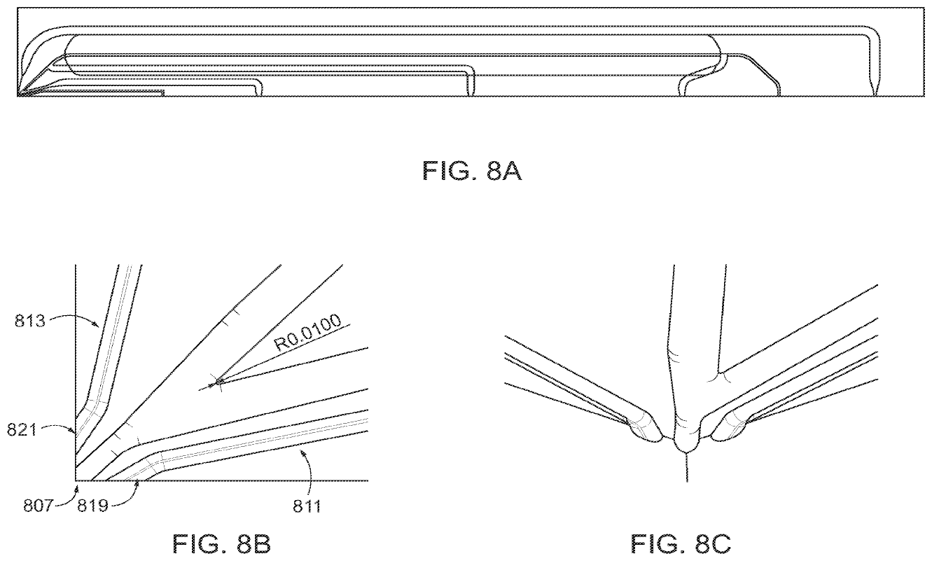

FIGS. 8A-8C provide additional non-limiting schematic illustrations of yet another example microfluidic chip comprising a separation channel and a gas channel.

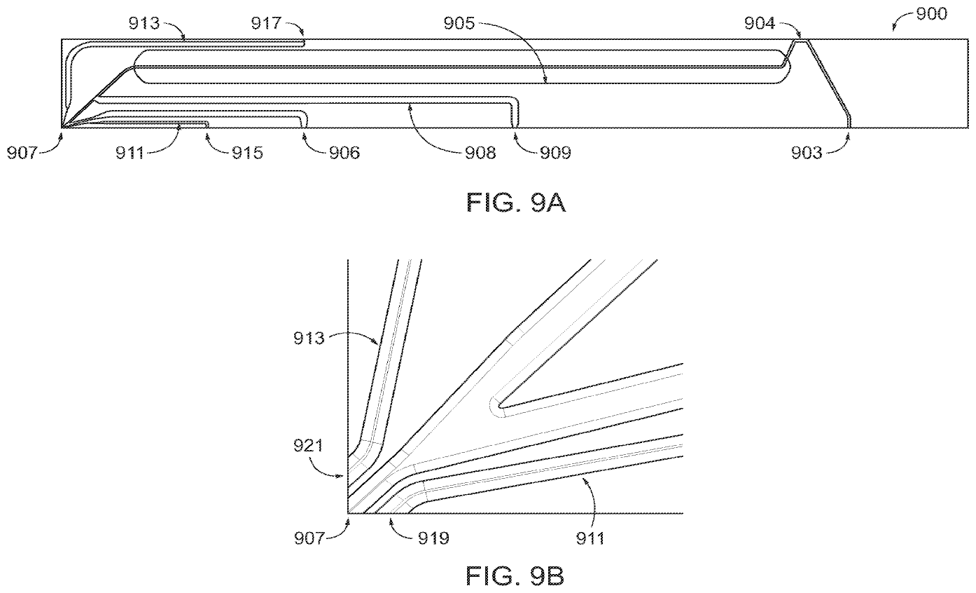

FIGS. 9A-9B provide additional non-limiting schematic illustrations of yet another example microfluidic chip comprising a separation channel and a gas channel, with inlet ports on opposite edges of a substrate described herein.

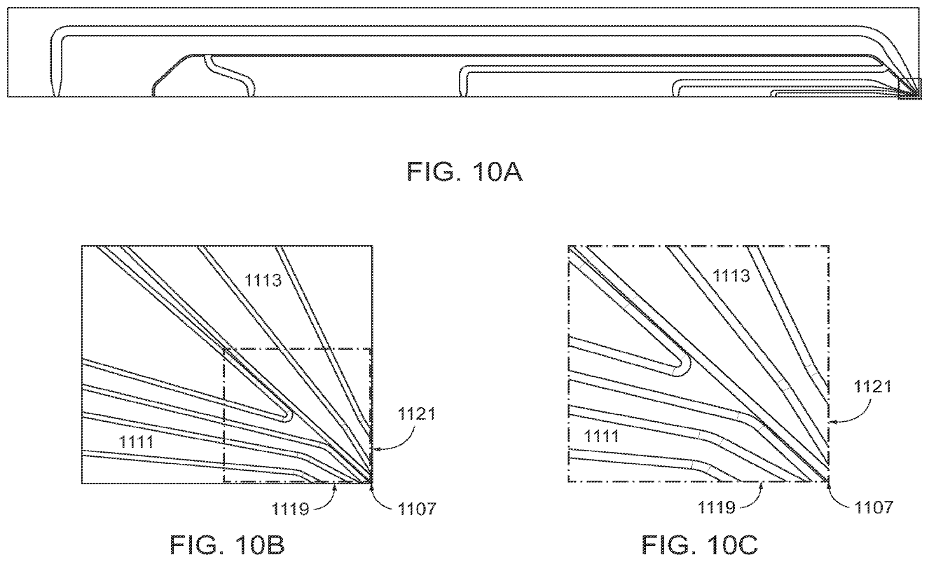

FIG. 10 provides example images of the fluid orifice of a microfluidic chip comprising a fluid outlet channel and symmetric gas channels during electrospray ionization.

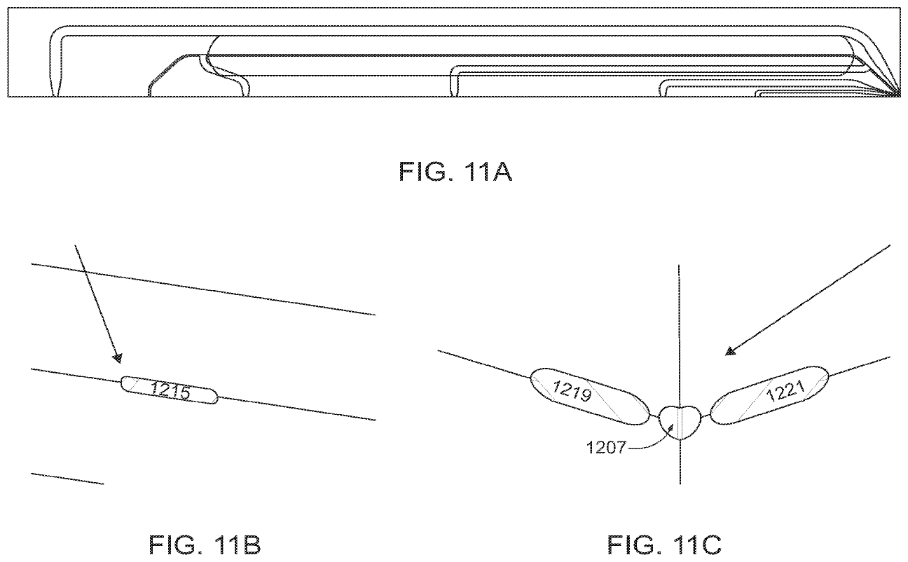

FIGS. 11A-11B provide additional example images of the fluid orifice of a microfluidic chip comprising a fluid outlet channel and symmetric gas channels during electrospray ionization.

In addition to a gas channel and/or inlet ports located on an edge of a substrate of the microfluidic chip, the substrate may comprise a plurality of separation channels (e.g., two or more first separation channels, two or more second separation channels, two or more third separation channels, and so forth), and one or more gas channels for nebulization. The devices or microfluidic chips (or substrate thereof) of the present disclosure may comprise a plurality of inlet ports, outlet ports, sample and/or reagent introduction channels, interconnecting channels, sample and/or reagent waste channels, reservoirs (e.g., sample reservoirs, reagent reservoirs, or waste reservoirs), micropumps, microvalves, vents, traps, filters, membranes, and the like, or any combination thereof.

The disclosed microfluidic chips and microfluidic cartridges may be fabricated using any of a variety of fabrication techniques and materials known to those of skill in the art. In some instances, the devices may be fabricated as a series of two or more separate parts, and subsequently either mechanically clamped or permanently bonded together to form the completed device. In some instances, for example, fluid channels (also sometimes referred to herein as “microchannels”) may be fabricated in a first layer (e.g., by photolithographic patterning of a glass substrate and wet chemical etching of the channels to the desired depth), and then sealed by bonding a second layer to the first layer, where through holes in the second layer that intersect with the fluid channels provide external access to the fluid channels. In some instances, fluid channels may be fabricated in a first layer (e.g., by laser cutting of a channel pattern in a suitable polymer or ceramic film), and then sealed by sandwiching and bonding the first layer between second and third layers, where through holes in the second layer and/or third layer that intersect with the fluid channels provide external access to the fluid channels. In the latter example, the thickness of the first layer defines the thickness (or depth) of the fluid channels.

Examples of suitable fabrication techniques include, but are not limited to, conventional machining, CNC machining, injection molding, 3D printing, alignment and lamination of one or more layers of laser- or die-cut polymer or ceramic film, or any of a number of microfabrication techniques such as photolithography and wet chemical etching, dry etching, deep reactive ion etching, or laser micromachining. In some embodiments, the microfluidic structures may be 3D printed from an elastomeric, polymeric or ceramic material.

The disclosed microfluidic chips and microfluidic cartridges may be fabricated using any of a variety of materials known to those of skill in the art. In general, the choice of material used will depend on the choice of fabrication technique, and vice versa. Examples of suitable materials include, but are not limited to, glass, quartz, fused-silica, silicon, any of a variety of polymers, e.g., polydimethylsiloxane (PDMS; elastomer), polymethylmethacrylate (PMMA), polycarbonate (PC), polystyrene (PS), polypropylene (PP), polyethylene (PE), polyfluorinated polyethylene, high density polyethylene (HDPE), polyether ether ketone, polyimide, cyclic olefin polymers (COP), cyclic olefin copolymers (COC), polyethylene terephthalate (PET), polyether ether ketone (PEEK), epoxy resins, a non-stick material such as Teflon (polytetrafluoroethylene (PTFE)), a variety of photoresists such as SU8 or any other thick film photoresist, or any combination of these materials. In some instances, different layers in a microfluidic chip or microfluidic cartridge comprising multiple layers may be fabricated from different materials. In some instances, a given single layer in a device or microfluidic chip comprising one or more layers may be fabricated from two or more different materials.

In some instances, all or a portion of the microfluidic chip or microfluidic cartridge may be optically transparent (e.g., transparent to ultraviolet (UV), visible, and/or near-infrared light) to facilitate imaging of the separation channels and/or other portions of the device. In some instances, all or a portion of the separation channels are configured for imaging, e.g., whole channel imaging. For example, in some instances the separation channels may be fabricated in a layer of optically opaque material that is sandwiched between two layers of optically transparent material, thereby forming an “optical slit” through which light may be transmitted and/or collected. In some instances, all or a portion of the fluid orifice may be configured for imaging, e.g., during electrospray ionization to determine a parameter of the Taylor cone (e.g., droplet size, shape of the Taylor cone, etc., as described elsewhere herein).

In general, the dimensions of fluid channels, gas channels, sample and/or reagent reservoirs, etc., in the disclosed devices will be optimized to (i) provide fast, accurate, and reproducible separation of samples or sample aliquots comprising analyte mixtures, and (ii) to minimize sample and reagent consumption. In general, the width of fluid channels or gas channels may be between about 10 μm and about 2 mm. In some instances, the width of fluid channels or gas channels may be at least 10 μm, at least 25 μm, at least 50 μm at least 100 μm, at least 200 μm, at least 300 μm, at least 400 μm, at least 500 μm, at least 750 μm, at least 1 mm, at least 1.5 mm, or at least 2 mm. In some instances, the width of fluid channels or gas channels may be at most 2 mm, at most 1.5 mm, at most 1 mm, at most 750 μm, at most 500 μm, at most 400 μm, at most 300 μm, at most 200 μm, at most 100 μm, at most 50 μm, at most 25 μm, or at most 10 μm. Any of the lower and upper values described in this paragraph may be combined to form a range included within the disclosure, for example, in some instances the width of the fluid channels (or reservoirs) may range from about 100 μm to about 1 mm. Those of skill in the art will recognize that the width of the fluid channels (or reservoirs) may have any value within this range, for example, about 80 μm.

In general, the length of fluid channels or gas channels may be between about 0.5 cm to about 10 cm. In some instances, the length of fluid channels or gas channels may be at least 0.1 cm, at least 0.5 cm, at least 1 cm, at least 2 cm, at least 3 cm, at least 4 cm, at least 5 cm, at last 6 cm, at least 7 cm, at least 8 cm, at least 9 cm, at least 10 cm, or more. In some instances, the length of fluid channels or gas channels may be at most 10 cm, at most 9 cm, at most 8 cm, at most 7 cm, at most 6 cm, at most 5 cm, at most 4 cm, at most 3 cm, at most 2 cm, at most 1 cm, at most 0.5 cm, or at most 0.1 cm. Any of the lower and upper values described in this paragraph may be combined to form a range included within the disclosure, for example, in some instances the length of the fluid channels (or reservoirs) may range from about 5 cm to about 10 cm. Those of skill in the art will recognize that the length of the fluid channels (or reservoirs) may have any value within this range, for example, about 8 cm.

In general, the depth of the fluid channels (or reservoirs) will be between about 1 μm and about 1 mm. In some instances, the depth of the fluid channels (or reservoirs) may be at least 1 μm, at least 5 μm, at least 10 μm, at least 20 μm, at least 30 μm, at least 40 μm , at least 50 μm, at least 100 μm, at least 200 μm, at least 300 μm, at least 400 μm, at least 500 μm, at last 600 μm, at least 700 μm, at least 800 μm, at least 900 μm, or at least 1 mm. In some instances, the depth of the fluid channels (or reservoirs) may be at most 1 mm, at most 900 μm, at most 800 μm, at most 700 μm, at most 600 μm, at most 500 μm, at most 400 μm, at most 300 μm, at most 200 μm, at most 100 μm, at most 50 μm, at most 40 μm, at most 30 μm, at most 20 μm, at most 10 μm, at most 5 μm, or at most 1 μm. Any of the lower and upper values described in this paragraph may be combined to form a range included within the disclosure, for example, in some instances the depth of the fluid channels (or reservoirs) may range from about 50 μm to about 100 μm. Those of skill in the art will recognize that the depth of the fluid channels (or reservoirs) may have any value within this range, for example, about 55 μm.

In some embodiments, the depth of the gas channels will match that of the fluid channels. The depth of the gas channels may be between about 1 μm and about 1 mm. In some instances, the depth of the gas channels may be at least 1 μm, at least 5 μm, at least 10 μm, at least 20 μm, at least 30 μm, at least 40 μm , at least 50 μm, at least 100 μm, at least 200 μm, at least 300 μm, at least 400 μm, at least 500 μm, at last 600 μm, at least 700 μm, at least 800 μm, at least 900 μm, or at least 1 mm. In some instances, the depth of the gas channels may be at most 1 mm, at most 900 μm, at most 800 μm, at most 700 μm, at most 600 μm, at most 500 μm, at most 400 μm, at most 300 μm, at most 200 μm, at most 100 μm, at most 50 μm, at most 40 μm, at most 30 μm, at most 20 μm, at most 10 μm, at most 5 μm, or at most 1 μm. Any of the lower and upper values described in this paragraph may be combined to form a range included within the disclosure, for example, in some instances the depth of the gas channels may range from about 50 μm to about 100 μm. Those of skill in the art will recognize that the depth of the fluid channels (or reservoirs) may have any value within this range, for example, about 55 μm.

A cross-sectional dimension of the gas outlet orifice will generally be within about 10 μm to about 100 μm. In some instances, the cross-sectional dimension of the gas outlet orifices may be at least 10 μm, at least 25 μm, at least 50 μm at least 100 μm, at least 200 μm, at least 300 μm, at least 400 μm, at least 500 μm, at least 750 μm, at least 1 mm, at least 1.5 mm, or at least 2 mm. In some instances, the cross-sectional dimension of the gas outlet orifices may be at most 2 mm, at most 1.5 mm, at most 1 mm, at most 750 μm, at most 500 μm, at most 400 μm, at most 300 μm, at most 200 μm, at most 100 μm, at most 50 μm, at most 25 μm, or at most 10 μm. Any of the lower and upper values described in this paragraph may be combined to form a range included within the disclosure, for example, in some instances the cross-sectional dimension of the gas outlet orifices may range from about 10 μm to about 100 μm. Those of skill in the art will recognize that the cross-sectional dimension of the outlet orifice may have any value within this range, for example, about 80 μm.

Cartridges: In some instances, the disclosed microfluidic devices or chips may be configured to be coupled to one another or may be a part of an integrated unit, such as a microfluidic cartridge. The cartridge may comprise the microfluidic chip, which may comprise a substrate comprising a separation channel, at least one gas channel, and other auxiliary parts, such as reservoirs, reagents, membranes, valves, fixtures (e.g., membrane-containing high voltage electrode fixtures), securing devices or features (e.g., screws, pins (e.g., pogo pins), adhesives, levers, switches, grooves, form-fitting pairs, hooks and loops, latches, threads, clips, clamps, prongs, rings, rubber bands, rivets, grommets, ties, snaps, tapes, vacuum, seals), gaskets, o-rings, electrodes, or a combination thereof. The cartridge may be monolithically built or may be modular and comprise removable parts. For instance, the microfluidic chip may be configured to couple removably to the cartridge. Similarly, the reservoirs, membranes, valves, etc., may each be removable from the cartridge. In the case where one or more components may be removable, the microfluidic cartridge may be configured such that each of the individual components may be aligned in place with sufficient tolerance by a user. For example, the microfluidic cartridge may comprise grooves and pins, such that the microfluidic chip may be integrated by sliding the chip along the cartridge until the chip reaches a pin for alignment. In some instances, the chip may be configured to be positioned flush with the cartridge or a portion thereof. In some instances, the chip may be positioned into the cartridge such that one or more inlets, outlets, etc., may be connected (e.g., fluidically and/or electrically) to a reservoir, electrode, membrane and/or other useful interfacing unit. In some instances, the interfacing of the chip and the reservoirs, electrodes, etc., may be performed without any additional measurement or adjustment from the user. For example, the reservoirs may be configured to receive an electrode which snaps into place or is secured via a pogo pin, thereby establishing electrical and/or fluidic communication. It will be appreciated that these example configurations of the cartridge and chip are not meant to be limiting, and that many different configurations of positioning the microfluidic chip or other components of the microfluidic cartridge may be achieved. In some instances, the microfluidic cartridge may be configured to be a removeable and/or disposable component of the systems described herein.

In a preferred embodiment, the cartridge component interfaces with the microfluidic chip at an edge of the microfluidic chip. The microfluidic chip may comprise two or more fluid ports, and the cartridge component may comprise an edge that mirrors the number of fluid ports of the chip. In some instances, the edge of the cartridge comprises two or more fluid ports that align with the two or more fluid ports of the microfluidic chip. The cartridge may also comprise one or more elastomeric components (e.g., gaskets, o-rings, etc.) that are used to form a substantially leak-proof seal between the two or more fluid ports of the microfluidic chip and the two or more fluid ports of the cartridge component upon application of a force to an assembly comprising the microfluidic chip and the cartridge component. For example, the assembly may comprise screws, clamps, or other fastening mechanisms that are used to apply the force to form the leak-proof seal between the ports of the microfluidic chip and the ports of the cartridge component.

In certain instances, the cartridge comprises one or more reservoirs that is configured to contain a desired volume of fluid. In some instances, the reservoir may be capable of containing at least about 200 microliters (μL), at least about 300 μL, at least about 400 μL, at least about 500 μL, at least about 600 μL, at least about 700 μL, at least about 800 μL, at least about 900 μL, at least about 1 milliliter (mL), at least about 1.5 mL, at least about 2 mL, at least about 2.5 mL, at least about 3 mL, at least about 3.5 mL, at least about 4 mL, at least about 4.5 mL, or at least about 5 mL. In some instances, the reservoir may be capable of containing at most about 5 mL, at most about 4.5 mL, at most about 4 mL, at most about 3.5 mL, at most about 3 mL, at most about 2.5 mL, at most about 2 mL, at most about 1.5 mL, at most about 1 mL, at most about 900 μL, at most about 800 μL, at most about 700 μL, at most about 600 μL, at most about 500 μL, at most about 400 μL, at most about 300 μL, or at most about 200 μL. Any of the lower and upper values described in this paragraph may be combined to form a range included within the present disclosure, for example, in some instances the reservoir may contain a volume of fluid that may range from about 200 μL to about 2 mL. Those of skill in the art will recognize that the reservoir fluid volume capacity may have any value within this range, e.g., about 1.8 mL.

In such instances where the microfluidic cartridge comprises the reservoirs, the reservoirs may be controllably coupled (e.g., electrically, fluidically) to the microfluidic chip. For example, the cartridge may comprise one or more valves, which may be used to control the flow volumes or rate in the chip. In some cases, the cartridge may comprise a stop-cock valve or a shear valve (e.g., sliding valve or rotating shear valve), which may allow for controlled flow rate during delivery of one or more liquid reagents (e.g., mobilization reagents). In some cases, the cartridge may be integrated or interfaced with a syringe pump, which may be used to control the flow rate of liquid into the chip. In some cases, the flow rate may be controlled using a piston, a spring-loaded device, or other mechanical approaches.

In some instances, the cartridge may be configured to accommodate different types or models of chips. For instance, the cartridge may be configured to accommodate at least 1, 2, 3, 4, 5, 6, 7, 8, 9, 10, 20, 30, 40, 50, 60, 70, 80, 90, or 100 different types or models of chips. In some cases, the cartridge may comprise ports or connections that can interface with the channels of the chip (e.g., interface with the inlets and/or outlets of the chip).

Instrument interface design: In preferred embodiments, the cartridge is configured to couple to an instrument system through an interface design, which interface design is used to interface other units (e.g., reservoirs, electrodes, fluid handling unit) to the microfluidic cartridge and/or the microfluidic chip. In some instances, the interface design comprises two or more fluid interconnects, where each of the fluid interconnects is configured to provide a substantially leak-proof fluid coupling between an external fluid line or reservoir and a fluid port of the microfluidic cartridge upon application of a force to an assembly comprising the interface device and the microfluidic cartridge. In some instances, the fluid couplings are maintained as substantially leak-proof when a relative fluid pressure within two of the two or more external fluid lines at the point of their fluid couplings to the two or more fluid ports of the cartridge varies. For example, the fluid couplings may remain leak-proof when the relative fluid pressure within the two external fluid lines varies by about 1-fold, about 2-fold, about 3-fold, about 4-fold, about 5-fold, about 6-fold, about 7-fold, about 8-fold, about 9-fold, about 10-fold, about 20-fold, about 30-fold, about 40-fold, about 50-fold, about 60-fold, about 70-fold, about 80-fold, about 90-fold, or about 100-fold. The fluid couplings may remain leak-proof when the relative fluid pressure within the two external fluid lines varies by at least 1-fold, at least 2-fold, at least 3-fold, at least 4-fold, at least 5-fold, at last 6-fold, at least 7-fold, at least 8-fold, at least 9-fold, at least 10-fold, at least 20-fold, at least 30-fold, at least 40-fold, at least 50-fold, at last 60-fold, at least 70-fold, at least 80-fold, at least 90-fold, or at least 100-fold. In some instances, the fluid couplings may remain leak-proof when the relative fluid pressure within the two external fluid lines varies by at most 100-fold, at most 90-fold, at most 80-fold, at most 70-fold, at most 60-fold, at most 50-fold, at most 40-fold, at most 30-fold, at most 20-fold, at most 10-fold, at most 9-fold, at most 8-fold, at most 7-fold, at most 6-fold, at most 5-fold, at most 4-fold, at most 3-fold, at most 2-fold, or at most 1-fold.

In some instances, the two or more fluid interconnects comprise an independently spring-loaded fitting, which may be useful in generating repeatable seal force. In some instances, the instrument interface comprises parts that are configured to couple to the microfluidic cartridge assembly. For instance, the instrument interface and the cartridge can have parts that are configured to mate (e.g., conical fitting assemblies, flat face-sealing assemblies). In some instances, the spring-loaded fittings comprise a conical fitting that mates with a fluid port comprising a hole in the microfluidic cartridge. In some instances, the spring-loaded fittings comprise a flat face-sealing fitting that mates with a fluid port comprising a hole in the microfluidic cartridge. In some aspects, the hold in the microfluidic cartridge is tapered. In some instances, the instrument interface may be mechanically coupled to the microfluidic cartridge assembly using one or more fastening mechanisms. In some cases, the instrument interface and/or the microfluidic cartridge assembly may comprise magnets that allow for removable coupling or may be mechanically coupled, e.g., using interlocking geometries of the instrument interface and the cartridge assembly. For example, the instrument interface may comprise threads (e.g., screw threads, internal threads, etc.) and the assembly may comprise complementary threads that may engage with the threads of the interface. In conjunction or alternatively, the interface device and/or the assembly may comprise snap-fit joints (e.g., cantilever snap fits, annular snap fits, etc.) that allow for interlocking of the instrument interface to the microfluidic cartridge assembly. Alternatively, or in conjunction, the instrument interface and/or the microfluidic cartridge assembly may comprise components that allow for interference fits, force fits, shrink fits, location fits, etc. Other examples of fastening mechanisms may include, in non-limiting examples, form-fitting pairs, hooks and loops, latches, threads, screws, staples, clips, clamps, prongs, rings, brads, rubber bands, rivets, grommets, pins, ties, snaps, Velcro, adhesives (e.g., glue), tapes, vacuum, seals, a combination thereof, or any other types of fastening mechanisms.

Separation and enrichment of analytes: In some instances, the disclosed devices or systems may be configured to perform one or more separation or enrichment steps in which a plurality of analytes in a mixture are separated and/or concentrated in individual fractions. For example, in some instances the disclosed devices (e.g., microfluidic chips or microfluidic cartridges) may be configured to perform a first enrichment step, in which a mixture of analytes in a sample are separated into and/or enriched as analyte fractions (e.g., analyte peaks or analyte bands) containing a subset of the analyte molecules from the original sample. In some instances, these separated analyte fractions may be mobilized and/or eluted, and in some instances, may then be subjected to another downstream separation and/or enrichment step. In some instances, e.g., following a final separation and/or enrichment step, the separated/enriched analyte fractions may be expelled from the device for further analysis.

In some instances, the disclosed devices and systems may be configured to perform one, two, three, four, or five or more separation and/or enrichment steps. In some instances, one or more of the separation or enrichment steps may comprise a solid-phase separation technique, e.g., reverse-phase HPLC. In some instances, one or more of the separation or enrichment steps may comprise a solution-phase separation and/or enrichment technique, e.g., capillary zone electrophoresis (CZE) or isoelectric focusing (IEF).

The disclosed devices and systems may be configured to perform any of a variety of analyte separation and/or enrichment techniques known to those of skill in the art, where the separation or enrichment step(s) are performed in at least a first separation channel that is configured to be imaged in whole or in part so that the separation process may be monitored as it is performed. For example, in some instances the imaged separation may be an electrophoretic separation comprising, e.g., isoelectric focusing, capillary gel electrophoresis, capillary zone electrophoresis, isotachophoresis, capillary electrokinetic chromatography, micellar electrokinetic chromatography, flow counterbalanced capillary electrophoresis, electric field gradient focusing, dynamic field gradient focusing, and the like, that produces one or more separated analyte fractions from an analyte mixture. In some instances, a separation and mobilization step may be performed in at least a first separation channel that is configured to be imaged in whole or in part so that the separation and mobilization processes may be monitored as they are performed. In any of these instances, the imaging of the separation channel in whole or in part may be performed continuously or intermittently and may be performed prior to, during, or following the separation and/or enrichment process.

In some instances, the use of a microfluidic device format may provide for fast separation times and accurate, reproducible separation data. For example, in instances where the microfluidic device is configured to perform electrophoretic separations and/or isoelectric focusing reactions, the high surface area-to-volume ratios of microfluidic channels may allow one to use high electric field strengths without incurring significant Joule heating, thereby enabling very fast separation reactions without substantial dispersion and loss of separation resolution. In some instances, the precise control of fluid channel geometries provides for accurate and reproducible control of sample injection volumes, electric field strengths, etc., thereby enabling very accurate determinations of one or more parameters of the assay, e.g., separation resolution and/or pI determinations.

The one or more parameters of the assay may comprise a characteristic of the separation. For example, the one or more parameters may be selected from the group consisting of separation resolution, peak width, peak capacity, linearity of the pH gradient, and minimum resolvable pI difference.

In general, the separation time required to achieve complete separation will vary depending on the specific separation technique and operational parameters utilized (e.g., separation channel length, microfluidic device design, buffer compositions, applied voltages, etc.). In some instances, the separation times achieved using the disclosed devices and systems may range from about 0.1 minutes to about 30 minutes. In some instances, the separation time may be at least 0.1 minutes, at least 0.5 minutes, at least 1 minute, at least 5 minutes, at least 10 minutes, at least 15 minutes, at least 20 minutes, at least 25 minutes, or at least 30 minutes. In some instances, the separation time may be at most 30 minutes, at most 25 minutes, at most 20 minutes, at most 15 minutes, at most 10 minutes, at most 5 minutes, at most 1 minute, at most 0.5 minutes, or at most 0.1 minutes. Any of the lower and upper values described in this paragraph may be combined to form a range included within the present disclosure, for example, in some instances the separation time may range from about 1 minute to about 20 minutes. Those of skill in the art will recognize that the separation time may have any value within this range, e.g., about 11.2 minutes. In some instances, the separation time may be longer than 20 minutes.

Similarly, the separation efficiency and resolution achieved using the disclosed devices and systems may vary depending on the specific separation technique and operational parameters utilized (e.g., separation channel length, microfluidic device design, buffer compositions, applied voltages, etc.), as well as whether one or two dimensions of separation are utilized. In some instances, for example when performing isoelectric focusing, the use of switchable electrodes to trigger electrophoretic introduction of a mobilization electrolyte into the separation channel may result in improved separation resolution. For example, in some instances, the separation resolution of IEF performed using the disclosed methods and devices may provide for a resolution of analyte bands differing in pI ranging from about 0.1 to about 0.0001 pH units. In some instances, the IEF separation resolution may allow for resolution of analyte bands differing in pI by less than 0.1, less than 0.05, less than 0.01, less than 0.005, less than 0.001, less than 0.0005, or less than 0.0001 pH units.

Accordingly, in some instances, e.g., when using imaging of all or a portion of a separation channel to identify the positions of pI markers in an isoelectric focusing reaction and determining a pI value for separated analytes, the accuracy with which the pI value may be determined may be less than ±0.1 pH unit, less than ±0.05 pH units, less than ±0.01 pH units, less than ±0.005 pH units, less than ±0.001 pH units, less than ±0.0005 pH units, or less than ±0.0001 pH units.

In some instances, the peak capacity achieved using the disclosed devices may range from about 100 to about 20,000. In some instances, the peak capacity may be at least 100, at least 200, at least 300, at least 400, at least 500, at last 600, at least 700, at least 800, at least 900, at least 1,000, at least 2,000, at least 3,000, at least 4,000, at least 5,000, at least 10,000, at least 15,000, or at least 20,000. In some instances, the peak capacity may be at most 20,000, at most 15,000, at most 10,000, a most 5,000, at most 4,000, at most 3,000, at most 2,000, at most 1,000, at most 900, at most 800, at most 700, at most 600, at most 500, at most 400, at most 300, at most 200, or at most 100. Any of the lower and upper values described in this paragraph may be combined to form a range included within the present disclosure, for example, in some instances the peak capacity may range from about 400 to about 2,000. Those of skill in the art will recognize that the peak capacity may have any value within this range, e.g., about 285.

Capillary isoelectric focusing (CIEF): In some embodiments, the separation technique may comprise isoelectric focusing (IEF), e.g., capillary isoelectric focusing (CIEF). Isoelectric focusing (or “electrofocusing”) is a technique for separating molecules by differences in their isoelectric point (pI), i.e., the pH at which the molecules have a net zero charge. CIEF involves adding ampholyte (amphoteric electrolyte) solutions to a sample channel between reagent reservoirs containing an anode or a cathode to generate a pH gradient within a separation channel (i.e., the fluid channel connecting the electrode-containing wells, e.g., the lumen of a capillary or a channel in a microfluidic device) across which a separation voltage is applied. The ampholytes can be solution phase or immobilized on the surface of the channel wall. Negatively charged molecules migrate through the pH gradient in the medium toward the positive electrode while positively charged molecules move toward the negative electrode. A protein (or other molecule) that is in a pH region below its isoelectric point (pI) will be positively charged and so will migrate towards the cathode (i.e., the negatively charged electrode). The protein's overall net charge will decrease as it migrates through a gradient of increasing pH (due, for example, to protonation of carboxyl groups or other negatively charged functional groups) until it reaches the pH region that corresponds to its pI, at which point it has no net charge and so migration ceases. As a result, a mixture of proteins separated based on their relative content of acidic and basic residues, becomes focused into sharp stationary bands with each protein positioned at a point in the pH gradient corresponding to its pI. The technique is capable of extremely high resolution, with proteins differing by a single charge being fractionated into separate bands. In some aspects, isoelectric focusing may be performed while flowing a fluid (e.g. catholyte or mobilizing reagents) from a fluid inlet through the capillary or a channel and out the distal end of the capillary or channel. In some embodiments, isoelectric focusing may be performed in a separation channel that has been permanently or dynamically coated, e.g., with a neutral and hydrophilic polymer coating, to eliminate electroosmotic flow (EOF). Examples of suitable coatings include, but are not limited to, amino modifiers, hydroxypropylcellulose (HPC) and polyvinylalcohol (PVA), Guarant® (Alcor Bioseparations), linear polyacrylamide, polyacrylamide, dimethyl acrylamide, polyvinylpyrrolidine (PVP), methylcellulose, hydroxyethylcellulose (HEC), hydroxypropylmethylcellulose (HPMC), triethylamine, propylamine, morpholine, diethanolamine, triethanolamine, diaminopropane, ethylenediamine, chitosan, polyethyleneimine, cadaverine, putrescine, spermidine, diethylenetriamine, tetraethylenepentamine, cellulose, dextran, polyethylene oxide (PEO), cellulose acetate, amylopectin, ethylpyrrolidine methacrylate, dimethyl methacrylate, didodecyldimethylammonium bromide, Brij 35, sulfobetains, 1,2-dilauryloylsn-phosphatidylcholine, 1,4-didecyl-1,4-diazoniabicyclo[2,2,2]octane dibromide , agarose, poly(Nhydroxyethylacrylamide), pole-323, hyperbranched polyamino esters, pullalan, glycerol, adsorbed coatings, covalent coatings, dynamic coatings, etc. In some embodiments, isoelectric focusing may be performed (e.g., in an uncoated separation channel) using additives such as methylcellulose, glycerol, urea, formamide, surfactants (e.g., Triton-X 100, CHAPS, digitonin) in the separation medium to significantly decrease the electroosmotic flow, allow better protein solubilization, and limit diffusion inside the capillary (e.g., in the lumen of the capillary) or fluid channel by increasing the viscosity of the electrolyte.

As noted above, the pH gradient used for capillary isoelectric focusing techniques is generated through the use of ampholytes, i.e., amphoteric molecules that contain both acidic and basic groups and that exist mostly as zwitterions within a certain range of pH. The portion of the electrolyte solution on the anode side of the separation channel is known as an “analyte”. That portion of the electrolyte solution on the cathode side of the separation channel is known as a “catholyte”. A variety of electrolytes may be used in the disclosed methods and devices including, but not limited to, phosphoric acid, sodium hydroxide, ammonium hydroxide, glutamic acid, lysine, formic acid, dimethylamine, triethylamine, acetic acid, piperidine, diethylamine, and/or any combination thereof. The electrolytes may be used at any suitable concentration, such as 0.0001%, 0.001%, 0.01%, 0.1%, 1%, 10%, 20%, 30%, 40%, 50%, 60%, 70%, 80%, 90%, etc. The concentration of the electrolytes may be at least 0.0001%, 0.001%, 0.01%, 0.1%, 1%, 10%, 20%, 30%, 40%, 50%, 60%, 70%, 80%, 90%. The concentration of the electrolytes may be at most 90%, 80%, 70%, 60%, 50%, 40%, 30%, 20%, 10%, 1%, 0.1%, 0.01%, 0.001%, 0.0001%. A range of concentrations of the electrolytes may be used, e.g., 0.1%-2%. Ampholytes may be selected from any commercial or non-commercial carrier ampholytes mixtures (e.g., Servalyt pH 4-9 (Serva, Heildelberg, Germany), Beckman pH 3-10 (Beckman Instruments, Fullerton, Calif., USA), Ampholine 3.5-9.5 and Pharmalyte 3-10 (both from General Electric Healthcare, Orsay, France), AESlytes (AES), FLUKA ampholyte (Thomas Scientific, Swedesboro, N.J.), Biolyte (Bio-Rad, Hercules, Calif.)), and the like. Carrier ampholyte mixtures may comprise mixtures of small molecules (about 300-1,000 Da) containing multiple aliphatic amino and carboxylate groups that have closely spaced pI values and good buffering capacity. In the presence of an applied electric field, carrier ampholytes partition into smooth linear or non-linear pH gradients that increase progressively from the anode to the cathode.

Any of a variety of pI standards may be used in the disclosed methods and devices for calculating the isoelectric point for separated analyte peaks. For example, pI markers generally used in CIEF applications, e.g., protein pI markers and synthetic small molecule pI markers, may be used. In some instances, protein pI markers may be specific proteins with commonly accepted pI values. In some instances, the pI markers may be detectable, e.g., via imaging. A variety or combination of protein pI markers or synthetic small molecule pI markers that are commercially available, e.g., the small molecule pI markers available from Advanced Electrophoresis Solutions, Ltd. (Cambridge, Ontario, Canada), ProteinSimple, the peptide library designed by Shimura, and Slais dyes (Alcor Biosepartions), may be used.

Capillary zone electrophoresis (CZE): In some instances, the separation or enrichment technique may comprise capillary zone electrophoresis, a method for separation of charged analytes in solution in an applied electric field. The net velocity of charged analyte molecules is influenced both by the electroosmotic flow (EOF), μEOF, exhibited by the separation system and the electrophoretic mobility, μEP, for the individual analyte (dependent on the molecule's size, shape, and charge), such that analyte molecules exhibiting different size, shape, or charge exhibit differential migration velocities and separate into bands. In contrast to other capillary electrophoresis methods, CZE uses “simple” buffer, or background electrolyte, solutions for separation.

Capillary gel electrophoresis (CGE): In some instances, the separation or enrichment technique may comprise capillary gel electrophoresis, a method for separation and analysis of macromolecules (e.g., DNA, RNA and proteins) and their fragments based on their size and charge. The method comprises use of a gel-filled separation channel, where the gel acts as an anti-convective and/or sieving medium during electrophoretic movement of charged analyte molecules in an applied electric field. The gel functions to suppress thermal convection caused by application of the electric field, and also acts as a sieving medium that retards the passage of molecules, thereby resulting in a differential migration velocity for molecules of different size or charge.

Capillary isotachophoresis (CITP): In some instances, the separation technique may comprise capillary isotachophoresis, a method for separation of charged analytes that uses a discontinuous system of two electrolytes (known as the leading electrolyte and the terminating electrolyte) within a capillary or fluid channel of suitable dimensions. The leading electrolyte contains ions with the highest electrophoretic mobility, while the terminating electrolyte contains ion with the lowest electrophoretic mobility. The analyte mixture (i.e., the sample) to be separated is sandwiched between these two electrolytes, and application of an electric field results in partitioning of the charged analyte molecules within the capillary or fluid channel into closely contiguous zones in order of decreasing electrophoretic mobility. The zones move with constant velocity in the applied electric field such that a detector, e.g., a conductivity detector, photodetector, or imaging device, may be utilized to record their passage along the separation channel. Unlike capillary zone electrophoresis, simultaneous determination or detection of anionic and cationic analytes is not feasible in a single analysis performed using capillary isotachophoresis.

Capillary electrokinetic chromatography (CEC): In some instances, the separation technique may comprise capillary electrokinetic chromatography, a method for separation of analyte mixtures based on a combination of liquid chromatographic and electrophoretic separation methods. CEC offers both the efficiency of capillary electrophoresis (CE) and the selectivity and sample capacity of packed capillary high-performance liquid chromatography (HPLC). Because the capillaries used in CEC are packed with HPLC packing materials, the wide variety of analyte selectivities available in HPLC are also available in CEC. The high surface area of these packing materials enables CEC capillaries to accommodate relatively large amounts of sample, making detection of the subsequently eluted analytes a somewhat simpler task than it is in capillary zone electrophoresis (CZE).

Micellar electrokinetic chromatography (MEKC): In some instances, the separation technique may comprise capillary electrokinetic chromatography, a method for separation of analyte mixtures based on differential partitioning between surfactant micelles (a pseudo-stationary phase) and a surrounding aqueous buffer solution (a mobile phase). The basic set-up and detection methods used for MEKC are the same as those used in CZE. The difference is that the buffer solution contains a surfactant at a concentration that is greater than the critical micelle concentration (CMC), such that surfactant monomers are in equilibrium with micelles. MEKC is typically performed in open capillaries or fluid channels using alkaline conditions to generate a strong electroosmotic flow. Sodium dodecyl sulfate (SDS) is one example of a commonly used surfactant in MEKC applications. The anionic character of the sulfate groups of SDS cause the surfactant and micelles to have electrophoretic mobility that is counter to the direction of the strong electroosmotic flow. As a result, the surfactant monomers and micelles migrate quite slowly, though their net movement is still in the direction of the electroosmotic flow, i.e., toward the cathode. During MEKC separations, analytes distribute themselves between the hydrophobic interior of the micelle and hydrophilic buffer solution. Hydrophilic analytes that are insoluble in the micelle interior migrate at the electroosmotic flow velocity, uₒ, and will be detected at the retention time of the buffer, t_{M}. Hydrophobic analytes that solubilize completely within the micelles migrate at the micelle velocity, u_{c}, and elute at the final elution time, t_{c}.

Flow counterbalanced capillary electrophoresis (FCCE): In some instances, the separation technique may comprise flow counterbalanced capillary electrophoresis, a method for increasing the efficiency and resolving power of capillary electrophoresis that utilizes a pressure-induced counter-flow to actively retard, halt, or reverse the electrokinetic migration of an analyte through a capillary. By retarding, halting, or moving the analytes back and forth across a detection window, the analytes of interest are effectively confined to the separation channel for much longer periods of time than under normal separation conditions, thereby increasing both the efficiency and the resolving power of the separation.

Chromatography: In some instances, the separation technique may comprise a chromatographic technique in which the analyte mixture in the sample fluid (the mobile phase) is passed through a column or channel-packing material (the stationary phase) which differentially retains the various constituents of the mixture, thereby causing them to travel at different speeds and separate. In some instances, a subsequent step of elution or mobilization may be required to displace analytes that have a high binding affinity for the stationary phase. Examples of chromatographic techniques that may be incorporated into the disclosed methods include, but are not limited to, ion exchange chromatography, size-exclusion chromatography, and reverse-phase chromatography.

Mobilization of separated analyte species: In some instances, provided herein are devices and systems configured to perform, e.g., a chromatographic separation technique such as reverse-phase chromatography. The method implemented by the device or system may further comprise elution of the analyte species retained on the stationary phase in each of a plurality of separation channels (e.g., by simultaneously or independently changing a buffer that flows through each of a plurality of separation channels), which may be referred to as a “mobilization” step or reaction. In some instances, the method implemented by the device or system may further comprise simultaneously or independently applying pressure to each of a plurality of separation channels, or simultaneously or independently introducing an electrolyte into each of a plurality of separation channels to disrupt the pH gradient used for isoelectric focusing, and thus trigger migration of the separated analyte peaks out of the separation channels, which may also be referred to as a “mobilization” step. In some instances, the force used to drive the separation reactions (e.g., pressure for reverse-phase chromatography, or an electric field for electrokinetic separation or isoelectric focusing reactions) may be turned off during the mobilization step. In some instances, the force used to drive the separation reactions may be left on during the mobilization step. In some instances of the disclosed methods, e.g., those comprising an isoelectric focusing step, the separated analyte bands may be mobilized (e.g., using hydrodynamic pressure and/or a chemical mobilization technique) such that the separated analyte bands migrate towards an end of each of a plurality of separation channels that is connected to another fluid channel (which may be, e.g., an outlet, a waste reservoir, or a second separation channel). In some instances, e.g., in those instances where capillary gel electrophoresis, capillary zone electrophoresis, isotachophoresis, capillary electrokinetic chromatography, micellar electrokinetic chromatography, flow counterbalanced capillary electrophoresis, or any other separation technique that separates components of an analyte mixture by differential velocity is employed, the separation step itself may be viewed as a mobilization step.

In some instances, mobilization of the analyte bands may be implemented by simultaneously or independently applying hydrodynamic pressure to one or both ends of each of the plurality of separation channels. In some instances, mobilization of the analyte bands may be implemented by orienting the device such that the plurality of separation channels is in a vertical position so that gravity may be employed. In some instances, mobilization of the analyte bands may be implemented using EOF-assisted mobilization. In some instances, mobilization of the analyte bands may be implemented using chemical mobilization, e.g., by simultaneously or independently introducing a mobilization electrolyte into each of the plurality of separation channels that shifts the local pH in a pH gradient used for isoelectric focusing. In some instances, any combination of these mobilization techniques may be employed.

In one preferred instance, the mobilization step for isoelectrically-focused analyte bands comprises chemical mobilization. Compared with pressure-based mobilization, chemical mobilization has the advantage of exhibiting minimal band broadening by overcoming the hydrodynamic parabolic flow profile induced through the use of pressure. Chemical mobilization may be implemented by introducing an electrolyte (i.e., a “mobilization electrolyte”) into the separation channel to alter the local pH and/or net charge on separated analyte bands (or zwitterionic buffer components) such that they (or the zwitterionic buffer components and associated hydration shells) migrate in an applied electric field. In some instances, the polarity of the applied electric field used to mobilize separated analyte bands may be such that analytes migrate towards an anode that is in electrical communication with the outlet or distal end of the separation channel (anodic mobilization). In some instances, the polarity of the applied electric field used to mobilize separated analyte bands may be such that analytes migrate towards a cathode that is in electrical communication with the outlet or distal end of the separation channel (cathodic mobilization). Mobilization electrolytes comprise either anions or cations that compete with hydroxyls (cathodic mobilization) or hydronium ions (anodic mobilization) for introduction into the separation channel or capillary. Examples of bases that may be used as catholytes for anodic mobilization include, but are not limited to, sodium hydroxide, ammonium hydroxide (“ammonia”), diethylamine, dimethyl amine, piperidine, etc. Examples of acids that may be used as anolytes in cathodic mobilization include, but are not limited to, phosphoric acid, acetic acid, formic acid, and carbonic acid, etc. In some instances, mobilization may be initiated by the addition of salts (e.g., sodium chloride) to the anolyte or catholyte. In some instances, an anode may be held at ground, and a negative voltage is applied to the cathode. In some instances, a cathode may be held at ground, and a positive voltage is applied to the anode. In some instances, a non-zero negative voltage may be applied to the cathode, and a non-zero positive voltage may be applied to the anode. In some instances, a non-zero positive voltage may be applied to both the anode and the cathode. In some instances, a non-zero negative voltage may be applied to both the anode and the cathode.

In some instances, mobilization of separated analyte bands may be initiated at a user-specified time point that triggers switchable electrodes (e.g., a cathode in electrical communication with the distal end of each of the plurality of separation channels, and a cathode in electrical communication with a proximal end of each of a plurality of mobilization channels (e.g., fluid channels that intersects the separation channels near the outlet or distal end of each separation channel)) between on and off states to control the electrophoretic introduction of a mobilization buffer or electrolyte into a separation channel.

In some instances, a user-specified time for independently triggering a transition of one, two, or three or more switchable electrodes between on and off states for each of the plurality of separation channels may range from about 30 seconds, to about 30 minutes for any of the mobilization schemes. In some instances, the user-specified time may be at least 30 seconds, at least 1 minute, at least 2 minutes, at least 3 minutes, at least 4 minutes, at least 5 minutes, at least 10 minutes, at least 15 minutes, at least 20 minutes, at least 25 minutes, or at least 30 minutes. In some instances, the user-specified time may be at most 30 minutes, at most 25 minutes, at most 20 minutes, at most 15 minutes, at most 10 minutes, at most 5 minutes, at most 4 minutes, at most 3 minutes, at most 2 minutes, at most 1 minute, or at most 30 seconds. Any of the lower and upper values described in this paragraph may be combined to form a range included within the present disclosure, for example, in some instances the user-specified time may range from about 2 minutes to about 25 minutes. Those of skill in the art will recognize that the user-specified time may have any value within this range, e.g., about 8.5 minutes.

In some instances, the electric field used to effect mobilization in any of the mobilization scenarios disclosed herein (or to perform electrokinetic separation or isoelectric focusing reactions in those instances where such separation techniques are performed) may range from about 0 V/cm to about 1,000 V/cm. In some instances, the electric field strength may be at least 0 V/cm, at least 20 V/cm, at least 40 V/cm, at last 60 V/cm, at least 80 V/cm, at least 100 V/cm, at least 150 V/cm, at least 200 V/cm, at least 250 V/cm, at least 300 V/cm, at least 350 V/cm, at least 400 V/cm, at least 450 V/cm, at least 500 V/cm, at last 600 V/cm, at least 700 V/cm, at least 800 V/cm, at least 900 V/cm, or at least 1,000 V/cm. In some instances, the electric field strength may be at most 1,000 V/cm, at most 900 V/cm, at most 800 V/cm, at most 700 V/cm, at most 600 V/cm, at most 500 V/cm, at most 450 V/cm, at most 400 V/cm, at most 350 V/cm, at most 300 V/cm, at most 250 V/cm, at most 200 V/cm, at most 150 V/cm, at most 100 V/cm, at most 80 V/cm, at most 60 V/cm, at most 40 V/cm, at most 20 V/cm, or at most 0 V/cm. Any of the lower and upper values described in this paragraph may be combined to form a range included within the present disclosure, for example, in some instances the electric field strength time may range from about 40 V/cm to about 650 V/cm. Those of skill in the art will recognize that the electric field strength may have any value within this range, e.g., about 575 V/cm.

In some instances, mobilization of separated analyte bands may be initiated based on data derived from independently monitoring the current (or conductivity) for each of the plurality of separation channels where, for example, in the case of isoelectric focusing the current passing through a separation channel may reach a minimum value. In some instances, the detection of a minimum current value, or a current value that remains constant or below a specified threshold for a specified period of time, may be used to determine if an isoelectric focusing reaction has reached completion and may thus be used to trigger the initiation of a chemical mobilization step.

In some instances, the minimum current value or threshold current value may range from about 0 μA to about 100 μA. In some instances, the minimum current value or threshold current value may be at least 0 μA, at least 1 μA, at least 2 μA, at least 3 μA, at least 4 μA, at least 5 μA, at least 10 μA, at least 20 μA, at least 30 μA, at least 40 μA, at least 50 μA, at last 60 μA, at least 70 μA, at least 80 μA, at least 90 μA, or at least 100 μA. In some instances, the minimum current value or threshold current value may be at most 100 μA, at most 90 μA, at most 80 μA, at most 70 μA, at most 60 μA, at most 50 μA, at most 40 μA, at most 30 μA, at most 20 μA, at most 10 μA, at most 5 μA, at most 4 μA, at most 3 μA, at most 2 μA, at most 1 μA, or at most 0 μA. Any of the lower and upper values described in this paragraph may be combined to form a range included within the present disclosure, for example, in some instances the minimum current value or threshold current value may range from about 10 μA to about 90 μA. Those of skill in the art will recognize that the minimum current value or threshold current value may have any value within this range, e.g., about

In some instances, the specified period of time may be at least 5 seconds, at least 10 seconds, at least 15 seconds, at least 20 seconds, at least 25 seconds, at least 30 seconds, at least 35 seconds, at least 40 seconds, at least 45 seconds, at least 50 seconds, at least 55 seconds, or at last 60 seconds. In some instances, the specified period of time may be at most about 60 seconds, at most about 55 seconds, at most about 50 seconds, at most about 45 seconds, at most about 40 seconds, at most about 35 seconds, at most about 30 seconds, at most about 25 seconds, at most about 20 seconds, at most about 15 seconds, at most about 10 seconds, or at most about 5 seconds. Any of the lower and upper values described herein may be combined to form a range included within the present disclosure, in some instances the specified period of time may range from about 5 seconds to about 30 seconds. Those of skill in the art will recognize that the specified period of time may have any value within this range, e.g., about 32 seconds.

In some instances, mobilization of separated analyte bands may be initiated based on data derived from images (e.g., by performing automated image processing) of the separation channel as a separation reaction is performed. The image-derived data may be used to monitor the presence or absence of one or more analyte peaks, the positions of one or more analyte peaks, the widths of one or more analyte peaks, the velocities of one or more analyte peaks, separation resolution, a rate of change or lack thereof in the presence, position, width, or velocity of one or more analyte peaks, or any combination thereof, and may be used to determine whether a separation reaction is complete and/or to trigger the initiation of a mobilization step in a given separation channel. In some cases, completion of a separation step may be determined by monitoring the rate of change of a separation performance parameter (e.g., peak position or peak width) over a period of time (e.g., over a period of 10 to 60 seconds).

In some embodiments, a chemical mobilization step may be initiated within a microfluidic device designed to integrate CIEF with ESI-MS by changing an electric field within the device to electrophorese a mobilization electrolyte into the separation channel. In some instances, the initiation of the mobilization step may be triggered based on data derived from images of all or a portion of the separation channel. In some instances, the change in electric field may be implemented by connecting or disconnecting one or more electrodes attached to one or more power supplies, wherein the one or more electrodes are positioned in reagent wells on the device or integrated with fluid channels of the device. In some instances, the connecting or disconnecting of one or more electrodes may be controlled using a computer-implemented method and programmable switches, such that the timing and duration of the mobilization step may be coordinated with the separation step. In some instances, changing an electric field within the device may be used to electrophoretically or electro-osmotically flow a mobilization buffer into a separation channel comprising a stationary phase such that retained analytes are released from the stationary phase.

In some instances, three or more electrodes for each separation channel may be connected to or integrated into the device. For example, a first electrode may be coupled electrically to a proximal end of the separation channel, an electrode reservoir coupled to the separation channel, or another channel that is in electrical and/or fluidic communication with the separation channel. Similarly, a second electrode may then be coupled to the distal end of the separation channel, an electrode reservoir coupled to the distal end of the separation channel, or another channel that is in electrical and/or fluidic communication with the distal end of the separation channel, and a third electrode may be coupled with a mobilization channel (or a channel or reservoir connected thereto) that intersects with the separation channel, e.g., at a distal end of the separation channel, and that connects to or comprises a reservoir containing mobilization buffers. Upon completion of the separation step, as determined by image-based methods, the electric coupling of the second or third electrodes with their respective channels may be switchable between “on” and “off” states. In one such example, the second electrode that forms the anode or cathode of the separation circuit may switch to an “off” mode, and the third electrode, which may be off during the separation, may switch to an “on” mode, to initiate introduction of mobilization buffer into the channel (e.g., via electrophoresis). In some instances, “on” and “off” states may comprise complete connection or disconnection of the electrical coupling between an electrode and a fluid channel respectively. In some instances, “on” and “off” states may comprise clamping the current passing through a specified electrode to non-zero or zero microamperes, respectively.

In some instances, triggering or initiation of a mobilization step may comprise detecting no change or a change of less than a specified threshold for one or more image-derived separation parameters as described above. For example, in some instances a change of less than 20%, 15%, 10%, or 5% in one or more image-derived parameters (e.g., peak position, peak width, peak velocity, etc.) may be used to trigger the mobilization step.

In some instances, triggering or initiation of a mobilization step may comprise detecting no change or a rate of change of less than a specified threshold for one or more image-derived separation parameters as described above. For example, in some instances a change of less than 20%, 15%, 10%, or 5% in one or more image-derived parameters (e.g., peak position, peak width, peak velocity, etc.) over a time period of at least 10 seconds, 15 seconds, 20 seconds, 25 seconds, 30 seconds, 35 seconds, 40 seconds, 45 seconds, 50 seconds, 55 seconds, or 60 seconds (or any combination of these percentage changes and time periods) may be used to trigger the mobilization step.

In some instances, a calibrant may be used during the mobilization step to correlate and/or calibrate information from the mass spectrometer. In some instances, the calibrant may comprise a peptide, a polypeptide, a protein, or other molecule (either natural or synthetic) with a known mass. In some instances, the calibrant will be mixed with the mobilizer solution. The calibrant may be used to calibrate the mass spectrometer. In some instances, the calibrant may be used to correlate information from the mass spectrometer to the mobilization process or the separation process. For example, the calibrant may be monitored during the separation (e.g., isoelectric focusing) or mobilization.

Electrospray Ionization (ESI) and Mass Spectrometry: In preferred embodiments, the methods, devices, and systems of the present disclosure are configured for performing electrospray ionization of a separated analyte mixture and injection of the separated analyte mixture into a mass spectrometer. In ESI, droplets of sample and solution are emitted from a distal end of a capillary or microfluidic device comprising an electrospray feature, such as an emitter tip or orifice, by the application of an electric field between the capillary tip or emitter tip and the mass spectrometer source plate. In some embodiments, the voltage between the capillary or emitter tip and the mass spectrometer may be between 500 and 6000V, or -−500 and −6000V. The droplet stretches and expands in this induced electric field to form a cone shaped emission (i.e., a “Taylor cone”) which comprises increasingly small droplets that evaporate and produce the gas phase ions that are introduced into the mass spectrometer for further separation and detection. In preferred embodiments, the methods, devices, and systems of the present disclosure include performing a nebulization process (e.g., using a gas channel) during ESI. In some instances, the nebulization may be performed to achieve nanoflow or the generation of nanoscale droplets, which may aid in reduced ion suppression, increased ionization, reduced contamination, more stable electrospray performance, greater accuracy of detection, or higher signal of detection during mass spectrometry. For instance, the ESI performance including nebulization may be characterized by a less than 1.0% standard error fluctuation in total mass spectrometric signal. In some instances, ESI may be performed while flowing a fluid from a fluid inlet through the capillary or a channel and out the distal end of the capillary or channel.

As described herein, in some instances, the microfluidic device (e.g., microfluidic chip or microfluidic cartridge) comprises a fluid orifice that serves as an emitter tip (e.g., an ESI orifice). Emitter tips may be sharpened to provide a small surface and drop volume using a lapping wheel, file, machining tools, CNC machining tools, water jet cutting, or other tools or processes to shape the ESI tip to provide a small surface volume, and the like. In some instances, the emitter tip may be positioned at an edge or corner of a microfluidic device. In other instances, the tip may be drawn by heating and stretching the tip portion of the chip. In some instances, the tip may then be cut to a desired length or diameter. In some instances, the electrospray tip may be coated with a hydrophobic coating which may minimize the size of droplets formed on the tip. In some embodiments, the system may electrospray mobilizer, catholyte, or any other liquid during a separation step, when no analyte is being eluted from the device. In some embodiments, the substrate exit orifice may be further shaped into a wedge, pyramid, cone or other three-dimensional shape. In some embodiments, the shape may include a flat feature where some or all of the channels (gas or fluid) exit. In some embodiments, the substrate maybe be a chemically modified surface that is hydrophobic or hydrophilic or maintains a prescribed contact angle with fluids; water, organic solvents etc.

The mass-to-charge ratio (or “mass”) for analytes expelled from the microfluidic device (e.g., a biologic or biosimilar) and introduced into a mass spectrometer can be measured using any of a variety of different mass spectrometer designs. Examples include, but are not limited to, time-of-flight mass spectrometry, quadrupole mass spectrometry, ion trap or orbitrap mass spectrometry, distance-of-flight mass spectrometry, Fourier transform ion cyclotron resonance, resonance mass measurement, and nanomechanical mass spectrometry.

In some embodiments, the electrospray feature of a microfluidic device may be in-line with a separation channel. In some embodiments, the electrospray feature of a microfluidic device may be oriented at a right angle or at an intermediate angle relative to a separation channel. In some embodiments of the disclosed methods, substantially all of the separated and/or enriched analyte fractions from a final separation or enrichment step performed in a capillary or microfluidic device are expelled from the electrospray tip or feature in a continuous stream. In some embodiments, a portion of the analyte mixture (e.g., a fraction of interest) may be expelled from a microfluidic device via an outlet or fluid orifice configured to interface with an analytical instrument, such as a mass spectrometer or another device configured to fractionate and/or enrich at least a portion of the sample.

In some embodiments, the expulsion from the capillary or microfluidic device is performed using pressure, electric force, ionization, or any combination of these. In some embodiments, the expulsion coincides with a mobilization step as described above. In some embodiments a sheath liquid used for electrospray ionization is used as an electrolyte for an electrophoretic separation. In preferred embodiments, a nebulizing gas (e.g., which flows through a gas channel of the microfluidic device) is provided to nebulize the sample and/or decrease the droplet size during introduction of the sample into an analytical instrument, such as a mass spectrometer. During nebulization, a gas (e.g., air, oxygen, nitrogen, etc.) stream is directed toward the sample at a sufficiently high velocity to aerosolize the sample. The resulting sample comprises smaller droplets, which may then evaporate quicker and allow improved ionization of the sample that is introduced into the mass spectrometer.

Imaging of electrospray ionization performance: Disclosed herein are devices, methods and systems for improving the electrospray ionization performance and thus the quality of mass spectrometry data collected for capillary-based or microfluidic device-based ESI-MS systems. In some instances, imaging of the Taylor cone in an electrospray ionization setup may be used to assess the performance of the nebulization process during ESI. For instance, imaging of the Taylor cone may provide data on the size, shape or other characteristic of the Taylor cone or of the nebulization process (e.g., droplet size, uniformity, etc.). In certain instances, the imaging may be used in a computer implemented method to provide feedback control of one or more operating parameters such that the shape, density, or other characteristic of the Taylor cone is maintained within a specified range. In some embodiments, the operating parameters that may be controlled through such a feedback process include, but are not limited to, the alignment of the electrospray tip or orifice with the mass spectrometer inlet, the distance between the electrospray tip and the mass spectrometer inlet (e.g., by mounting the capillary tip or microfluidic device comprising an integrated electrospray feature on a programmable precision X-Y-Z translation stage), the flow rate of analyte sample through the electrospray tip (e.g., by adjusting the pressure, electric field strength, or combination thereof that are used to drive the expulsion of analyte sample), the voltage applied, e.g., at a proximal end of the channel, e.g., between the electrospray tip or orifice and the mass spectrometer inlet, the volumetric flowrate of a sheath liquid or sheath gas or nebulizer gas surrounding the expulsed analyte sample, or any combination thereof.

Imaging of separation channels: In some instances, the disclosed devices and systems may be configured to perform imaging of all or a portion of at least one separation channel to monitor a separation and/or mobilization reaction while it is performed. In some instances, the disclosed devices and systems may be configured to perform imaging of all or a portion of a plurality of separation channels to monitor a plurality of separation and/or mobilization reactions in parallel while they are performed. In some instances, separation and/or mobilization reactions may be imaged using any of a variety of imaging techniques known to those of skill in the art. Examples include, but are not limited to, ultraviolet (UV) light absorbance, visible light absorbance, fluorescence (e.g., native fluorescence or fluorescence resulting from having labeled one or more analytes with fluorophores), Fourier transform infrared spectroscopy, Fourier transform near infrared spectroscopy, Raman spectroscopy, optical spectroscopy, and the like. In some instances, the plurality of separation (or enrichment) channels may be the lumens of a plurality of capillaries. In some instances, the plurality of separation (or enrichment) channels may be a plurality of fluid channels within a microfluidic device. In some instances, all or a portion of a separation (or enrichment) channel, a junction or connecting channel that connects an end of the separation channel and a downstream analytical instrument or an electrospray orifice or tip, the electrospray orifice or tip itself, or any combination thereof may be imaged. In some instances, the separation (or enrichment) channel may be the lumen of a capillary. In some instances, the separation (or enrichment) channel may be a fluid channel within a microfluidic device.

The wavelength range(s) used for imaging and detection of separated analyte bands will typically depend on the choice of imaging technique and the material(s) out of which the device or portion thereof are fabricated. For example, in the case that UV light absorbance is used for imaging all or a portion of the separation channel or other part of the microfluidic device, detection at about 220 nm (due to a native absorbance of peptide bonds) and/or at about 280 nm (due to a native absorbance of aromatic amino acid residues) may allow one to visualize protein bands during separation and/or mobilization provided that at least a portion of the device, e.g., the separation channel or a portion thereof, is transparent to light at these wavelengths. In some instances, the analytes to be separated may be labeled prior to separation with, e.g., a fluorophore, chromophore, chemiluminescent tag, or other suitable label, such that they may be imaged using fluorescence imaging, UV absorbance imaging, or other suitable imaging techniques. In some instances, e.g., wherein the analytes comprise proteins produced by a commercial manufacturing process, the proteins may be genetically-engineered to incorporate a green fluorescence protein (GFP) domain or variant thereof, so that they may be imaged using fluorescence. In some instances, labeling proteins or other analyte molecules may be performed using an approach to ensure that the label itself doesn't interfere with or perturb the analyte property on which the chosen separation technique is based.

In some instances, imaging (or data derived therefrom) may be used to trigger, e.g., a mobilization step or other transfer of separated analyte fractions or portions thereof from a first separation channel or plurality of separation channels to a second separation channel or second plurality of separation channels, or from a first separation channel or plurality of separation channels to a second separation channel or plurality of separation channels that are in fluid communication with the outlet ends of the first channel or plurality of separation channels. For example, in some instances the disclosed methods may comprise injecting analyte mixtures into a microfluidic device containing a first plurality of separation channels and a second plurality of separation channels. The first plurality of separation channels may contain a medium configured to bind an analyte from the sample analyte mixture. Accordingly, when the sample analyte mixtures are loaded or injected into the device, e.g., a microfluidic device or microfluidic cartridge, at least a fraction of the analyte in each sample analyte mixture may be bound to the matrix and/or impeded from flowing through the first plurality of separation channels. For example, injecting the analyte mixtures into the microfluidic device can effect a chromatographic separation in the first plurality of separation channels. An eluent can then be injected into the microfluidic device such that at least a fraction of the analyte, if present, is mobilized from the media in each separation channel. In some instances, the first plurality of separation channels may be imaged while the analyte is mobilized. In some instances, imaging of the first plurality of separation reactions may comprise whole column (e.g., whole channel) imaging and/or imaging a portion of the separation channels. In some instances, an electric field may be applied to the second plurality of separation channels when the imaging detects that an analyte fraction is disposed at intersections of the first plurality of separation channels and the second plurality of separation channels such that the analyte fractions are electro-kinetically injected into the second plurality of separation channels. For example, in some instances, the first plurality of separation channels and the second plurality of separation channels may form a series of T-junctions. In some instances, imaging may be used to detect when an analyte fraction (e.g., a fraction of interest) is at one or more of the series of T-junctions. Applying the electric field can electro-kinetically inject the analyte fraction of interest (and, optionally, not other analyte fractions that are not located at the series of T-junctions) into the second plurality of separation channels for a second stage of separation. In some instances, the electric field may be applied independently to one or more of the second plurality of separation channels depending on whether or not an analyte fraction of interest is detected at one or more of the T-junctions.

In some instances, imaging may be performed during mobilization to monitor the mobilization reaction. In some instances, the imaging system used to monitor the separation reaction may also be used to monitor the mobilization reaction. In some instances, only a portion of the channel or plurality of channels may be imaged to monitor the mobilization reaction. In some instances, the entire channel or plurality of channels may be imaged, and only a portion of the imaged channel or plurality of channels may be used to monitor the mobilization reaction. For example, the channels may be imaged at a given sampling rate, and for each image generated, the portion of the image corresponding to the distal end of the channel or channels may be used to generate a mobility chromatogram. The mobility chromatogram may provide information on, for example, the average absorbance of a certain pixel width (e.g., 8 pixels) as a function of time. In some instances, the pixel width of the image used to generate the mobility chromatogram (e.g., corresponding to the distal end of the channel) may comprise at least 1 pixel, at least 2 pixels, at least 3 pixels, at least 4 pixels, at least 5 pixels, at last 6 pixels, at least 7 pixels, at least 8 pixels, at least 9 pixels, at least 10 pixels, at least 15 pixels, at least 20 pixels, at least 25 pixels, at least 30 pixels, at least 35 pixels, at least 40 pixels, at least 50 pixels, at last 60 pixels, at least 70 pixels, at least 80 pixels, at least 90 pixels, at least 100 pixels.

The mobility chromatogram may be used to determine a parameter of the mobilization reaction. For example, the mobility chromatogram may be used to calibrate the mass spectrometer, to determine the time-of-flight information, peak width, peak velocity, peak mobility, peak position, etc., of one or more analytes. In some instances, the mobility chromatogram may be generated in real-time. In some instances, the mobility chromatogram may be generated at a sampling rate (e.g., Nyquist sampling rate, 1-2 Hz, or a frequency that matches the sampling rate of the mass spectrometer). In some instances, the chromatogram may be used to yield information on the absorbance of a segment of the channel as a function of time.

System and system components: In some instances, the systems of the present disclosure may comprise one or more of the disclosed devices (e.g., microfluidic devices), one or more high voltage power supplies (or in cases of multiple parallel separations, a single, multiplexed high voltage power supply that allows independent control of two or more channels), an autosampler and/or fluid handling system, a fluid flow controller, an imaging module, a dynamic light scattering module, a microplate-handling robotics module, a waste management module (e.g., to remove or prevent accumulation of fluid droplets from accumulating on the exterior of an electrospray tip), an electrode interfacing unit, a processor or computer, or any combination thereof.

High voltage power supplies: In some instances, the one or more high voltage power supplies of the disclosed systems (or a single, multiplexed high voltage power supply that allows independent control of two or more channels) are configured to provide simultaneous, independent electrical control of a plurality of separation channels, e.g., to simultaneously and independently apply a specified voltage or current to each of a plurality of separation channels or auxiliary fluid channels (e.g., mobilization channels used to deliver a chemical mobilization agent to a separation channel following completion of an isoelectric focusing reaction). In some instances, the two or more high voltage power supplies of the disclosed systems (or a single, multiplexed high voltage power supply that allows independent control of two or more channels) are configured to monitor and/or record the current flowing through each separation channel of a plurality of separation channels (not just the total current). As described herein, the separation channels may comprise different samples or the same sample (e.g., aliquots of a sample). In some instances, the current flowing through each separation channel may be used, for example, to determine when an isoelectric focusing reaction is complete and/or to detect a failure (e.g., introduction or formation of a bubble in a separation channel).

In some instances, the two or more high voltage power supplies may be programmed or otherwise configured to run in constant voltage mode, e.g., where the voltage applied across each of a plurality of separation channels and/or auxiliary channels is held fixed for the duration of a separation reaction or for a specified period of time. In some instances, the two or more high voltage power supplies may be programmed or otherwise configured to make stepwise changes in the voltage applied across each of a plurality of separation channels and/or auxiliary channels from a first specified voltage to at least a second specified voltage at one or more specified times. In some instances, the two or more high voltage power supplies may be programmed or otherwise configured to make two, three, four, five, or more than five stepwise changes in voltage over the course of a separation reaction.

In some instances, the two or more high voltage power supplies may be programmed or otherwise configured to run in constant power mode, e.g., to raise the voltage applied to a given separation channel as the current drops during a separation reaction due to conductivity changes, thereby allowing one to increase the voltage to minimize separation time without inducing excess Joule heating.

As noted above, in some instances the electric field used to perform electrophoretic separation or isoelectric focusing reactions (or other electrokinetic injection or separation processes) may range from about 0 V/cm to about 1,000 V/cm. Accordingly, in some instances, the two or more high voltage power supplies of the disclosed systems may be configured to provide an adjustable voltage ranging from about 0 volts to about 5,000 volts (e.g., for a 5 cm long separation channel). In some instances, the two or more high voltage power supplies may be configured to provide an adjustable voltage of at least 0, at least 5, at least 10, at least 50, at least 100, at least 500, at least 1,000, or at least 5,000 volts. In some instances, the two or more high voltage power supplies may be configured to provide an adjustable voltage of at most 5,000, at most 1,000, at most 500, at most 100, at most 50, at most 10, or at most 5 volts. Any of the lower and upper values described in this paragraph may be combined to form a range included within the present disclosure, for example, in some instances the two or more high voltage power supplies may be configured to provide an adjustable voltage ranging from about 100 volts to about 1,000 volts. Those of skill in the art will recognize that the two or more high voltage power supplies may be configured to provide an adjustable voltage of any value within this range, e.g., about 1,250 volts.

Fluid flow controllers: In some instances, the disclosed systems may comprise one or more programmable fluid flow controllers configured to provide, e.g., independently-controlled, pressure-driven flow through one or more separation channels (e.g., for use alone or in combination with a voltage gradient applied to the one or more separation channels) or auxiliary channels that intersect with the separation channels. In some instances, pressure-driven flow may be used for mobilizing separated analyte peaks out of a separation channel. In some instances, pressure-driven flow may be used, e.g., for introducing a chemical mobilization agent into a separation channel (e.g., an electrolyte that disrupts the pH gradient used for isoelectric focusing), thereby mobilizing separated analyte peaks out of the separation channel. In some instances, pressure-driven flow may be used, e.g., for introducing a chemical mobilization agent into a separation channel (e.g., an elution buffer for eluting analytes from a stationary phase confined within a separation channel), thereby mobilizing separated analyte peaks out of the separation channel. In some instances, the flow may be controlled by integration of flow restrictors into the device, e.g., long capillary or channel lengths to increase the hydrodynamic resistance and provide uniform flow profiles and electrospray performance.

Control of pressure-driven fluid flow through the disclosed devices and systems will typically be performed through the use of pumps (or other fluid actuation mechanisms) and valves. Examples of suitable pumps include, but are not limited to, syringe pumps, programmable syringe pumps, peristaltic pumps, diaphragm pumps, piston pumps and the like. In some embodiments, fluid flow through the system may be controlled by means of applying positive pneumatic pressure at the one or more fluid inlets or sample or reagent reservoirs on the device. In some embodiments, fluid flow through the system may be controlled by means of drawing a vacuum at the one or more fluid outlets or waste reservoirs. Examples of suitable valves include, but are not limited to, check valves, electromechanical two-way or three-way valves, pneumatic two-way and three-way valves, and the like. In some instances, one or more micropumps or (e.g. peristaltic pumps, piezo pumps), microvalves (e.g., metered injection valves, piezo valves, stopcock valves, slide valves) may be integrated within the device. In certain cases, control or pressure-driven fluid flow through the disclosed devices and systems may be performed using a bladder, blister pack, pistons, screws, glass frits, or a combination thereof. In some instances, the pressure-driven fluid flow may be pulse-less.

In some embodiments, fluid flow through the system may be controlled using one or more device or system parameters. In some instances, flow may be generated in the device by altering the temperature of the system (e.g., to change the gas pressure in an area of the device) or by introducing a temperature gradient. In some instances, the reservoir height may be changed to drive flow through one or more channels of the device (e.g., via hydrostatic pressure). In some instances, a portion of the device (e.g., an inlet or outlet) may be exposed and allowed to evaporate, thereby driving fluid flow through the channels. In some instances, the fluid flow may be pulse-less.

In some instances, fluid flow through the disclosed devices and systems may be performed electrically. For instance, electroosmotic flow in one or more of the channels of the device or outside the channel may be performed using, for example, an electroosmotic pump.

Gas flow controllers: In some instances, the disclosed systems may comprise one or more programmable gas flow controllers configured to provide, e.g., independently-controlled, pressure-driven gas flow through one or more gas channels or auxiliary channels that intersect with the fluid channels. In some instances, the flow may be controlled by integration of flow restrictors into the device, e.g., long capillary or channel lengths to increase the hydrodynamic resistance, varying geometries, etc. to provide uniform gas flow profiles.

Control of pressure-driven gas flow through the disclosed devices and systems can comprise the use of pumps (or other fluid/gas actuation mechanisms) and valves. In some embodiments, gas flow through the system may be controlled by means of applying positive pneumatic pressure at the one or more gas inlets of the device. In some embodiments, gas flow through the system may be controlled by means of drawing a vacuum at the one or more gas outlets. Examples of suitable valves include, but are not limited to, check valves, electromechanical two-way or three-way valves, pneumatic two-way and three-way valves, and the like. In some instances, one or more micropumps (e.g. peristaltic pumps, piezo pumps) or microvalves (e.g., metered injection valves, piezo valves, stopcock valves, slide valves) may be integrated within the device. In certain cases, control or pressure-driven gas flow through the disclosed devices and systems may be performed using a bladder, blister pack, pistons, screws, glass frits, or a combination thereof. In some instances, the pressure-driven gas flow may be pulse-less.

In some embodiments, gas flow through the system may be controlled using one or more device or system parameters. In some instances, flow may be generated in the device by altering the temperature of the system (e.g., to change the gas pressure in an area of the device) or by introducing a temperature gradient. In some instances, the reservoir height may be changed to drive flow through one or more channels of the device (e.g., via hydrostatic pressure). In some instances, the fluid flow may be pulse-less.

Gas flow through the one or more gas channels may be performed using a motive force, e.g., pressure-driven flow, electrokinetic force, gravitational force, centrifugal force, etc., or a combination thereof. In some instances, the gas flow is driven using a compressed gas source. In some preferred instances, the inlet gas pressure upstream of the gas outlet orifice ranges from 100-110 pounds per square inch (PSI). The inlet gas pressure upstream of the gas outlet orifice may be about 50 PSI, about 60 PSI, about 70 PSI, about 80 PSI, about 90 PSI, about 100 PSI, about 110 PSI, about 120 PSI, about 130 PSI, about 140 PSI, about 150 PSI or more. In some instances, the inlet gas pressure upstream of the gas outlet orifice may be at least about 50 PSI, at least about 60 PSI, at least about 70 PSI, at least about 80 PSI, at least about 90 PSI, at least about 100 PSI, at least about 110 PSI, at least about 120 PSI, at least about 130 PSI, at least about 140 PSI, at least about 150 PSI or more. In some instances, the inlet gas pressure upstream of the gas outlet orifice may be at most about 150 PSI, at most about 140 PSI, at most about 130 PSI, at most about 120 PSI, at most about 110 PSI, at most about 100 PSI, at most about 90 PSI, at most about 80 PSI, at most about 70 PSI, at most about 60 PSI, at most about 50 PSI or less. The inlet gas pressure upstream of the gas outlet orifice may fall in a range, e.g., from about 50 PSI to about 110 PSI. The gas pressure at the gas outlet orifice may be about 0 PSI, about 5 PSI, about 10 PSI, about 15 PSI, or about 20 PSI. In particular aspects, the gas pressure at the gas outlet orifice may be about 0 PSI.

The gas flow rate may fall in a range of values and may be adjusted according to the specific geometry or utility (e.g., for nebulization, for drying the ESI tip, etc.). The gas flow rate may be about 10 m/s, about 20 m/s, about 30 m/s, about 40 m/s, about 50 m/s, about 60 m/s, about 70 m/s, about 80 m/s, about 90 m/s, about 100 m/s, about 150 m/s, about 200 m/s, about 300 m/s, about 400 m/s, about 500 m/s or more. The gas flow rate may be at least about 10 m/s, at least about 20 m/s, at least about 30 m/s, at least about 40 m/s, at least about 50 m/s, at least about 60 m/s, at least about 70 m/s, at least about 80 m/s, at least about 90 m/s, at least about 100 m/s, at least about 150 m/s, at least about 200 m/s, at least about 300 m/s, at least about 400 m/s, at least about 500 m/s or more. The gas flow rate may be at most about 500 m/s, at most about 400 m/s, at most about 300 m/s, at most about 200 m/s, at most about 100 m/s, at most about 90 m/s, at most about 80 m/s, at most about 70 m/s, at most about 60 m/s, at most about 50 m/s, at most about 40 m/s, at most about 30 m/s, at most about 20 m/s, at most about 10 m/s or less. The gas flow rate may fall in a range of values, e.g., between about 50 m/s and 150 m/s. In some aspects, the gas flow rate may be at sonic speed (e.g. about 350 m/s) depending on ambient conditions. In some aspects, the gas flow rate may be at supersonic speed depending on ambient conditions.

The gas source may comprise air, nitrogen, oxygen, a noble gas (e.g. helium, argon, etc.), an electron carrier gas, (e.g., nitrous oxide, or a fluoropolymer, e.g., fluorourethane). A combination of gases may be used, e.g., nitrogen and oxygen. In some instances, a solvent may be added to the gas line (e.g., methanol), which may aid in driving charge onto the molecules when the gas stream converges with the fluid flow path of the liquid at or near the fluid discharge channel orifice. In some instances, the gas source may be obtained from an analytical instrument (e.g., mass spectrometer) and may be integrated into the devices, systems, and methods described herein.

Different modes of fluid flow control may be utilized at different points during the performance of the disclosed analyte separation methods, e.g., forward flow (relative to the inlets and outlets for a given device or fluid or gas channel), reverse flow, oscillating or pulsatile flow, or combinations thereof, may all be used. For example, in some instances, oscillating or pulsatile flow may be used, for example, during device priming steps to facilitate dislodgement of any bubbles that may be trapped within the device. In some instances, the devices may be subjected to vacuum (e.g., degassed) for device priming, e.g., to facilitate bubble-free introduction of a fluid or reagent.

Different fluid flow rates may be utilized at different points during the performance of the disclosed analyte separation methods. For example, in some instances of the disclosed devices and system, the volumetric flow rate may vary from −100 mL/s to +100 mL/s. In some instances, the absolute value of the volumetric flow rate may be at least 0.001 mL/s, at least 0.01 mL/s, at least 0.1 mL/s, at least 1 mL/s, at least 10 mL/s, or at least 100 mL/s. In some instances, the absolute value of the volumetric flow rate may be at most 100 mL/s, at most 10 mL/s, at most 1 mL/s, at most 0.1 mL/s, at most 0.01 mL/s, or at most 0.001 mL/s. The volumetric flow rate at a given point in time may have any value within this range, e.g., a forward flow rate of 2.5 mL/s, a reverse flow rate of −0.05 mL/s, or a value of 0 mL/s (i.e., stopped flow). In some instances, the pressure-driven fluid flow mode and/or fluid flow velocities through each separation channel and/or auxiliary fluid channels may be programmed independently of each other to follow a specified time-course.

During ESI, the flow rate of the sample (or separated sample) from the ESI orifice can be tuned to obtain substantially nano-volumetric flow. For instance, the flow rate of the sample as it is emitted to form a Taylor cone may be approximately 1 nanoliter per minute (nL/min), 5 nL/min, 10 nL/min, 20 nL/min, 30 nL/min, 40 nL/min, 50 nL/min, 60 nL/min, 70 nL/min, 80 nL/min, 90 nL/min, 100 nL/min, 200 nL/min, 300 nL/min, 400 nL/min, 500 nL/min, 600 nL/min, 700 nL/min, 800 nL/min, 900 nL/min, 1000 nL/min (1 μL/min), 2 μL/min, 3 μL/min, 4 μL/min, 5 μL/min, 10 μL/min or more. The flow rate of the sample as it is emitted to form a Taylor cone may be at least about 1 nanoliter per minute (nL/min), at least about 5 nL/min, at least about 10 nL/min, at least about 20 nL/min, at least about 30 nL/min, at least about 40 nL/min, at least about 50 nL/min, at least about 60 nL/min, at least about 70 nL/min, at least about 80 nL/min, at least about 90 nL/min, at least about 100 nL/min, at least about 200 nL/min, at least about 300 nL/min, at least about 400 nL/min, at least about 500 nL/min, at least about 600 nL/min, at least about 700 nL/min, at least about 800 nL/min, at least about 900 nL/min, at least about 1000 nL/min (1 μL/min), at least about 2 μL/min, at least about 3 μL/min, at least about 4 μL/min, at least about 5 μL/min, at least about 10 μL/min or more. The flow rate of the sample as it is emitted to form a Taylor cone may be at most about 10 μL/min , at most about 5 μL/min, at most about 4 μL/min, at most about 3 μL/min, at most about 2 μL/min, at most about 1 μL/min, at most about 900 nL/min, at most about 800 nL/min, at most about 700 nL/min, at most about 600 nL/min, at most about 500 nL/min, at most about 400 nL/min, at most about 300 nL/min, at most about 200 nL/min, at most about 100 nL/min, at most about 90 nL/min, at most about 80 nL/min, at most about 70 nL/min, at most about 60 nL/min, at most about 50 nL/min, at most about 40 nL/min, at most about 30 nL/min, at most about 20 nL/min, at most about 10 nL/min, at most about 9 nL/min, at most about 8 nL/min. at most about 7 μL/min, at most about 6 μL/min, at most about 5 μL/min, at most about 4 μL/min, at most about 3 μL/min, at most about 2 μL/min, at most about 1 μL/min. The flow rate of the sample as it is emitted to form a Taylor cone may fall in a range of values, e.g., about 500 nL/min to about 1 μL/min.

Autosamplers and fluid handling systems: In some instances, the disclosed systems may further comprise an autosampler or fluid handling system configured for automated, independently controlled loading of sample aliquots and/or other separation reaction reagents into a plurality of sample or reagent inlet ports to the separation channels. In some instances, a custom-built autosampler or fluid handling module may be incorporated into the disclosed systems. In some instances, a commercially-available autosampler or fluid handling module may be integrated into the disclosed systems. Examples of suitable commercially-available autosamplers include, but are not limited to, the Agilent 1260 Infinity Dual Loop Autosampler and 1260 Infinity High Performance Micro Autosampler (Agilent Technologies, Santa Clara, Calif.), the HT1500L HPLC Autosampler (HTA, Brescia, Italy), the Spark Holland Alias (Spark-Holland, Emmen, Netherlands), and the SIL-20A/AC HPLC Autosampler (Shimadzu, Columbia, Me). Examples of suitable commercially-available fluid handling systems (or liquid handling systems) include, but are not limited to, the Tecan Fluent® system (Tecan Trading AG, Switzerland), the Hamilton Microlab STAR and Microlab NIMBUS systems (Hamilton, Reno, Nev.), and the Agilent Bravo Automated Liquid Handling Platform and Agilent Vertical Pipetting Station (Agilent Technologies, Santa Clara, Calif.).

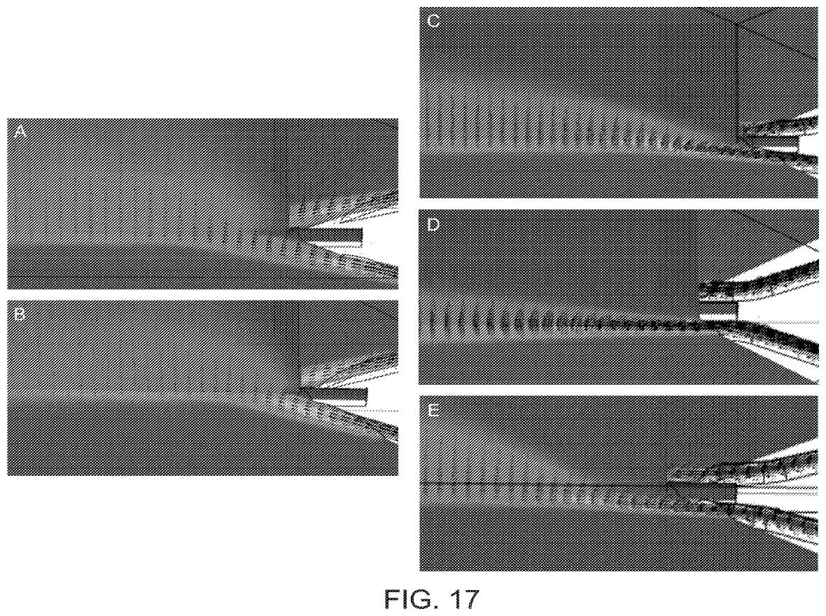

In some instances, one or more fluid flow controllers or fluid handling systems may be used for filling or replenishing one or more reservoirs. The reservoirs may be in fluid communication with the cartridge, microfluidic device, or assemblies as described herein, or may be connected to fluid lines that interface with the cartridge or assembly, e.g., via an interfacing unit (see, e.g., FIGS. 17A-17B and Example 9 below). The reservoirs may comprise, for instance, a compressed gas unit, reagents for performing a separation reaction (e.g., catholyte, anolyte, carrier ampholytes, etc.), reagents for performing a mobilization reaction, or reagents for performing an electrospray ionization reaction.

Waste management: In some instances, the gas channel or plurality of gas channels of the microfluidic device is used to manage waste within or adjacent to the fluid (e.g., separation) channel. The gas channel may be used, for instance, to direct fluid away from the fluid orifice that is in fluid communication with the separation channel. For example, the gas channel may be used to direct the fluid toward a waste receptacle or generally away from the downstream analytical instrument (e.g., mass spectrometer). In some instances, the gas channel expels air at the gas outlet orifice adjacent to the fluid orifice, which air stream is used to remove excess liquid from the fluid orifice (which may comprise or serve as the electrospray tip). In some instances, the gas channel may be used to clean the electrospray tip. For instance, higher pressures may be applied to direct excess fluid or waste products away from the electrospray tip.

In certain embodiments, the system comprises waste management modules which can either be integrated with (i.e., attached to) or be separate from the microfluidic device. The waste management module may be used to collect a waste product from the microfluidic device. In some instances, the waste management module may additionally or alternatively be used to manage droplet formation at an outlet or surface of the microfluidic device. For example, the waste management module may be used to prevent droplets from forming at the outlet (e.g., electrospray tip) of the device and/or wicking of the droplets to a different segment or portion of the device (e.g., the inlets, interfaced electrodes, etc.). In some instances, the waste management module may comprise application of positive or negative pressure (e.g., vacuum). In such cases, a vacuum may be applied to a part of the microfluidic device (e.g., the outlet or electrospray tip). For example, a flange or adaptor may be applied to the chip, thereby allowing the vacuum to be interfaced with the device with minimal disruption to the placement of the device or to any downstream analysis units (e.g., mass spectrometer). The vacuum may then be used to aspirate droplets or waste products as they are expelled from the outlet or electrospray tip. In some instances, the waste management module uses positive pressure. For example, an air stream (e.g., from a nebulizer module) may be used to direct droplets away from the electrospray tip. In such an example, the air stream may be connected to an air or nitrogen gas source and/or pressurizer to generate air (or nitrogen gas) pressure to eject the droplets or direct the droplets away from the device or portion thereof (e.g., electrospray tip). In some instances, the waste management module may comprise a nebulizing unit. For example, a nebulizer may be configured to secure to the chip. The nebulizer may comprise geometries necessary to direct air towards the chip such that the droplets or waste products are directed away from the electrospray tip or outlet (e.g., to a waste receptacle). The nebulizer may comprise sealing mechanisms and may be connected to an air source and/or pressurizer to generate air pressure to eject the droplets or direct the droplets away from the electrospray tip. In some instances, the nebulizer may comprise a nozzle. The nebulizer may be comprised of a polymer, metal, or ceramic material.

In some instances, the waste management methods described herein are used in conjunction with other approaches for waste management. For example, the device may comprise a geometry or chemical/material properties that allow for control of droplet formation at the fluid orifice or outlet and/or to minimize wicking of droplets and fluids to a different segment or portion of the device (e.g., electrodes or inlets). In some instances, a coating may be used to allow for droplet formation at the tip or outlet of the device and may aid in the prevention of the wicking of fluids to other segments or portions of the device. In some cases, the coating may be a hydrophobic coating.

In some instances, the geometry or orientation of the device may be used to control droplet formation at the outlet and/or to minimize wicking of droplets to a different segment or portion of the device. For example, the outlet or electrospray tip may be formed into a triangular tip to allow for optimal droplet formation. In some instances, the geometries of the device may be used to control waste management. For example, in instances where the microfluidic device comprises a gas channel and a fluid channel, the geometry of the gas channel may be optimized to allow high gas pressures to direct fluid away from the fluid orifice or outlet. The high gas pressures may also be used to remove, for instance, debris or other unwanted products or byproducts from the fluid orifice (e.g., ESI tip).

Imaging module: In some instances, the system may further comprise an imaging module configured to acquire a series of one or more images of the two or more separation channels, or a portion thereof. In some instances, the field-of-view of the images may comprise all or a portion of the two or more separation channels. In some instances, the imaging may comprise continuous imaging of all or a portion of the two or more separation channels while separation and/or mobilization reactions are performed. In some instances, the imaging may comprise intermittent or periodic imaging of all or a portion of the two or more separation channels while separation and/or mobilization reactions are performed. In some instances, the imaging may comprise acquiring UV absorbance images. In some instances, the imaging may comprise acquiring fluorescence images, e.g., of native fluorescence or fluorescence due to the presence of exogenous fluorescent labels attached to the analytes. In some instances, the imaging module may be configured, for example, to determine when an isoelectric focusing reaction is complete and/or to detect a failure (e.g., the introduction or formation of a bubble in a separation channel).

Any of a variety of imaging systems or system components may be utilized for the purpose of implementing the disclosed methods, devices, and systems. Examples include, but are not limited to, one or more light sources (e.g., light emitting diodes (LEDs), diode lasers, fiber lasers, gas lasers, halogen lamps, arc lamps, etc.), condenser lenses, objective lenses, mirrors, filters, beam splitters, prisms, image sensors (e.g., CCD image sensors or cameras, CMOS image sensors or cameras), and the like, or any combination thereof. In some instances, the one or more light sources may comprise an array of light sources. For example, a LED array may be used to illuminate one or more regions of the device. Depending on the imaging mode utilized, the light source and image sensor may be positioned on opposite sides of the microfluidic device, e.g., so that absorbance-based images may be acquired. In some instances, the light source and image sensor may be positioned on the same side of the microfluidic device, e.g., so that epifluorescence images may be acquired.

As noted above, images may be acquired continuously during the separation and/or mobilization steps or may be acquired at random or specified time intervals. In some instances, a series of one or more images are acquired continuously or at random or specified time intervals. In some instances, a series of short exposure images (e.g., 10-20 images) are acquired on a fast (e.g., millisecond timescale) and are then averaged to provide a “single image” having improved signal-to-noise ratio. In some instances, a “single image” is acquired every 1 second, 5 seconds, 10 seconds, 20 seconds, 30 seconds, or at longer time intervals. In some instances, longer exposure times may be used to improve signal-to-noise ratio. In some instances, the series of one or more images may comprise video images.

Image processing: In some instances, as noted above, the system may comprise processors, controllers, or computers configured to run image processing software for detecting the presence of analyte peaks, determining the positions of pI markers or separated analyte bands, determining peak width, determining peak shapes (e.g., Gaussian fitting or other curve-fitting algorithms), or changes in any of these parameters over time. In some instances, image processing may be used for detection of a failure, e.g., introduction or formation of a bubble in one of the two or more separation channels. Any of a variety of image processing algorithms may be utilized for image pre-processing or image processing in implementing the disclosed methods and systems. Examples include, but are not limited to, Canny edge detection methods, Canny-Deriche edge detection methods, first-order gradient edge detection methods (e.g., the Sobel operator), second order differential edge detection methods, phase congruency (phase coherence) edge detection methods, other image segmentation algorithms (e.g., intensity thresholding, intensity clustering methods, intensity histogram-based methods, etc.), feature and pattern recognition algorithms (e.g., the generalized Hough transform for detecting arbitrary shapes, the circular Hough transform, etc.), and mathematical analysis algorithms (e.g., Fourier transform, fast Fourier transform, wavelet analysis, auto-correlation, Savitzky-Golay smoothing, Eigen analysis, etc.), or any combination thereof.

Microplate-handling robotics: In some instances, the system may further comprise a microplate-handling robotics module configured to transport and replace microplates that serve as sources for samples and/or reagents. In some instances, the system may further comprise a microfluidic device-handling robotics module configured to transport and replace the microfluidic devices used in the system, e.g., after a failure is detected. In some instances, the microplate-handling and the microfluidic device-handling may be handled by the same robotics module. In some instances, custom robotics may be incorporated into the disclosed systems to perform these functions. In some instances, commercially-available robotics systems may be adapted and/or integrated into the disclosed systems to perform these functions. Examples of suitable microplate handling robotics systems include, but are not limited to, Tecan Robotic Gripper Arms (Tecan Trading AG, Switzerland) and the Agilent Direct Drive and BenchBot Robots (Agilent Technologies, Santa Clara, Calif.).

Temperature control: In some instances, the disclosed systems and methods may be subjected to temperature control. In some instances, the gas channel or plurality of gas channels of the device may be used to regulate or control the temperature of the substrate. For instance, the temperature of the gas may be varied, such that heat can be dissipated into or from the gas channel(s) to heat or cool the device. In some instances, a portion of the system (e.g., a portion of the device) may be subjected to temperature control. In some instances, the system or one or more components of the system may be cooled using, for example a Peltier, a fan or other heat dissipater, or an air knife. In some instances, the cooling system may be integrated with the waste management system (e.g., air knife). In some instances, the cooling system may comprise a compressor for cooling. In some instances, the system may comprise an environmental or temperature-controlled chamber. In some instances, cooling blocks or pre-cooled blocks may be used (e.g., coupled to the stage or cartridge). In some instances, the system or component thereof may be constructed from materials that allow for heat exchange with the environment. In some instances, the system may comprise a liquid heat exchanger. In some embodiments, the system will control temperature in the range of about 15-35° C. In some embodiments, the system will control temperature within about +/−5° C. In some embodiments, the system will control temperature within about +/−1° C.

Applications: The disclosed methods, devices, and systems have potential application in a variety of fields including, but not limited to, proteomics research, cellular research, drug discovery and development, and clinical diagnostics. For example, the improved reproducibility and quantitation that may be achieved for separation-based characterization of analyte samples using the disclosed methods may be of great benefit for the characterization of biologic and biosimilar pharmaceuticals during development and/or manufacturing.

Biologics and biosimilars are a class of drugs which include, for example, recombinant proteins, antibodies, live virus vaccines, human plasma-derived proteins, cell-based medicines, naturally-sourced proteins, antibody-drug conjugates, protein-drug conjugates and other protein drugs. The FDA and other regulatory agencies require the use of a stepwise approach to demonstrating biosimilarity, which may include a comparison of the proposed product and a reference product with respect to structure, function, animal toxicity, human pharmacokinetics (PK) and pharmacodynamics (PD), clinical immunogenicity, and clinical safety and effectiveness (see “Scientific Considerations in Demonstrating Biosimilarity to a Reference Product: Guidance for Industry”, U.S. Department of Health and Human Services, Food and Drug Administration, April 2015). Examples of the structural characterization data that may be required for protein products include primary structure (i.e., amino acid sequence), secondary structure (i.e., the degree of folding to form alpha helix or beta sheet structures), tertiary structure (i.e., the three dimensional shape of the protein produced by folding of the polypeptide backbone and secondary structural domains), and quaternary structure (e.g., the number of subunits required to form an active protein complex, or the protein's aggregation state)). In many cases, this information may not be available without employing laborious, time-intensive, and costly techniques such as x-ray crystallography. Thus there is a need for experimental techniques that allow for convenient, real-time, and relatively high-throughput characterization of protein structure for the purposes of establishing biosimilarity between candidate biological drugs and reference drugs.

In some instances, the disclosed methods, devices, and systems may be used to provide structural comparison data for biological drug candidates (e.g., monoclonal antibodies (mAb)) and reference biological drugs for the purpose of establishing biosimilarity. For example, in some instances, determination of the isoelectric point for a drug candidate and a reference drug may provide important evidence in support of a demonstration of biosimilarity. In some embodiments, isoelectric point data for a drug candidate and a reference drug that have both been treated with a site-specific protease under identical reaction conditions may provide important evidence in support of a demonstration of biosimilarity. In some embodiments, the disclosed methods, devices, and systems may be used to monitor a biologic drug manufacturing process (e.g., to monitor bioreactor processes in real time) to ensure the quality and consistency of the product by analyzing samples drawn at different points in the production process, or samples drawn from different production runs.

The disclosed devices and systems for performing multiple, independently-controlled separation reactions in parallel provide a number of advantages over currently available technologies, for example, the ability to perform different isoelectric focusing reactions (or other separation reactions) in different channels (e.g., using different pH gradients, different focusing times, different focusing voltages, etc.) for more detailed and accurate sample characterization (e.g., more accurate determination of pIs), or the ability to simultaneously process a plurality of samples in parallel using the same set of separation reaction conditions for higher throughput sample characterization. Furthermore, the independent monitoring and/or recording of current traces and/or voltage settings used for each separation channel may be advantageous in meeting the data tracking requirements for FDA submissions when attempting to demonstrate biosimilarity, etc. As noted, in some instances, the disclosed devices and systems may be configured to identify sample run failures, e.g., the presence or formation of bubbles in the microfluidic device, and to initiate recovery steps, e.g., by automatically re-loading samples from a microtiter plate or other sample source and repeating the separation reaction.

### EXAMPLES

These examples are provided for illustrative purposes only and not to limit the scope of the claims provided herein.

### Example 1

### Microfluidic Device Comprising Multiple Separation Channels

FIG. 1A provides a drawing of one non-limiting example of a microfluidic device for performing a plurality of separation reactions, e.g., isoelectric focusing reactions. The device comprises a lower substrate 101, which may be substantially planar, comprising fused silica in which fluid channels measuring 210 μm wide and 100 μm in depth are fabricated using, e.g., embossing, laser micromachining, or photolithography and wet chemical etching. The fluid channels are sealed by bonding substrate 101 to a transparent coverslip 102. In some instances, e.g., in cases where UV absorbance imaging is used to monitor separation and/or mobilization reactions, substrate 101 may be fabricated from an optically transparent material. In some instances, e.g., where epifluorescence imaging is used to monitor separation and/or mobilization reactions, substrate 101 may be fabricated from an optically opaque material. Although illustrated as a rectangular shape, it will be appreciated that the device may take any useful shape. In some embodiments, the microfluidic device may comprise a tip (e.g., at the distal end), which may allow for fluid to be directed away from the device (e.g., to a waste receptacle or analysis unit, e.g., mass spectrometer).

Access to the fluid channels within the device is provided through sample inlet ports 103, anode wells 104, cathode wells 106, sample outlet ports 107, and chemical mobilization agent inlet ports 109. One anode well 104 and cathode well 106 are in fluid- and electrical communication with a proximal end and distal end of each separation channel 105, respectively (four separation channels are shown in this non-limiting example). The electrodes can, in some instances, be placed in contact with the anode well 104 and cathode well 106. The separation channels extend beyond the cathode wells 106 to sample outlet ports 107 (only labeled for two of the four separation channels shown in the figure). Chemical mobilization agent inlet ports 109 are connected to the distal ends of separation channels 105 via chemical mobilization channels 108 (only labeled for two of the four separation channels shown in the figure). As illustrated in FIG. 1A, the inlet ports 109 and outlet ports 107 may be configured to be loaded through the side of the device, which may facilitate whole-channel or whole-device imaging.

For use in performing a plurality of isoelectric focusing reactions to separate mixtures of proteins, protein samples are pre-mixed with ampholyte pH gradient and pI markers before placing into vials and loading onto an autosampler. The samples are serially loaded into the device by the autosampler via the sample inlet ports 103 onto the microfluidic device, through the separation channels 105, and out of the device to waste through the sample outlet ports 107.

A catholyte fluid (e.g., 1% NH4OH in H₂O) is loaded into cathode wells 106, anolyte (e.g., 10 mM H₃PO₄) is loaded into the anode wells 104, and a mobilizer solution (e.g., 49% MeOH, 49% H₂O, 1% Acetic Acid) is connected to mobilization agent inlet ports 109.

After all reagents are loaded, an electric field of, e.g., +600 V/cm is applied from one or more of the anode wells 104 to the corresponding cathode wells 106 by connecting electrodes to the anode wells 104 and cathode wells 106 to initiate isoelectric focusing. As noted above, the voltages and/or currents applied to each of the separation channels 105 may be controlled independently and may also be recorded as a function of time. In some instances, the electrodes used for anodes and cathodes may be integrated with the devices. For UV absorbance imaging, a collimated beam of light provided by a UV light source is aligned with the separation channels 105, and an image sensor (e.g., a CCD camera or CMOS camera) is placed on the other side of the separation channels 105 to measure the amount of light transmitted through each of the separation channels 105, thereby imaging and detecting the focused proteins (or other separated analytes) by means of their absorbance. In some instances, the focused proteins may be unlabeled and detected through native absorbance at 220 nm, 280 nm, or any other wavelength at which the proteins will absorb light. For fluorescence imaging, i.e., epifluorescence imaging, excitation light of a suitable wavelength is delivered to the separation channels 105 by means of an optical assembly comprising suitable dichroic reflectors and bandpass filters, and emitted fluorescence is collected from the separation channels 105 by the same optical assembly and imaged onto the image sensor. In some instances, focused proteins (or other separated analytes) may be imaged and detected using native fluorescence. In some instances, the focused proteins may be detected using non-covalently bound fluorogenic, chromogenic, fluorescent, or chromophoric labels, such as SYPRO® Ruby, Coomassie Blue, and the like. In some instances, portions of the device may be constructed of an optically opaque material such that light may only be transmitted through the separation channels 105, thereby block any stray light from reaching the image sensor without having passed through the separation channels 105 and increasing the sensitivity of UV absorbance measurements.

Images of the focusing proteins in all or a portion of the separation channels 105 can be captured continuously and/or periodically as the isoelectric focusing reactions are performed in the plurality of separation channels 105. In some instances, detection of the positions of the pI markers in the images of the separation channels 105 may be used to determine the local pH as a function of position along the separation channels and, by extrapolation, make more accurate determinations of pI for the separated proteins (or other analytes). In some instances, when focusing is complete a positive pressure is applied at sample inlet ports 103 and/or anode wells 104 to mobilize the separated protein (or other analyte) mixture towards sample outlets 107. In some instances, when focusing is complete the electrodes connected to cathode wells 106 are disconnected, and electrodes in electrical communication with mobilizer channels 108 are used to apply an electric field of 600V/cm from anode wells 104 to the chemical mobilization agent inlets 109 to electrophoretically introduce the mobilization agent into separation channels 105. In some instances, mild positive pressure applied to mobilization agent inlets 109 may be used instead of, or in addition to, electrophoretic introduction of a chemical mobilization agent.

In the case of electrophoretic introduction of the mobilization agent, the acetic acid in the mobilizer solution is drawn by the electric field into the separation channels 105, where it ionizes the proteins and ampholytes and disrupts the pH gradient used for isoelectric focusing. The ionization of the enriched protein fractions causes them to migrate out of the separation channels 105 toward sample outlets 107. Continuing to image the separation channels 105 during the mobilization process can be used to refine the determination of pI for each separated protein.

### Example 2

### Prophetic Example of the Use of the Disclosed Devices and Systems for Demonstration of Biosimilarity

One non-limiting example of the utility of the disclosed devices and systems is in the field of biologics and the demonstration of biosimilarity. As noted above, the FDA and other regulatory agencies require the use of a stepwise approach to demonstrating biosimilarity, which may include a comparison of the proposed product and a reference product with respect to structure, function, animal toxicity, human pharmacokinetics (PK) and pharmacodynamics (PD), clinical immunogenicity, and clinical safety and effectiveness. Examples of the structural characterization data that may be required for protein products include primary structure (i.e., amino acid sequence), secondary structure (i.e., the degree of folding to form alpha helix or beta sheet structures), tertiary structure (i.e., the three dimensional shape of the protein produced by folding of the polypeptide backbone and secondary structural domains), quaternary structure (e.g., the number of subunits required to form an active protein complex, or the protein's aggregation state)) and post-translational modifications. Accurate determination of protein isoelectric points may provide an important datum for comparison of biologic drug candidates to a reference drug in order to demonstrate biosimilarity. Sample aliquots of a manufactured biosimilar candidate and a reference drug may be loaded into the disclosed devices or systems and characterized under one or more sets of isoelectric focusing reaction conditions (e.g., using different buffers, pH gradients, applied voltages and/or currents, etc.) to determine accurate pI values under the one or more sets of reaction conditions and provide valuable comparison data for the biosimilar drug candidate and reference drug. Furthermore, the monitoring and recording of current traces for each individual separation reaction (and other operating parameters used for performing the isoelectric focusing reactions) facilitates compliance with FDA data submission requirements.

### Example 3

### Tracking Velocity of Analyte Peaks as they Leave the Microfluidic Chip and Enter the Mass Spectrometer

FIG. 1B shows another non-limiting example of a microfluidic device described herein. Microfluidic channel network 110 in the device is fabricated in a 250-μm thick layer of opaque cyclic olefin polymer. Channel 122 is 250 μm deep, so it cuts all the way through the 250-μm layer. All other channels are 50 μm deep. The channel layer is sandwiched between two transparent layers of cyclic olefin polymer to fabricate a planar microfluidic device. Ports 112, 114, 116, 118 and 120 provide access to the channel network for reagent introduction from external reservoirs and electrical contact. Port 112 is connected to a vacuum source, allowing channel 113 to act as a waste channel, enabling the priming of the other reagents through the channel network to “waste.” Acid (e.g., 1% formic acid) is primed through port 118 to channels 119, 122, 124, and 113, and out to port 112. A sample (e.g., a peptide or protein diluted in 4% Pharmalyte 3-10, 12.5 mM pI standard 3.38 (purified peptide, sequence: Trp-Asp-Asp-Asp), 12.5 mM pI standard 10.17 (purified peptide, sequence: Trp-Tyr-Lys-Arg)) is primed through port 116 into channels 117, 122, 124, and 113 and out to port 112. This leaves channel 122 containing the sample analyte. Base (e.g., 1% dimethylamine) is primed through port 114 into channels 115, 124, and 113 and out to port 112. Mobilizer (e.g., 1% formic acid, 49% methanol) is primed through port 120 into channels 121, 124, and 113, and out channel 113 to port 112.

Electrophoresis of the analyte sample in channel 122 is performed by applying 4000V to port 118 and connecting port 120 to ground. The ampholytes in the analyte sample establish a pH gradient spanning channel 122. Absorbance imaging of the separation is performed using a 280 nm light source aligned to channel 122 and measuring the transmission of 280 nm light through the channel 122 with a CCD camera. Software calculates the absorbance by comparing light transmission during separation or mobilization compared to a “blank” reference measurement taken in the absence of focused analyte before the analyte is run, then displays the absorbance per pixel over the length of channel 122. Locations where standards or analyte has focused are displayed as peaks in absorbance traces derived from the image data.

Once the analyte has completed focusing, a final focused absorbance image is captured. Software will identify the spatial position of the pI markers and interpolate in between the markers to calculate the pI of the focused analyte fraction peaks. At this point, the control software will trigger a relay disconnecting the ground at port 120, and connecting port 114 to ground, as well as setting pressure on the mobilizer reservoir connected to port 114 to establish flow of 100 nL/min of mobilizer solution through port 114 into channels 115 and 124, and out of the chip at orifice 126. Orifice 126 is positioned 2 mm away from a mass spectrometer ESI inlet, with an inlet voltage of −3500V to −4500V.

While the pressure driven flow directs mobilizer from port 114 to orifice 126, some of the formic acid in the mobilizer reagent will electrophorese in the form of formate from channel 115, through channel 122 to the anode at port 118. As the formate travels through channel 122, it will disrupt the isoelectric pH gradient, causing the ampholytes, standards and analyte sample to increase charge and migrate electrophoretically out of channel 122 into channel 124, where pressure driven flow from port 120 will carry them into the ESI spray out of orifice 126.

While mobilization occurs, the software continues to capture absorbance images, and identifies peaks, tracking their migration out of the imaging channel 122 into channel 124. By tracking the time each peak exits imaging channel 122, its velocity, and the flow rate in channel 124, the software can calculate the time the peak traverses channel 124 and is introduced to the mass spectrometer via orifice 126, allowing direct correlation between the original focused peak and the resulting mass spectrum.

### Example 4

### Microfluidic Devices Comprising a Gas Channel for Nebulization of Liquid

FIGS. 2A-2B show a top-down schematic of an example microfluidic device described herein comprising a separation channel and two gas channels. Referring to FIG. 2A, the microfluidic device comprises a substrate 200 which is about 1 millimeter (mm) in thickness and comprises fused silica. Channels are chemically etched to 40 micron deep and 86 to 600 micron wide. In some embodiments, the microfluidic device may comprise a tip (e.g., at the distal end), which may allow for fluid to be directed away from the device (e.g., to a waste receptacle or analysis unit, e.g., mass spectrometer).

Access to the fluid channels within the device is provided through a sample inlet port 203, anode port 204, cathode port 206, sample outlet port 207 (also “fluid orifice” herein), and chemical mobilization agent inlet port 209. The anode port 204 and cathode port 206 are in fluid- and electrical communication with a proximal end and distal end of a separation channel 205, respectively. The electrodes can, in some instances, be placed in contact with the anode port 204 and cathode port 206. In other instances, the anode port 204 and the cathode port 206 are in fluidic and/or electrical communication with an electrode reservoir (not shown), which connects to the anode port 204 and cathode port 206 via, for example, a channel. The separation channel 205 extends beyond the cathode port 206 to the sample outlet port 207. Chemical mobilization agent inlet port 209 is connected to the distal end of the separation channel 205 via a chemical mobilization channel 208. The device also comprises two gas channels 211 and 213, which have a gas orifice or outlet adjacent to the sample outlet port 207. The gas inlet ports 215 and 217 allow for entry of gas (e.g., air, nitrogen, etc.) into the gas channels 211 and 213. In some instances, the gas orifices or outlets of gas channels 211 and 213 may be symmetrically positioned from the sample outlet port 207. The inlet ports, including the anode port 204, the cathode port 206, the sample inlet port 203, the chemical mobilization agent inlet port 209, and the gas inlet ports 215 and 217 may be configured to be loaded through the side or edge 220 of the device, which may facilitate various processes such as reagent loading, whole-channel or whole-device imaging, etc.

For use in performing an isoelectric focusing reaction to separate mixtures of proteins, a protein sample is pre-mixed with ampholyte pH gradient and pI markers before placing into vials and loading onto an autosampler. The samples are serially loaded into the device by the autosampler via the sample inlet port 203 onto the microfluidic device, through the separation channel 205, and out of the device to waste through the sample outlet ports 207.

A catholyte fluid (e.g., 1% NH₄OH in H₂O) is loaded into the cathode port 206, anolyte (e.g., 10 mM H₃PO₄) is loaded into the anode port 204, and a mobilizer solution (e.g., 49% MeOH, 49% H₂O, 1% Acetic Acid) is connected to mobilization agent inlet port 209.

After all reagents are loaded, an electric field of, e.g., +600V/cm is applied from the anode port 204 to the corresponding cathode port 206 by connecting electrodes to anodic and cathodic reservoirs (not shown) to initiate isoelectric focusing. In some instances, the electrodes used for anodes and cathodes may be integrated with the devices. For UV absorbance imaging, a collimated beam of light provided by a UV light source is aligned with the separation channel 205, and an image sensor (e.g., a CCD camera or CMOS camera) is placed on the other side of the separation channel 205 to measure the amount of light transmitted through the separation channel 205, thereby imaging and detecting the focused proteins (or other separated analytes) using absorbance. In some instances, the focused protein may be unlabeled and detected through native absorbance at 220 nm, 280 nm, or any other wavelength at which the proteins will absorb light. For fluorescence imaging, i.e., epifluorescence imaging, excitation light of a suitable wavelength is delivered to the separation channel 205 by means of an optical assembly comprising suitable dichroic reflectors and bandpass filters, and emitted fluorescence is collected from the separation channel 205 by the same optical assembly and imaged onto the image sensor. In some instances, focused proteins (or other separated analytes) may be imaged and detected using native fluorescence. In some instances, the focused proteins may be detected using non-covalently bound fluorogenic, chromogenic, fluorescent, or chromophoric labels, such as SYPRO® Ruby, Coomassie Blue, and the like. In some instances, portions of the device may be constructed of an optically opaque material such that light may only be transmitted through the separation channel 205, thereby block any stray light from reaching the image sensor without having passed through the separation channel 205 and increasing the sensitivity of UV absorbance measurements.

Images of the focusing proteins in all or a portion of the separation channel 205 can be captured continuously and/or periodically as the isoelectric focusing reactions are performed in the plurality of separation channel 205. In some instances, detection of the positions of the pI markers in the images of the separation channel 205 may be used to determine the local pH as a function of position along the separation channels and, by extrapolation, make more accurate determinations of pI for the separated proteins (or other analytes). In some instances, when focusing is complete a positive pressure is applied at sample inlet port 203 and/or anode port 204 to mobilize the separated protein (or other analyte) mixture towards sample outlet 207. In some instances, when focusing is complete, the electrodes connected to cathode port 206 are disconnected, and electrodes in electrical communication with mobilizer channels 208 are used to apply an electric field of 600V/cm from anode port 204 to the chemical mobilization agent inlet 209 to electrophoretically introduce the mobilization agent into the separation channel 205. In some instances, mild positive pressure applied to mobilization agent inlet 209 may be used instead of, or in addition to, electrophoretic introduction of a chemical mobilization agent.

In the case of electrophoretic introduction of the mobilization agent, the acetic acid in the mobilizer solution is drawn by the electric field into the separation channel 205, where it ionizes the proteins and ampholytes and disrupts the pH gradient used for isoelectric focusing. The ionization of the enriched protein fractions causes them to migrate out of the separation channel 205 toward sample outlet 207. Continuing to image the separation channels 205 during the mobilization process can be used to refine the determination of pI for each separated protein.

FIG. 2B shows an enlarged schematic of the outlet portion of the microfluidic device illustrated in FIG. 2A. The gas channels 211 and 213 each have a gas orifice 219 and 221, respectively, from which gas is expelled. The gas orifices 219 and 221 are positioned adjacent to the sample outlet port 207 and are used to nebulize the sample near the sample outlet port 207. In some instances, the gas channels 211 and 213, or a portion thereof, are positioned symmetrically from the sample outlet 207. In some instances, the gas channel orifices 219 and 221 are positioned symmetrically from the sample outlet 207. In some instances, the gas channels 211 and 213 each comprise a region that is parallel to a portion of the separation channel 205. As shown in FIG. 2A, the gas channels 211 and 213 have different lengths; however, the gas channels 211 and 213 can be configured to provide substantially similar hydrodynamic flow resistance at each of the gas outlet orifices 219 and 221. For instance, the gas channels 211 and 213 may have different cross-sectional areas along a portion of the channel but approximately the same cross-sectional area near the gas outlet orifices 219 and 221. In some cases, the gas channel may narrow at the distal end to increase the flow rate or flow velocity at the gas outlet orifice. For devices where the gas outlet orifices 219 and 221 are positioned symmetrically from the sample outlet, 207, the similar hydrodynamic flow resistance at each of the gas outlet orifices 219 and 221 may be beneficial in achieving steady air flow for nebulization of the sample near the sample outlet 207. In other instances, the gas outlet orifices 219 and 221 may not be symmetrically positioned from the sample outlet 207; in such cases, the hydrodynamic flow resistance at each of the gas outlet orifices 219 and 221 may differ, such that the volume, quantity, or flow rate of air that reaches the sample outlet 207 is approximately the same.

During nebulization, which may be performed concurrently with ESI, the sample is dispersed or broken into smaller droplets. In some instances, the nebulized droplets are then subjected to a supplementary drying gas, resulting in evaporation of liquid and production of gas phase ions that are introduced into the mass spectrometer (not shown). Continuous imaging of the sample outlet 207 or the area surrounding the sample outlet 207 during the electrospray process can be used to determine a characteristic of the ESI or the Taylor cone, e.g., droplet size, Taylor cone shape, etc.

### Example 5

### Design Parameters for Optimizing Nebulization of the Sample during ESI

Nebulization of the sample, as disclosed herein, is achieved by the shear and inertial forces created by a gas jet to break a continuous liquid stream into small droplets. Nebulization of the sample (or separated sample) may be used to improve quantitative measurement of the sample (or separated sample) under microflow, where the sample (or separated sample) is flowed through the ESI tip at approximately microliter-scale flow rates (e.g., microliter(s)/min). The nebulization is particularly use for higher flow rates in the microliter/minute flow ranges (1's-, 10'a-, 100's-ul/min where additional solvent needs to be removed from the sample to get to single ions that are collected into the mass spectrometer for analysis). Various parameters of the gas channels disclosed herein are alterable and may be configured to optimize nebulization. FIGS. 3A-3D schematically show non-limiting examples of alterable parameters of a microfluidic device comprising a fluid discharge channel and two gas channels that can be used to nebulize the sample in the fluid discharge channel. In some instances, the fluid discharge channel is fluidically coupled (e.g., at a proximal end) to a separation channel (e.g., at a distal end) for use in a separation reaction such as isoelectric focusing.

FIG. 3A shows a schematic of an alterable convergence angle between a distal end of a gas channel and a distal end of a fluid discharge channel comprising an orifice (also herein “sample outlet”, “fluid orifice”, or “fluid outlet orifice”). In such a configuration, the gas channels 311 and 313 are positioned symmetrically from the outlet of the fluid discharge channel 307. The convergence angle between a distal section of the gas channel 313 and a distal section of the fluid discharge channel can range, e.g., from about 0 degrees to about 45 degrees. The convergence angle may be altered to achieve useful nebulization properties; for instance, a 15 degree convergence angle can be used to substantially reproduce coaxial flow, such as those used in capillary-based sheath flow systems. Moreover, the convergence of two gas jets create more inertial and shear forces that promote the breakup of liquid samples into smaller droplets. In some instances, lower angles of convergence may be useful, for example, in decreasing the back pressure or flow of the sample at or near the sample outlet 307. A decreased back pressure or flow of the sample at or near the sample outlet 307 may aid in reducing the amount of sample that is re-introduced into the fluid discharge channel. Optimal nebulization may occur when gas-flow induced back pressure just in front the sample outlet is minimized while maintaining high shear forces and flow velocities at or near the fluid (liquid) discharge channel orifice to provide a steady gas stream for efficiently nebulizing the sample.

FIG. 3B shows a schematic of the diameter of the gas channel or gas outlet orifice, which is alterable. In addition to the geometry and convergence angle of the gas channel and the fluid discharge channel, the diameter of one or both gas channels 311 and 313 or the gas outlet orifice is alterable. For example, the diameter of the gas outlet orifice 311 may be between 40 and 400 microns In some instances, it is preferable to have a narrower gas outlet orifice to maximize the local velocity of the gas toward or near the outlet of the fluid discharge channel. FIG. 3C shows a schematic of an alterable positioning of the gas channel or gas channels relative to the fluid discharge channel. An additional alterable aspect may be the positioning of the gas outlet orifice(s) relative to the outlet or orifice of the fluid discharge channel. FIG. 3D shows a schematic of an alterable angle of exit of the gas outlet orifice. Referring to FIGS. 3A-3D, optimal nebulization may occur when steady nanoflow or microflow is achieved without substantial back pressure at the outlet of the fluid channel.

FIGS. 4A-4B show non-limiting examples of micrographs of microfluidic devices described herein. FIG. 4A shows a microfluidic device comprising two gas channels 411a and 413a, with outlet orifices that are symmetrically positioned from the orifice 407a of the fluid outlet channel. The gas outlet orifices converge with the fluid outlet channel orifice. The diameter of each of the gas outlet orifices are approximately 114 micrometers (μm), and the diameter of the fluid outlet channel is approximately 98 μm. The angle of convergence of the gas channel 413a and the fluid outlet channel is approximately 15 degrees. FIG. 4B shows a microfluidic device comprising two gas channels 411b and 413b , with outlet orifices that are symmetrically positioned from the orifice 407b of the fluid outlet channel. The gas outlet orifices converge slightly outside the fluid outlet channel orifice and are positioned adjacent to fluid outlet channel orifice with a gap of 0 to 200 micron between them. The diameter of each of the gas outlet orifices are approximately 119 μm, and the diameter of the fluid outlet channel is approximately 94 μm. The angle of convergence of the gas channel 413 and the fluid outlet channel is approximately 15 degrees.

### Example 6

### Microfluidic Devices with Nebulizing Gas Channels

As described in Example 5, various parameters of the gas channel and fluid outlet channel are variable. FIGS. 5A-9B schematically illustrate non-limiting examples of microfluidic devices comprising a gas channel and a separation channel. Referring to FIG. 5A, access to the fluid channels within the device 500 is provided through a sample inlet port 503, anode port 504, cathode port 506, sample outlet port 507 (also “fluid orifice” herein), and chemical mobilization agent inlet port 509. The anode port 504 and cathode port 506 are in fluid- and electrical communication with a proximal end and a distal end of a separation channel 505, respectively. The electrodes can, in some instances, be placed in contact with the anode port 504 and cathode port 506. In other instances, the anode port 504 and the cathode port 506 are in fluidic and/or electrical communication with an electrode reservoir (not shown), which connects to the anode port 504 and cathode port 506 via, for example, a channel. The separation channel 505 extends beyond the cathode port 506 to the sample outlet port 507. Chemical mobilization agent inlet port 509 is connected to the distal end of the separation channel 505 via a chemical mobilization channel 508. The device also comprises two gas channels 511 and 513, which have a gas orifice or outlet adjacent that converges with the sample outlet port 507. The angle of convergence of the gas channel 513 and the fluid outlet channel is approximately 30 degrees. The gas inlet ports 515 and 517 allow for entry of gas (e.g., air, nitrogen, etc.) into the gas channels 511 and 513. In some instances, the gas orifices or outlets of gas channels 511 and 513 may be symmetrically positioned from the sample outlet port 507. The inlet ports, including the anode port 504, the cathode port 506, the sample inlet port 503, the chemical mobilization agent inlet port 509, and the gas inlet ports 515 and 517 may be configured to be loaded through the side or edge of the device, which may facilitate various processes such as reagent loading, whole-channel or whole-device imaging, etc.

FIG. 5B shows an enlarged schematic of the outlet portion of the microfluidic device illustrated in FIG. 5A. The gas channels 511 and 513 each have a gas orifice 519 and 521, respectively, from which gas is expelled. The gas channels 511 and 513 converge with the sample outlet port 507 and are used to nebulize the sample near the sample outlet port 507. Similar to the example shown in FIGS. 2A-2B, the gas channels 511 and 513, or a portion thereof, are positioned symmetrically from the sample outlet 507. In some instances, the gas channel orifices 519 and 521 are positioned symmetrically from the sample outlet 507. In some instances, the gas channels 511 and 513 each comprise a region that is parallel to a portion of the separation channel 505. The gas channels 511 and 513 have different lengths; however, the gas channels 511 and 513 can be configured to provide substantially similar hydrodynamic flow resistance at each of the gas outlet orifices 519 and 521. For instance, the gas channels 511 and 513 may have different cross-sectional areas along a portion of the channel but approximately the same cross-sectional area near the gas outlet orifices 519 and 521. For devices where the gas outlet orifices 519 and 521 are positioned symmetrically from the sample outlet, 507, the similar hydrodynamic flow resistance at each of the gas outlet orifices 519 and 521 may be beneficial in achieving steady air flow for nebulization of the sample near the sample outlet 507. In other instances, the gas outlet orifices 519 and 521 may not be symmetrically positioned from the sample outlet 507; in such cases, the hydrodynamic flow resistance at each of the gas outlet orifices 519 and 521 may differ, such that the volume, quantity, or flow rate of air that reaches the sample outlet 507 is approximately the same.

FIG. 5C shows an isometric view of the device depicted in FIGS. 5A-5B.

FIGS. 6A-6C schematically show another example of a microfluidic device comprising a gas channel and a separation channel. FIG. 6A shows the layout of the device. FIGS. 6A-6B show enlarged and isometric views, respectively, of the outlet portion of the device illustrated in FIG. 6A. The device may be similar to that shown in FIGS. 5A-5C, with gas channels 611 and 613 that converge with the sample outlet port 607 and are used to nebulize the sample near the sample outlet port 607. The gas channels 611 and 613 converge with the fluid outlet channel at an angle of approximately 15 degrees. The gas channels 611 and 613 are asymmetrically positioned relative to the fluid channel outlet orifice 607. Although the gas channels 611 and 613 are asymmetrically positioned relative to the fluid outlet channel orifice 607, the exit flow path of the gas in each of the channels is symmetric relative to the axis of the fluid flow path of the fluid from the fluid outlet orifice 607.

FIGS. 7A-7C schematically show another example of a microfluidic device comprising a gas channel and a separation channel. FIG. 7A shows the layout of the device. FIGS. 7A-7B show enlarged and isometric views, respectively, of the outlet portion of the device illustrated in FIG. 7A. The distal ends of gas channels 711 and 713 are parallel to the fluid outlet channel. The gas channels 711 and 713 are positioned such that the orifices 719 and 721 are each spaced approximately 30 μm from the fluid channel outlet orifice 707. The gas channels 711 and 713 are used to nebulize the sample near the sample outlet port 707. The gas channels 711 and 713 are symmetrically positioned relative to the fluid channel outlet orifice 707, and the exit flow path of the gas in each of the channels is symmetric relative to the axis of the fluid flow path of the fluid from the fluid outlet orifice 707.

FIGS. 8A-8C schematically show another example of a microfluidic device comprising a gas channel and a separation channel. FIG. 8A shows the layout of the device. FIGS. 8A-8B show enlarged and isometric views, respectively, of the outlet portion of the device illustrated in FIG. 8A. The gas channels 811 and 813 are positioned such that the orifices 819 and 821 are each spaced approximately 40 μm from the fluid channel outlet orifice 807. The gas channels 811 and 813 are used to nebulize the sample near the sample outlet port 807. The gas channels 811 and 813 are symmetrically positioned relative to the fluid channel outlet orifice 807, and the exit flow path of the gas in each of the channels is symmetric relative to the axis of the fluid flow path of the fluid from the fluid outlet orifice 807. The distal ends of the gas channels 811 and 813 converge with the fluid outlet channel at an angle of approximately 15 degrees.

FIGS. 9A-9B schematically show another example of a microfluidic device comprising a gas channel and a separation channel. FIG. 9A shows the layout of the device 900. Referring to FIG. 9A, access to the fluid channels within the device is provided through a sample inlet port 903, anode port 904, cathode port 906, sample outlet port 907 (also “fluid orifice” herein), and chemical mobilization agent inlet port 909. The anode port 904 and cathode port 906 are in fluid- and electrical communication with a proximal end and distal end of a separation channel 905, respectively. The electrodes can, in some instances, be placed in contact with the anode port 904 and cathode port 906. In other instances, the anode port 904 and the cathode port 906 are in fluidic and/or electrical communication with an electrode reservoir (not shown), which connects to the anode port 904 and cathode port 906 via, for example, channels. The separation channel 905 extends beyond the cathode port 906 to the sample outlet port 907. Chemical mobilization agent inlet port 909 is connected to the distal end of the separation channel 905 via a chemical mobilization channel 908. The device also comprises two gas channels 911 and 913, which have a gas orifice or outlet adjacent that converges with the sample outlet port 907. The gas inlet ports 915 and 917 allow for entry of gas (e.g., air, nitrogen, etc.) into the gas channels 911 and 913. The gas orifices or outlets of gas channels 911 and 913 are symmetrically positioned from the sample outlet port 907. The inlet ports, including the anode port 904, and one of the gas inlet ports 917 are positioned along one side or edge of the device, while the cathode port 906, the sample inlet port 503, the chemical mobilization agent inlet port 509, and the gas inlet port 915 are configured to be loaded through the opposite side or edge of the device.

FIG. 9B shows an enlarged view of the outlet portion of the device illustrated in FIG. 9A. The distal ends of gas channels 911 and 913 are parallel to the fluid outlet channel. The gas channels 911 and 913 are positioned such that the orifices 919 and 921 are each spaced approximately 30 μm from the fluid channel outlet orifice 907. The gas channels 911 and 913 are used to nebulize the sample near the sample outlet port 907. The gas channels 911 and 913 are symmetrically positioned relative to the fluid channel outlet orifice 907, and the exit flow path of the gas in each of the channels is symmetric relative to the axis of the fluid flow path of the fluid from the fluid outlet orifice 907. The distal ends of the gas channels 911 and 913 converge with the fluid outlet channel at an angle of approximately 15 degrees.

FIGS. 10A-10C schematically show another example of a microfluidic device comprising a gas channel and a separation channel. FIG. 10A shows the layout of the device. FIGS. 10B and 10C show enlarged views of the outlet portion of the device illustrated in FIG. 10A. The distal ends of gas channels 1111 and 1113 are parallel to the fluid outlet channel. The gas channels 1111 and 1113 are positioned such that the orifices 1119 and 1121 are each spaced approximately 15 μm from the fluid channel outlet orifice 1107. The gas channels 1111 and 1113 are used to nebulize the sample near the sample outlet port 1107. The gas channels 1111 and 1113 are symmetrically positioned relative to the fluid channel outlet orifice 1107, and the exit flow path of the gas in each of the channels is symmetric relative to the axis of the fluid flow path of the fluid from the fluid outlet orifice 1107.

FIGS. 11A-11C schematically show another example of a microfluidic device comprising a gas channel and a separation channel. The device may be similar to that shown in FIGS. 10A-10C. FIG. 11A shows the layout of the device. FIGS. 11B-11C show isometric enlarged views of a gas inlet and distal outlet portions, respectively, of the device illustrated in FIG. 11A. The gas inlet port 1215 features a substantially ellipsoidal cross-section. The distal ends of gas channels are parallel to the fluid outlet channel. The gas channels are positioned such that the orifices 1219 and 1221 are each spaced approximately 15 μm from the fluid channel outlet orifice 1207. The gas channels are used to nebulize the sample near the sample outlet port 1207. The gas channels are symmetrically positioned relative to the fluid channel outlet orifice 1207, and the exit flow path of the gas in each of the channels is symmetric relative to the axis of the fluid flow path of the fluid from the fluid outlet orifice 1207.

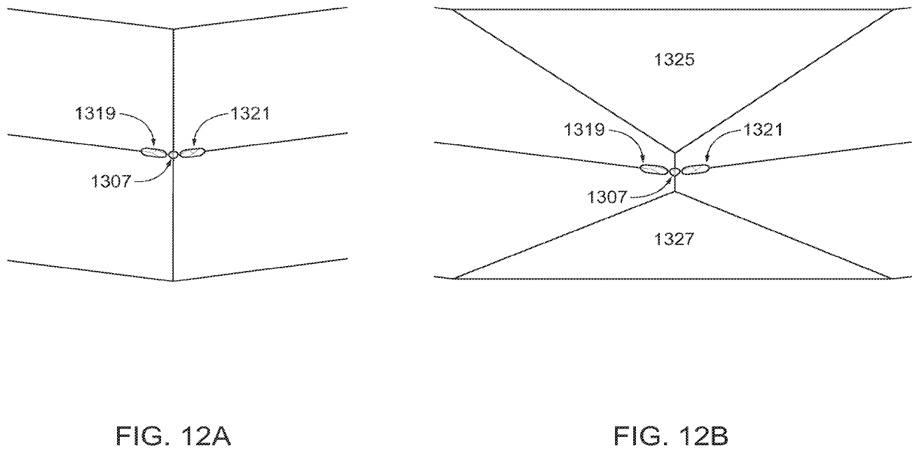

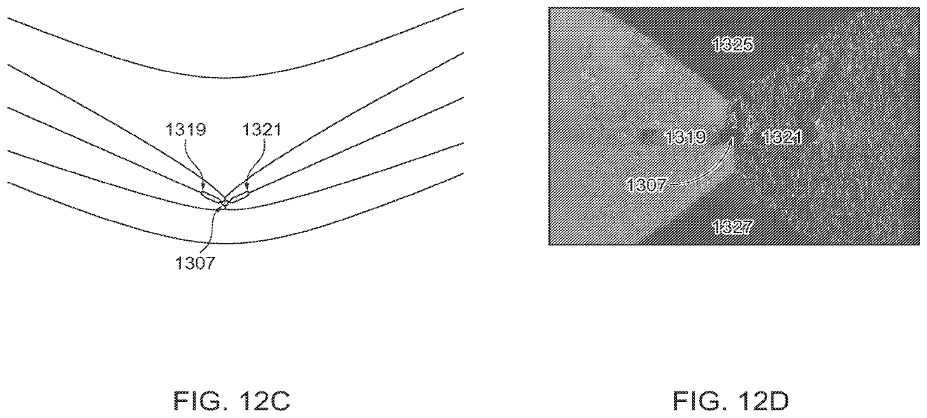

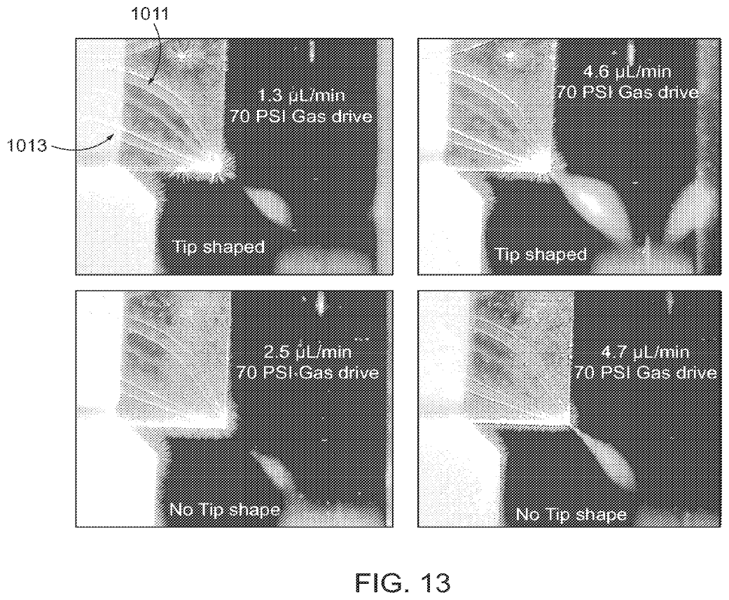

FIGS. 12A-12D provide example schematics (FIGS. 12A-12C) and an image (FIG. 12D) of various distal ends (tips) of microfluidic chips. The distal ends of gas channels are parallel to the fluid outlet channel. The distal ends of gas channels are parallel to the fluid outlet channel. The gas channels are positioned such that the orifices 1319 and 1321 are each spaced approximately 15 μm from the fluid channel outlet orifice 1307. The gas channels are used to nebulize the sample near the sample outlet port 1307. The gas channels are symmetrically positioned relative to the fluid channel outlet orifice 1307, and the exit flow path of the gas in each of the channels is symmetric relative to the axis of the fluid flow path of the fluid from the fluid outlet orifice 1307.

FIG. 12A shows schematic of an unshaped tip with gas orifices, 1319 and 1321, and fluid orifice 1307. FIG. 12B shows a schematic of a faceted shaped tip with gas orifices, 1319 and 1321, and fluid orifice 1307. The faceted shaped tip comprises beveled faces on the top face 1325 and bottom face 1327 which are absent on an unshaped tip such as shown in FIG. 12A. FIG. 12C shows a schematic of a rounded shaped tip with gas orifices, 1319 and 1321, and fluid orifice 1307. The rounded shaped tip is uniformly beveled, forming a rounded tip without sharp angles as shown on FIGS. 12A-12B. FIG. 12D shows an image similar to the schematic shown in FIG. 12B of a faceted shaped tip with gas orifices, 1319 and 1321, and fluid orifice 1307. The faceted shaped tip comprises beveled faces on the top face 1325 and bottom face 1327, which are absent on an unshaped tip such as shown in FIG. 12A.

### Example 7

### Imaging of Taylor Cone during Nebulization and ESI

The performance of ESI as a function of nebulization can be monitored using imaging. FIG. 13 shows non-limiting examples of fluorescence images of the orifice of the fluid outlet channel of a microfluidic device during ESI. The fluid outlet channel is filled with a fluorescent dye. Each panel of FIG. 13 illustrate a flow rate of the sample out of the fluid outlet channel (1.3 μL/min, 4.6 μL/min, 2.5 μL/min, and 4.7 μL/min) and an applied gas pressure of 70 PSI in each of the gas channels 1011 and 1013. The top panels demonstrate devices where the tip is shaped, and the bottom panels demonstrate devices where no tip shape is defined. Tip shaping creates a pyramidal shape around the exit orifices. It generally requires beveling the top and bottom corners of the chip near the orifices by means of mechanical grinding and/or polishing at well-controlled angles (preferably 30 degrees) using any of a number of means known in the art.

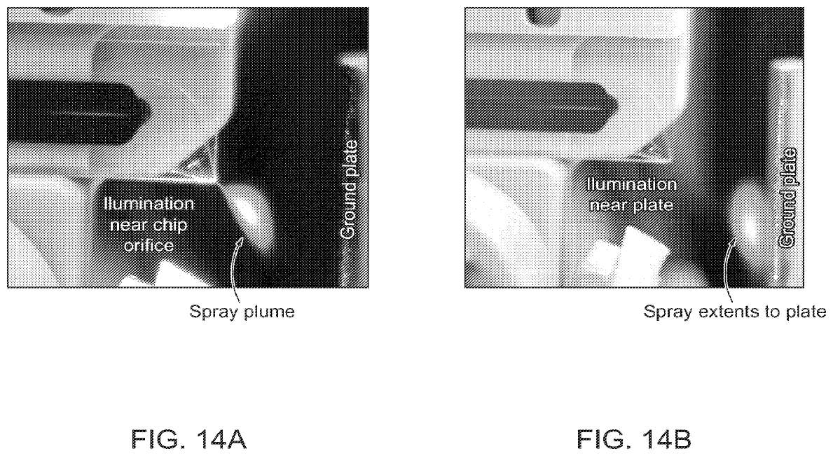

FIGS. 14A-14B show non-limiting examples of fluorescence images of the orifice of the outlet (orifice) portion of a microfluidic device during ESI combined with nebulization. The fluid outlet channel is filled with a fluorescent dye, and the tip of the device is positioned approximately 8 millimeters (mm) from a grounded plate (counter-electrode). A voltage potential of 4000 V is applied between the tip and the grounded plate. The sample comprising the fluorescent dye is expelled from the fluid outlet channel at a rate of approximately 2 to 3 μL/min. A gas pressure of approximately 100 PSI is applied through each of the gas channels for nebulization of the sample. FIG. 14A shows an image of a device when a UV light source is placed near the device orifice, demonstrating a spray plume surrounding the orifice, generated from the nebulization and voltage drop. FIG. 14B shows an image of the device when the UV light source is placed near the grounded plate, demonstrating that the spray plume effectively reaches the grounded plate under the given ESI and nebulization conditions.

### Example 8

### Numerical Simulation of Flow Profiles in Varying Chip Designs

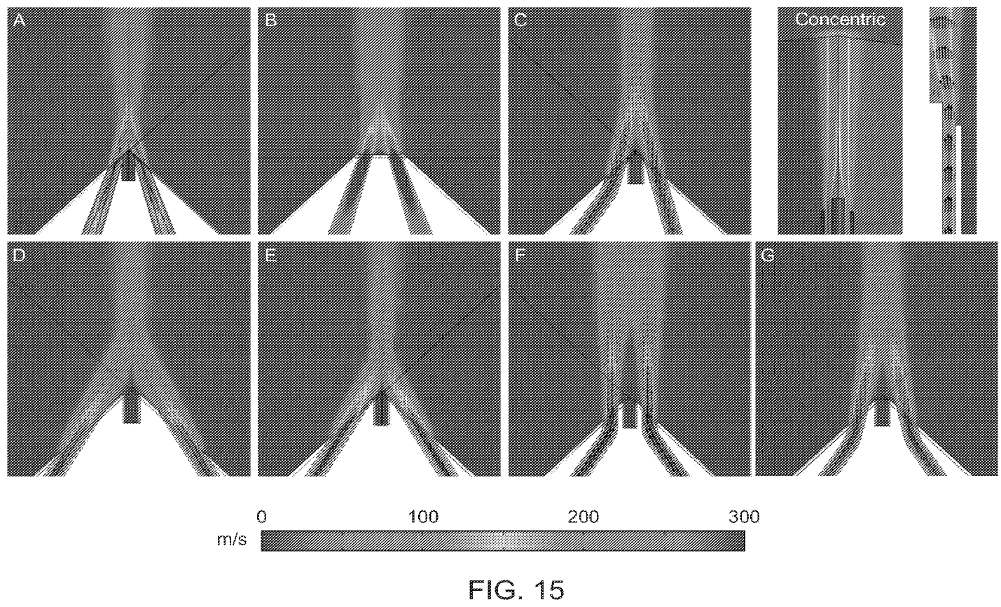

The gas shear rates at and surrounding the orifice of the fluid outlet channel of a microfluidic device can be characterized using numerical simulation (e.g., 3D simulation for all microfluidic chips; 2D axisymmetric model of the concentric cylindrical example in COMSOL). FIG. 15 shows an example of results from a finite element analysis of gas flow velocities on and surrounding the fluid outlet channel orifice as a function of varying parameters (e.g., convergence angle, gas outlet orifice diameter, proximity of the gas outlet orifice to the fluid outlet channel orifice, etc.) of a microfluidic device comprising a fluid discharge channel and two gas channels. All simulations except for the “concentric” panel use a gas flow rate of 11 standard cubic centimeters per minute (sccm) per channel, whereas the “concentric” model uses a gas flow rate of 370 sccm.

Panel A of FIG. 15 shows the gas flow velocities for a device with outlet orifices that are symmetrically positioned from the orifice of the fluid outlet channel. The gas outlet orifices converge with the fluid outlet channel orifice. The diameter of each of the gas outlet orifices are approximately 114 micrometers (pm), and the diameter of the fluid outlet channel is approximately 98 μm. The angle of convergence of the gas channel and the fluid outlet channel is approximately 15 degrees. Panel B of FIG. 15 shows gas flow velocities for the same device as that in Panel A of FIG. 15 with a portion of the tip truncated. Panel C of FIG. 15 shows the gas flow velocities for the device shown in FIGS. 6A-6C, in which the gas outlet orifices converge with the fluid outlet channel orifice at an angle of 15 degrees. The exit angles are symmetric, and the lower channel comprises a bend near the orifice. Panel D of FIG. 15 shows the gas flow velocities for the device shown in FIGS. 2A-2B, in which the gas channels are spaced approximately 115 μm from the fluid outlet channel. Panel E of FIG. 15 shows the gas flow velocities for the device shown in FIGS. 5A-5C, in which the gas outlet orifices converge with the fluid channel outlet orifice and the gas channels are positioned adjacent to the fluid channel outlet. Panel F of FIG. 15 shows the gas flow velocities for the device shown in FIGS. 7A-7C, in which the gas channel bends outward near the gas outlet orifice such that the gas exits parallel to the fluid flow path out the fluid outlet channel. The orifices of the gas channels are each positioned approximately 30 μm from the orifice of the fluid outlet channel. Panel G of FIG. 15 shows the gas flow velocities for the device shown in FIGS. 8A-8C, in which the gas channels bend near the orifice so that the gas channel and the fluid outlet channel converges at an angle of approximately 15 degrees. The orifices of the gas channels are each positioned approximately 40 μm from the orifice of the fluid outlet channel. The Panel “Concentric” of FIG. 15 shows the results of the simulation of a fluid outlet channel that is radially surrounded by an annular, concentric gas channel.

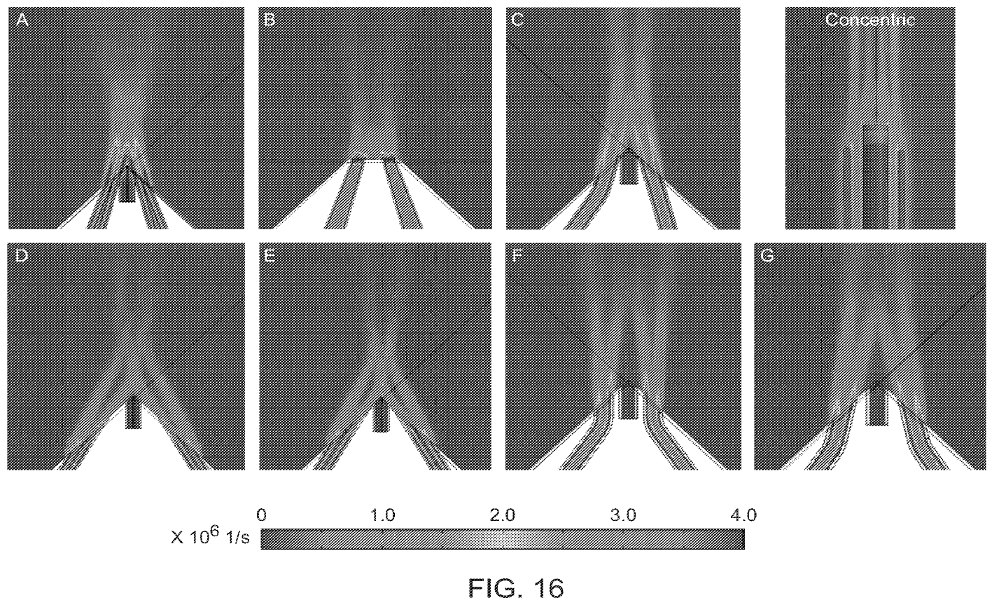

The numerical simulation may also be used to determine or model gas shear rates from the gas channels. FIG. 16 shows an example of results from the finite element analysis of gas shear rates on and surrounding the fluid outlet channel orifice as a function of varying parameters (e.g., convergence angle, gas outlet orifice diameter, proximity of the gas outlet orifice to the fluid outlet channel orifice, etc.) of a microfluidic device comprising a fluid discharge channel and two gas channels. All simulations except for the “concentric” panel use a gas flow rate of 11 standard cubic centimeters per minute (sccm) per channel, whereas the “concentric” model uses a gas flow rate of 370 sccm.

Panel A of FIG. 16 shows the gas shear rates for a device with outlet orifices that are symmetrically positioned from the orifice of the fluid outlet channel. The gas outlet orifices converge with the fluid outlet channel orifice. The diameter of each of the gas outlet orifices are approximately 114 micrometers (μm), and the diameter of the fluid outlet channel is approximately 98 μm. The angle of convergence of the gas channel and the fluid outlet channel is approximately 15 degrees. Panel B of FIG. 16 shows gas shear rates for the same device as that in Panel A of FIG. 16 with a portion of the tip truncated. Panel C of FIG. 16 shows the gas shear rates for the device shown in FIGS. 6A-6C, in which the gas outlet orifices converge with the fluid outlet channel orifice at an angle of 15 degrees. The exit angles are symmetric, and the lower channel comprises a bend near the orifice. Panel D of FIG. 16 shows the gas shear rates for the device shown in FIGS. 2A-2B, in which the gas channels are spaced approximately 115 μm from the fluid outlet channel. Panel E of FIG. 16 shows the gas shear rates for the device shown in FIGS. 5A-5C, in which the gas outlet orifices converge with the fluid channel outlet orifice and the gas channels are positioned adjacent to the fluid channel outlet. Panel F of FIG. 16 shows the gas shear rates for the device shown in FIGS. 7A-7C, in which the gas channel bends outward near the gas outlet orifice such that the gas exits parallel to the fluid flow path out the fluid outlet channel. The orifices of the gas channels are each positioned approximately 30 μm from the orifice of the fluid outlet channel. Panel G of FIG. 16 shows the gas shear rates for the device shown in FIGS. 8A-8C, in which the gas channels bend near the orifice so that the gas channel and the fluid outlet channel converges at an angle of approximately 15 degrees. The orifices of the gas channels are each positioned approximately 40 μm from the orifice of the fluid outlet channel. The Panel “Concentric” of FIG. 16 models a fluid outlet channel that is radially surrounded by an annular, concentric gas channel.

FIG. 17 shows an example of results from the finite element analysis illustrating velocity fields on and surrounding the fluid outlet channel orifice as a function of varying parameters (e.g., convergence angle, gas outlet orifice diameter, proximity of the gas outlet orifice to the fluid outlet channel orifice, etc.) of a microfluidic device comprising a fluid discharge channel and two gas channels. FIG. 17 shows perspective views of the device. All simulations except for the “concentric” panel use a gas flow rate of 11 standard cubic centimeters per minute (sccm) per channel, whereas the “concentric” model uses a gas flow rate of 370 sccm.

Panel A of FIG. 17 shows the gas flow velocities for the device shown in FIGS. 2A-2B, in which the gas channels are spaced approximately 115 μm from the fluid outlet channel. Panel B of FIG. 17 shows the gas flow velocities for the device shown in FIGS. 5A-5C, in which the gas outlet orifices converge with the fluid channel outlet orifice and the gas channels are positioned adjacent to the fluid channel outlet. Panel C of FIG. 17 shows the gas flow velocities for the device shown in FIGS. 6A-6C, in which the gas outlet orifices converge with the fluid outlet channel orifice at an angle of 15 degrees. The exit angles are symmetric, and the lower channel comprises a bend near the orifice. Panel D of FIG. 17 shows the gas flow velocities for the device shown in FIGS. 7A-7C, in which the gas channel bends outward near the gas outlet orifice such that the gas exits parallel to the fluid flow path out the fluid outlet channel. The orifices of the gas channels are each positioned approximately 30 μm from the orifice of the fluid outlet channel. Panel E of FIG. 17 shows the gas flow velocities for the device shown in FIGS. 8A-8C, in which the gas channels bend near the orifice so that the gas channel and the fluid outlet channel converges at an angle of approximately 15 degrees. The orifices of the gas channels are each positioned approximately 40 μm from the orifice of the fluid outlet channel.

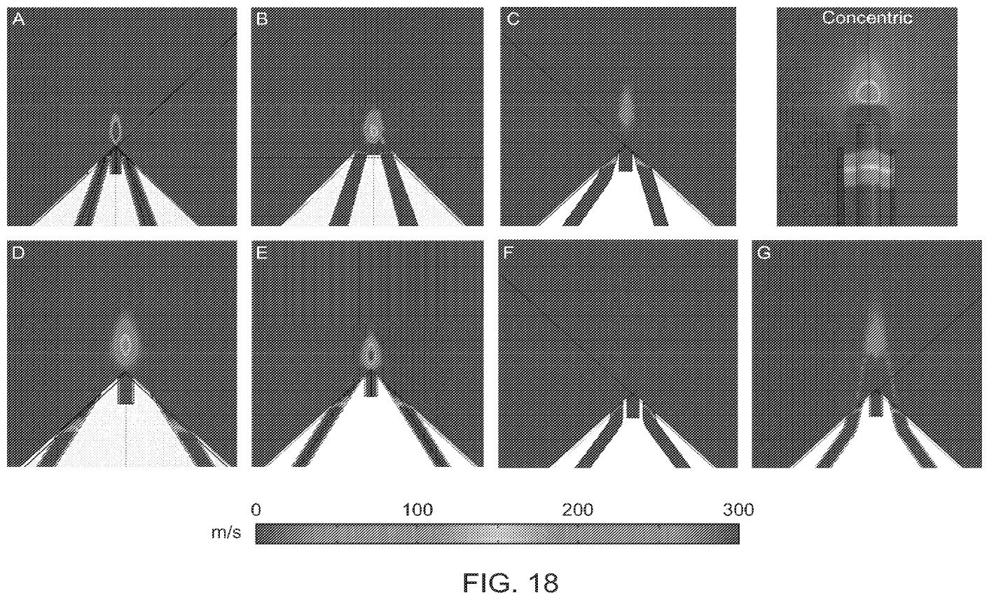

FIG. 18 shows an example of results from the finite element analysis, illustrating gas pressure fields from nebulization on and surrounding the fluid outlet channel orifice as a function of varying parameters (e.g., convergence angle, gas outlet orifice diameter, proximity of the gas outlet orifice to the fluid outlet channel orifice, etc.) of a microfluidic device comprising a fluid discharge channel and two gas channels. All simulations except for the “concentric” panel use a gas flow rate of 11 standard cubic centimeters per minute (sccm) per channel, whereas the “concentric” model uses a gas flow rate of 370 sccm.

Panel A of FIG. 18 shows the gas pressure fields for a device with outlet orifices that are symmetrically positioned from the orifice of the fluid outlet channel. The gas outlet orifices converge with the fluid outlet channel orifice. The diameter of each of the gas outlet orifices are approximately 114 micrometers (μm), and the diameter of the fluid outlet channel is approximately 98 μm. The angle of convergence of the gas channel and the fluid outlet channel is approximately 15 degrees. Panel B of FIG. 18 shows gas pressure fields for the same device as that in Panel A of FIG. 18 with a portion of the tip truncated. Panel C of FIG. 18 shows the gas pressure fields for the device shown in FIGS. 6A-6C, in which the gas outlet orifices converge with the fluid outlet channel orifice at an angle of 15 degrees. The exit angles are symmetric, and the lower channel comprises a bend near the orifice. Panel D of FIG. 18 shows the gas pressure fields for the device shown in FIGS. 2A-2B, in which the gas channels are spaced approximately 115 μm from the fluid outlet channel. Panel E of FIG. 18 shows the gas pressure fields for the device shown in FIGS. 5A-5C, in which the gas outlet orifices converge with the fluid channel outlet orifice and the gas channels are positioned adjacent to the fluid channel outlet. Panel F of FIG. 18 shows the gas pressure fields for the device shown in FIGS. 7A-7C, in which the gas channel bends outward near the gas outlet orifice such that the gas exits parallel to the fluid flow path out the fluid outlet channel. The orifices of the gas channels are each positioned approximately 30 μm from the orifice of the fluid outlet channel. Panel G of FIG. 18 shows the gas pressure fields for the device shown in FIGS. 8A-8C, in which the gas channels bend near the orifice so that the gas channel and the fluid outlet channel converges at an angle of approximately 15 degrees. The orifices of the gas channels are each positioned approximately 40 μm from the orifice of the fluid outlet channel. The Panel “Concentric” of FIG. 18 models a fluid outlet channel that is radially surrounded by an annular, concentric gas channel.

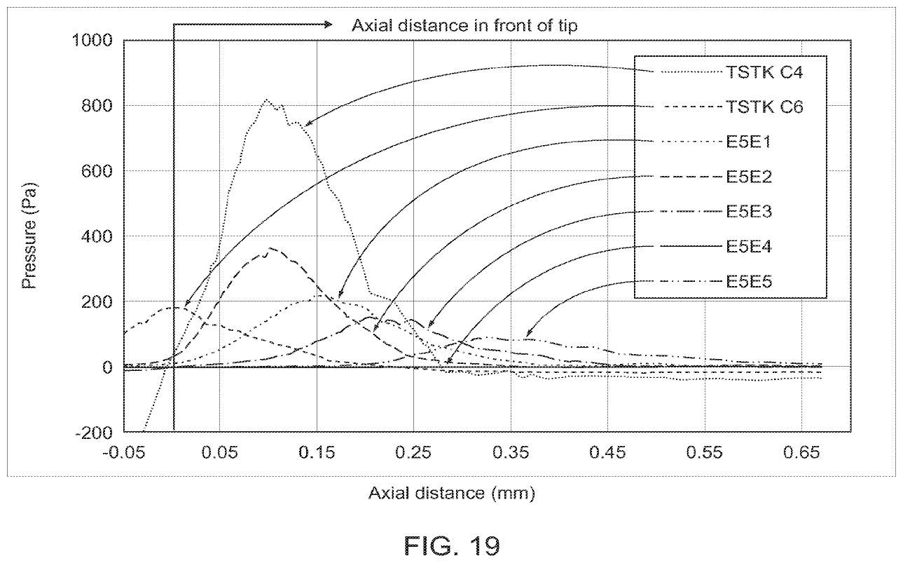

FIG. 19 shows a plot comparing the gas pressure for the multiple device designs as a function of distance (mm) from the tip (fluid channel outlet orifice). “TSTK C4” represents the device shown in FIG. 4A; “TSTK C6” represents the device shown in FIG. 4A with the tip truncated; “E5E1” represents the device shown in FIG. 2A; “E5E2” represents the device shown in FIG. 5A; “E5E3” represents the device shown in FIG. 6, “E5E4” represents the device shown in FIG. 7A; “E5E5” represents the device shown in FIG. 8A.

### Example 9

### Microfluidic Chip-Cartridge Interface and Cartridge-Instrument Interface

As described herein, the systems may comprise a cartridge configured to interface with a microfluidic chip, and in some instances, the cartridge (interface with the microfluidic chip) is configured to interface with an instrument.

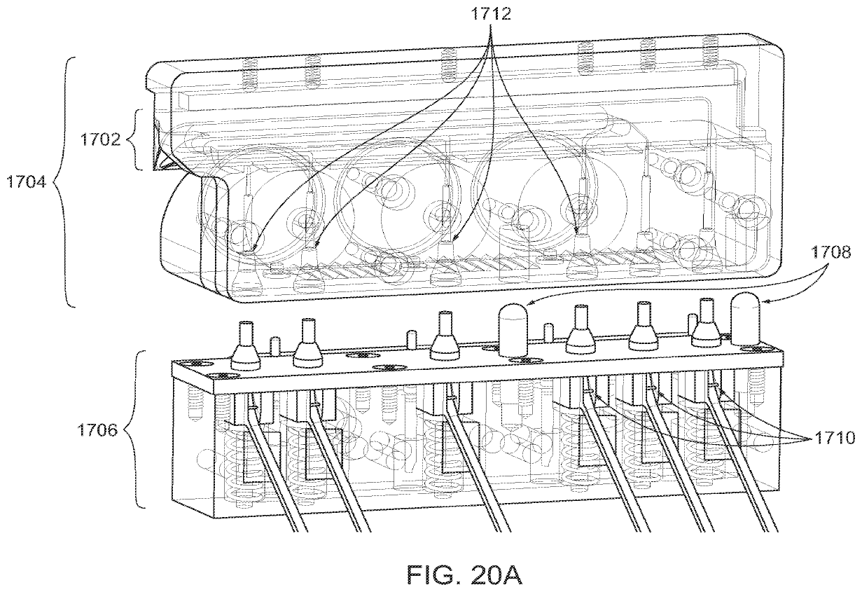

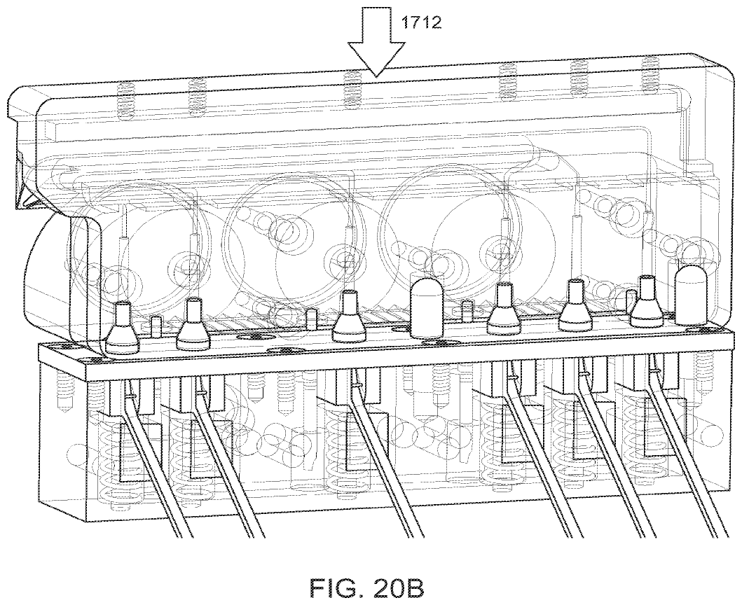

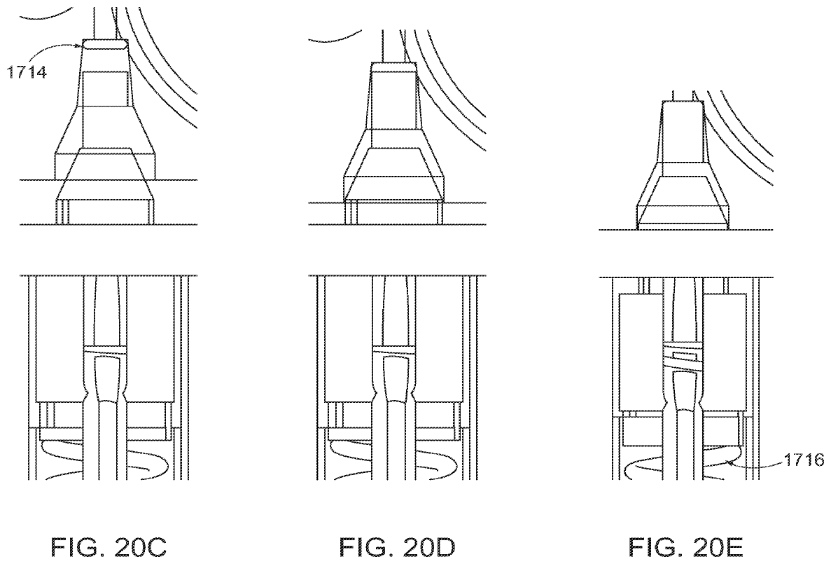

FIG. 20A schematically shows an exploded view of the interface between a microfluidic chip, cartridge and instrument interface. The microfluidic device 1702 is interfaced with or inserted into a cartridge 1704. The microfluidic device has six ports located at an edge of the device (see, e.g., FIGS. 2A, 5A, 6A, 7A, 8A) that interface with an edge of the cartridge. The cartridge comprises six fluid ports that align with the six ports of the microfluidic device and seal at the ports using an elastomeric material (e.g., gasket or 0-ring, not shown).

The cartridge 1704 is configured to interface with an instrument, which may be accomplished via an interface device 1706. The interface device 1706 comprises six independent spring-loaded fitting assemblies (also “interconnects” herein) 1710, which are configured to communicate fluidically and/or electrically with the cartridge and microfluidic device via the ports. The spring-loaded fitting assemblies couple to external fluid lines that provide, for example, the sample, anolyte, catholyte, mobilizing reagents, gas (e.g., for nebulization), etc. Each spring-loaded fitting assembly can be, for example, a conical fitting or a flat face-sealing fitting that mates with a fluid port. In such an example, the independently spring-loaded fittings comprise a conical fitting or a flat face-sealing fitting that mates with the six fluid ports via a hole 1712 in the microfluidic cartridge (only four of the six are indicated by arrows). In some aspects, hold 1712 can be tapered. The interface device 1706 may be configured to couple with the cartridge 1704 in a precise fashion using the locating pins 1708.

FIG. 20B schematically shows the interface between the microfluidic device, cartridge, and interface device in a “sealed” configuration. A clamping force 1712 may be applied to contact all three components, thereby establishing substantially leak-proof fluid communication.

FIGS. 20C-20E schematically show a cross-sectional view of the spring-loaded fitting assemblies in unloaded, contacted, and sealed configurations. FIG. 20C shows the spring-loaded fitting assembly in an unloaded configuration, in which the fluid interconnects are not contacting the elastomeric component 1714 of the cartridge. FIG. 20D shows the spring-loaded fitting assembly in a contacted configuration, in which the fluid interconnects are contacting the elastomeric component 1714 of the cartridge. FIG. 20E shows the spring-loaded fitting assembly in a sealed configuration, in which the fluid interconnects are contacting the elastomeric component 1714 of the cartridge (e.g., upon application of clamping force, such as 1612). In the sealed configuration, the cartridge is clamped to the interface device via the spring-loaded fittings and a seal force is generated between the tubing and the cartridge. The spring 1716 of the spring-loaded fittings aid in establishing a repeatable seal force.

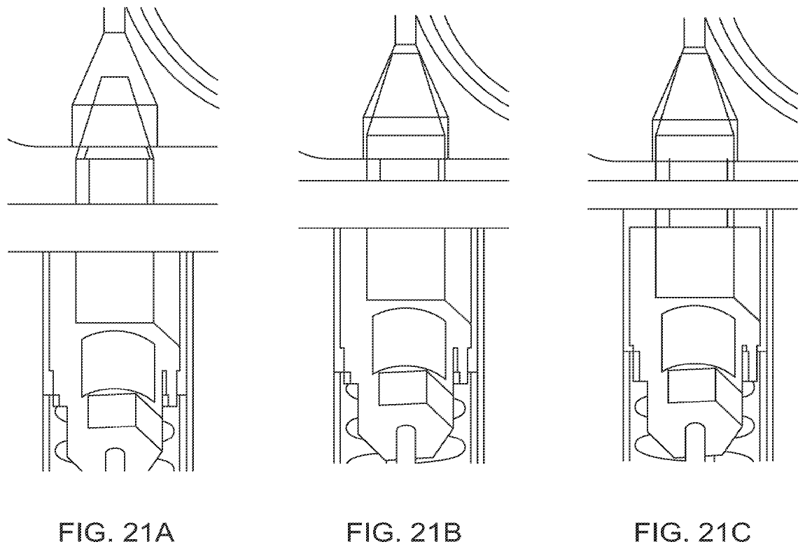

FIGS. 21A-21C schematically show a perspective view of the spring-loaded fitting assemblies in unloaded, contacted, and sealed configurations, as demonstrated in FIGS. 20C-20E.

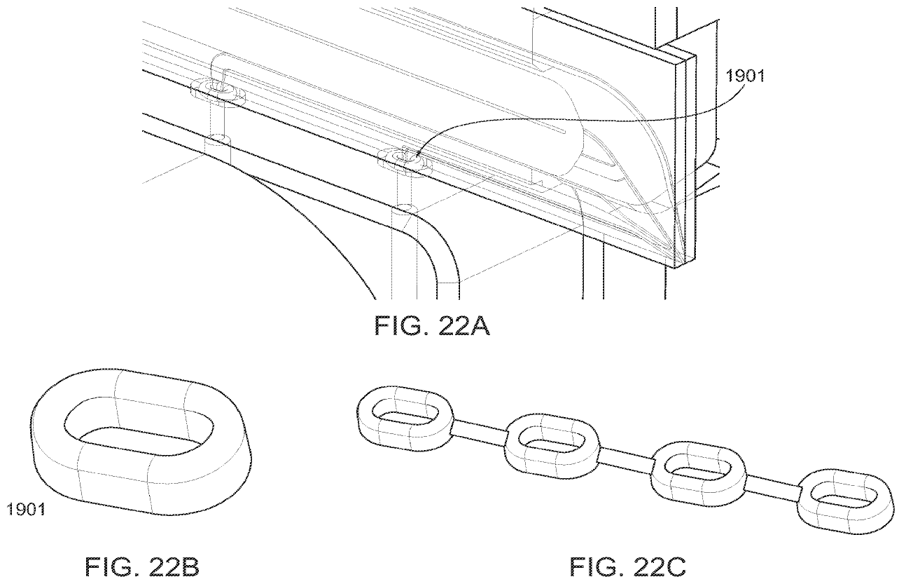

FIGS. 22A-22C schematically shows the interface between the microfluidic device and the cartridge. Referring to FIG. 22A-22B, the interface of the ports of the device and cartridge are elastomeric components 1901 (e.g., o-rings or gaskets), which aid in generating a substantially-leak proof seal between the cartridge and the device. In some embodiments, a set of connected gaskets may be used (e.g., in instances where the pitch or spacing between the ports of the device are the same), as shown in FIG. 22C.

### Example 10

### Computer Systems

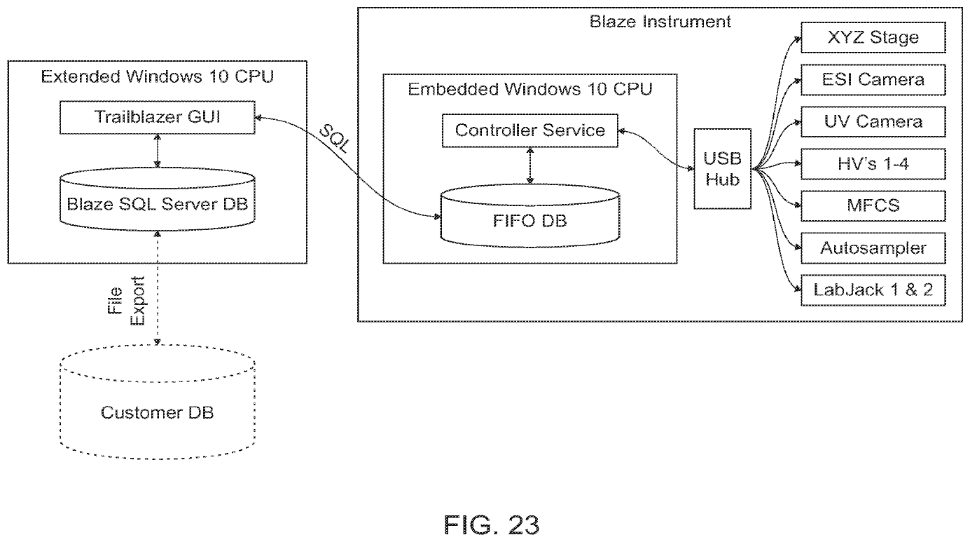

FIG. 23 shows an example software architecture system. The software architecture system may be integrated with the systems disclosed herein and may comprise one or more computer processors. In some instances, the one or more computer processors may be configured to collect and/or analyze data. The software architecture system may comprise a computer processing unit that comprises a controller service, which may be in communication with a first in first out (FIFO) database. In some instances, the FIFO database may be in communication with a second computer processor, which may comprise a graphical user interface and a server database. The second computer processor may be in communication, e.g., via cloud, with a customer database. In some instances, the computer processing unit may be in communication with one or more hardware units of the system (e.g., via a wired or wireless connection). For example, the computer processing unit may be connected via a USB hub to the stage, camera or cameras, high voltage power supplies, autosampler, flow control system (e.g., software and hardware for microfluidic flow control, e.g., Fluigent Inc.) and/or other lab equipment.

### Example 11

### Integrated Systems

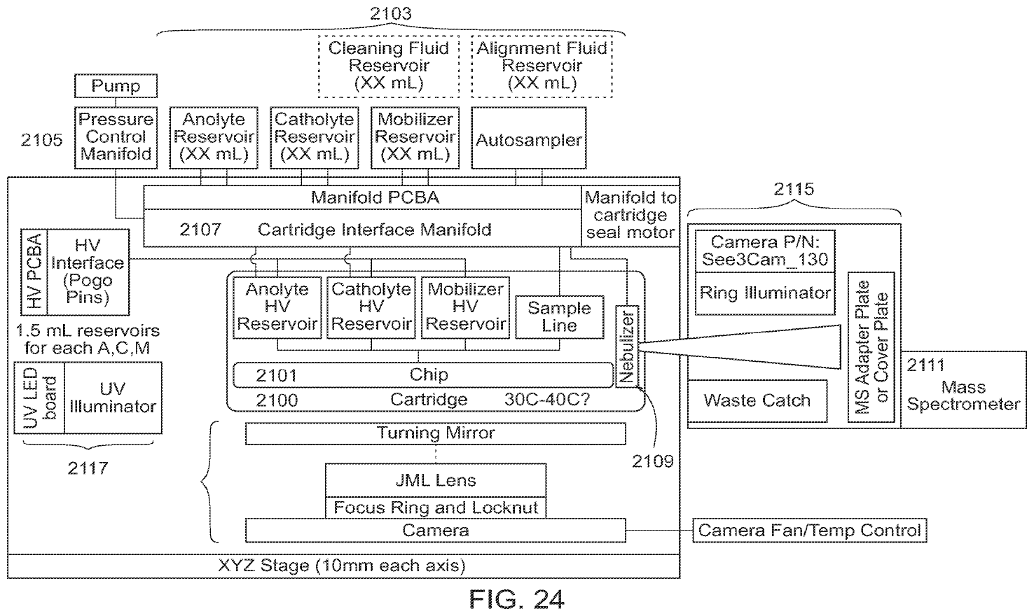

FIG. 24 shows an example block diagram of an integrated system. The integrated system may comprise one or more systems disclosed herein. The system may comprise an interfacing cartridge 2107, which may be in fluidic and/or electrical communication with a plurality of reservoirs 2103. For example, the interfacing cartridge 2107 may be connected to an anolyte reservoir, a catholyte reservoir, a mobilizer reservoir, and an autosampler unit. Alternatively, or in addition to, the interfacing cartridge 2107 may be in fluidic and/or electrical communication with a pressure control manifold 2105, which may be coupled to a fluid driving mechanism, e.g., a pump. The interfacing cartridge 2107 may be coupled to a cartridge 2100 which may comprise the device 2101. The device 2101 may be in electrical and/or fluidic communication with an anolyte high voltage reservoir, a catholyte high voltage reservoir, a mobilizer high voltage reservoir and a sample line. The anolyte high voltage reservoir, a catholyte high voltage reservoir, a mobilizer high voltage reservoir and a sample line may each be in fluidic and/or electrical communication with the interfacing cartridge 2107. The device 2101 may also be coupled to a waste management unit 2109, which may be used to direct waste away from the device 2101 and, in some instances, also be used to direct the sample to the downstream analysis unit 2111. In some embodiments, the waste management unit 2109 may comprise a nebulizer. In some instances, the downstream analysis unit 2111 may comprise a mass spectrometer.

The system may also comprise a plurality of imaging systems. For example, the system may comprise imaging system 2115, which may comprise a camera, an illuminator, a waste receptacle, and/or an adaptor, which may be used to interface with the analysis unit 2111. The system may also comprise imaging system 2117, which may comprise an illuminator (e.g., UV illumination source), a mirror, and/or a camera or other suitable detector. In some instances, the detector (e.g., camera) may be connected to a cooling source, e.g., fan or other temperature control platform.

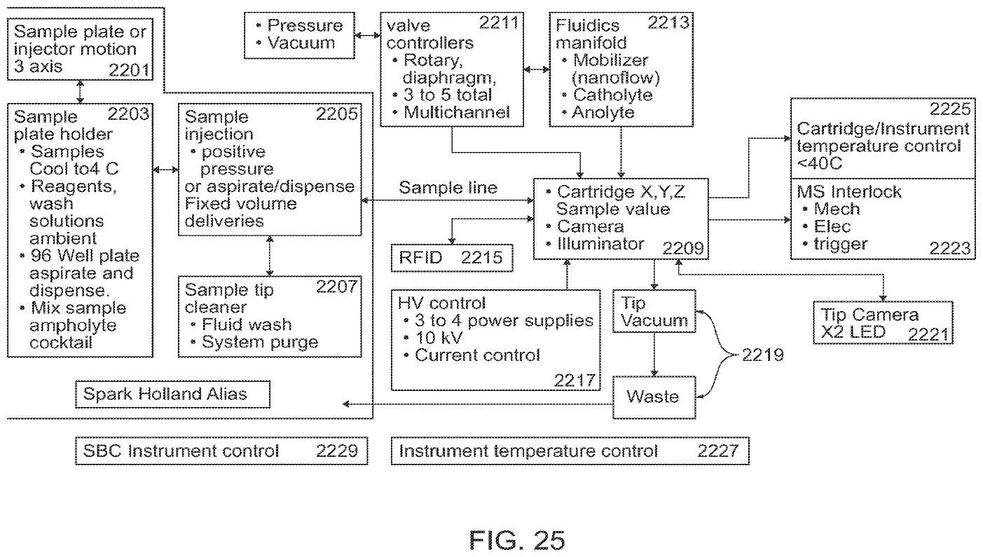

FIG. 25 shows an example block diagram of an integrated system. The system may comprise a sample 2201, a sample and reagent holder and/or processor 2203, which may be configured to store the samples and process the samples (e.g., mix, add reagents, aspirate or dispense samples, etc.), a sample injector 2205, and a sample tip cleaner 2207. The sample tip cleaner may comprise mechanisms to wash the sample and/or the system. The system may also comprise a separation unit 2209, which may comprise a cartridge comprising the device, an imaging system (e.g., UV illuminator and camera). The separation unit may be coupled to a plurality of controllers 2211, which may comprise fluid controls using negative pressure (e.g., vacuum) or positive pressure (e.g., rotary or diaphragm pumps, valves, etc.). The controllers 2211 and/or the separation unit 2209 may be coupled to a fluidics manifold 2213, which may comprise one or more reagent-containing reservoirs.

The separation unit 2209 may be used to perform a separation reaction (e.g., isoelectric focusing) and/or a mobilization reaction. The separation unit 2209 may be connected to or coupled to a communication interface 2215 (e.g., RFID), a high voltage power supply 2217, a waste management unit 2219 (e.g., vacuum and waste receptacle), another imaging unit 2221, and/or a downstream analysis unit 2223 (e.g., a mass spectrometer). In some instances, the separation unit 2209 may be coupled to a temperature control unit 2225. In some instances, one or more systems described herein may comprise a temperature control unit 2227 and/or other control unit, e.g., for instrument control 2229.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A microfluidic chip comprising:
a) a substrate, wherein the substrate comprises:
i) a fluid channel comprising a distal end that is in fluid communication with an electrospray ionization orifice; and
ii) a gas channel comprising a distal end that is in fluid communication with a gas outlet orifice disposed adjacent to the electrospray ionization orifice;
wherein an angle between the distal end of the fluid channel and the distal end of the gas channel ranges from about 0 degrees to about 30 degrees.

2. The microfluidic chip of claim 1, wherein the electrospray ionization orifice is disposed on an edge or corner or tip of the substrate.

3. The microfluidic chip of claim 2, wherein the gas outlet orifice is disposed an edge of the substrate adjacent to the electrospray ionization orifice.

4. The microfluidic chip of any one of claims 1 to 3, wherein the substrate comprises two or more gas channels, each of which comprises a distal end that is in fluid communication with a gas outlet orifice.

5. The microfluidic chip of claim 4, wherein the two or more gas outlet orifices are disposed adjacent to and symmetrically about the electrospray ionization orifice.

6. The microfluidic chip of any one of claims 1 to 5, wherein the angle ranges from about 10 degrees to about 20 degrees.

7. The microfluidic chip of any one of claims 1 to 5, wherein the angle is about 15±5 degrees.

8. The microfluidic chip of any one of claims 1 to 7, wherein the gas outlet orifice is configured to perform nebulization of a solution expelled from the electrospray ionization orifice.

9. The microfluidic chip of any one of claims 1 to 8, wherein the microfluidic device comprises three or more gas channels each comprising a gas outlet orifice disposed adjacent to the electrospray ionization orifice.

10. The microfluidic chip of claim 9, wherein at least one of the three or more gas channels are disposed within the substrate, and at least one of the three or more gas channels are disposed within an auxiliary component of the microfluidic chip that is positioned adjacent to the substrate such that the at least one gas channels are not located within a same plane as the substrate.

11. The microfluidic chip of claim 10, wherein the at least one of the three or more gas channels disposed within the auxiliary component are positioned such that their gas outlet orifices lie in a plane that is substantially perpendicular to that of the substrate and are positioned symmetrically about and adjacent to the electrospray ionization orifice.

12. The microfluidic chip of claim 11, wherein the at least one of the three or more gas channels that are disposed within the auxiliary component are positioned such that their gas outlet orifices lie in one or more planes that are rotated relative to that of the substrate and are positioned in a radially-symmetric pairwise manner about and adjacent to the electrospray ionization orifice.

13. The microfluidic chip of any one of claims 1 to 12, wherein the fluid channel comprises a separation channel.

14. The microfluidic chip of any one of claims 1 to 13, wherein the microfluidic chip is configured to perform an isoelectric focusing or electrophoretic separation of a sample comprising a mixture of analytes in the fluid channel.

15. The microfluidic chip of any one of claims 1 to 14, wherein the fluid channel has a width ranging from about 20 μm to about 600 μm.

16. The microfluidic chip of any one of claims 1 to 15, wherein the fluid channel has a depth ranging from about 10 μm to about 100 μm.

17. The microfluidic chip of any one of claims 1 to 16, wherein the fluid channel has a length ranging from about 0.25 cm to about 30 cm.

18. The microfluidic chip of any one of claims 1 to 17, wherein the electrospray ionization orifice has a substantially square, rectangular, circular, ovoid, or lozenge-shaped cross-section.

19. The microfluidic chip of any one of claims 1 to 18, wherein the electrospray ionization orifice has a maximum cross-sectional dimension ranging from about 10 μm to about 100 μm.

20. The microfluidic chip of any one of claims 1 to 19, wherein the gas channel has a width ranging from about 20 μm to about 200 μm.

21. The microfluidic chip of any one of claims 1 to 20, wherein the gas channel has a depth ranging from about 10 μm to about 100 μm.

22. The microfluidic chip of any one of claims 1 to 21, wherein the gas channel has a length ranging from about 0.2 cm to about 20 cm.

23. The microfluidic chip of any one of claims 1 to 22, wherein the gas outlet orifice has a substantially square, rectangular, circular, ovoid, or lozenge-shaped cross-section.

24. The microfluidic chip of any one of claims 1 to 23, wherein the gas outlet orifice has a maximum cross-sectional dimension ranging from about 10 μm to about 50 μm.

25. The microfluidic chip of any one of claims 1 to 24, wherein the gas outlet orifice is disposed within 100 μm of the electrospray ionization orifice.

26. The microfluidic chip of any one of claims 1 to 25, wherein the gas outlet orifice is disposed within 50 μm of the electrospray ionization orifice.

27. The microfluidic chip of any one of claims 1 to 26, wherein the gas outlet orifice is disposed within 15 μm of the electrospray ionization orifice.

28. The microfluidic chip of any one of claims 1 to 27, wherein the substrate is fabricated from glass, silicon, a polymer, or any combination thereof.

29. A microfluidic chip comprising:
a) a substrate, wherein the substrate comprises:
i) two or more gas channels of different lengths, each configured to deliver a gas to a gas outlet orifice;
wherein a dimension of at least one of the two or more gas channels is adjusted along a portion of its length so that each of the two or more gas channels has about the same hydrodynamic flow resistance.

30. The microfluidic chip of claim 29, wherein a cross-sectional area of at least one of the two or more gas channels is adjusted along a portion of its length.

31. The microfluidic chip of claim 29 or claim 30, wherein a minimum difference in length of the two or more gas channels ranges from about 1 cm to about 10 cm.

32. The microfluidic chip of any one of claims 29 to 31, wherein a maximum difference in length of the two or more gas channels ranges from about 1 cm to about 10 cm.

33. The microfluidic chip of any one of claims 29 to 32, wherein the substrate further comprises a fluid channel comprising a distal end that is in fluid communication with an electrospray ionization orifice.

34. The microfluidic chip of claim 33, wherein the two or more gas outlet orifices are disposed symmetrically about and adjacent to the electrospray ionization orifice and are configured to perform nebulization of a solution expelled from the electrospray ionization orifice.

35. The microfluidic chip of any one of claims 33 to 34, wherein the electrospray ionization orifice is disposed on an edge or corner of the substrate.

36. The microfluidic chip of claim 35, wherein the two or more gas outlet orifices are disposed on an edge of the substrate adjacent to the electrospray ionization orifice.

37. The microfluidic chip of any one of claims 29 to 36, wherein the fluid channel comprises a separation channel.

38. The microfluidic chip of any one of claims 29 to 37, wherein the microfluidic chip is configured to perform isoelectric focusing or electrophoretic separations.

39. The microfluidic chip of any one of claims 29 to 38, wherein the gas is a nebulizer gas.

40. The microfluidic chip of claim 39, wherein the nebulizer gas comprises air, nitrogen, oxygen, nitrous oxide, fluorourethane, helium, argon, methanol, or any combination thereof.

41. The microfluidic chip of any one of claims 35 to 40, further comprising a hydrophobic coating on at least a portion of an edge of the substrate or corner of the substrate on which the electrospray ionization orifice is disposed.

42. A microfluidic chip comprising:
a) a substrate, wherein the substrate comprises:
i) a fluid channel comprising a proximal end that is in fluid communication with a fluid inlet port and a distal end that is in fluid communication with an electrospray ionization orifice; and
ii) at least two gas channels, each comprising a proximal end that is in fluid communication with a gas inlet port and a distal end in fluid communication with a gas outlet orifice;
wherein the at least one fluid inlet port and the at least two gas inlet ports are disposed along a first edge of the substrate.

43. The microfluidic chip of claim 42, wherein the electrospray ionization orifice is positioned on a second edge of the substrate.

44. The microfluidic chip of claim 43, wherein the electrospray ionization orifice is positioned on a corner of the substrate that does not comprise the first edge.

45. The microfluidic chip of any one of claims 42 to 44, wherein the substrate is less than about 2.0 mm thick.

46. The microfluidic chip of any one of claims 42 to 45, wherein the fluid channel comprises a separation channel configured to perform an electrophoretic separation.

47. The microfluidic chip of any one of claims 42 to 45, wherein the fluid channel comprises a separation channel configured to perform an isoelectric focusing separation.

48. The microfluidic chip of any one of claims 46 to 47, wherein the substrate comprises a first separation channel and a second separation channel, wherein a distal end of the first separation channel is in fluid communication with a proximal end of the second separation channel, and wherein a distal end of the second separation channel is in fluid communication with the electrospray ionization orifice.

49. The microfluidic chip of claim 48, wherein the first separation channel is configured to perform a chromatographic separation, and wherein the second separation channel is configured to perform an electrophoretic separation.

50. The microfluidic chip of claim 48, wherein the first separation channel is configured to perform a chromatographic separation, and wherein the second separation channel is configured to perform an isoelectric focusing separation.

51. The microfluidic chip of any one of claims 42 to 50, wherein the fluid channel comprises a separation channel configured to perform isoelectric focusing separation of a sample comprising a mixture of analytes, and the substrate further comprises a mobilization electrolyte channel that is in fluid communication with a distal end of the separation channel and is configured to provide electrophoretic introduction of a mobilization electrolyte at the distal end of the separation channel.

52. A method for performing electrospray ionization from a microfluidic chip comprising:
a) providing a microfluidic chip comprising a substrate, wherein the substrate comprises:
i) at least one fluid channel comprising a distal end that is in fluid communication with an electrospray ionization orifice; and
ii) at least one gas channel configured to deliver a gas to a gas outlet orifice that is adjacent to the electrospray ionization orifice;
b) flowing a solution through the at least one fluid channel such that the solution is expelled from the electrospray ionization orifice; and
c) flowing a gas through the at least one gas channel such that the gas is expelled from the gas outlet orifice;
wherein a temperature of the substrate is controlled by a temperature of the gas flowing through the at least one gas channel.

53. The method of claim 52, wherein the temperature of the gas ranges from about 4° C. to about 100° C.

54. The method of claim 52 or claim 53, wherein the temperature of the substrate ranges from about 10° C. to about 50° C.

55. The method of any one of claims 52 to 54, wherein the average temperature of the substrate is held at 30±5° C.

56. The method of any one of claims 52 to 55, wherein the at least one fluid channel comprises a separation channel.

57. The method of claim 56, wherein the separation channel is configured to perform an isoelectric focusing separation of a sample comprising a mixture of analytes.

58. The method of claim 56, wherein the separation channel is configured to perform an electrophoretic separation of a sample comprising a mixture of analytes.

59. The method of any one of claims 52 to 58, wherein an electrospray ionization performance achieved when the microfluidic chip is configured to introduce a sample into a mass spectrometer is characterized by a less than a 1.0% standard error fluctuation in total mass spectrometric signal intensity.

60. The method of any one of claims 52 to 59, wherein an electrospray ionization performance when the microfluidic chip is configured to introduce a sample into a mass spectrometer is characterized by a less than a 0.1% standard error fluctuation in total mass spectrometric signal intensity.

61. A method for providing stable electrospray ionization performance comprising:
a) providing a microfluidic chip comprising a substrate, wherein the substrate comprises: (i) a fluid channel having a distal end that is in fluid communication with an electrospray ionization orifice, and (ii) a gas channel having a distal end that is in fluid communication with a gas outlet orifice;
b) flowing a solution through the fluid channel;
c) flowing a gas through the gas channel; and
d) controlling a flow rate of the gas and a flow rate of the solution such that a ratio of volumetric flow rates for the gas and solution ranges from 1000:1 to 1,000,000:1.

62. The method of claim 61, wherein the ratio of volumetric flow rates for the gas and solution ranges from 10,000:1 to 500,000:1.

63. The method of claim 61 or claim 62, wherein the flow of solution is controlled by pressure, gravity, an electrokinetic force, or any combination thereof.

64. The method of any one of claims 61 to 63, wherein the flow of gas is provided by a compressed gas source.

65. The method of any one of claims 61 to 64, wherein the volumetric flow rate for the solution is less than 25 μL/min.

66. The method of any one of claims 61 to 65, wherein the microfluidic chip comprises two or more gas channels, each comprising a distal end that is in fluid communication with a gas outlet orifice, and wherein the two or more gas outlet orifices are disposed symmetrically about and adjacent to the electrospray ionization orifice.

67. The method of any one of claims 61 to 66, wherein the electrospray ionization orifice is disposed on an edge or corner of the substrate.

68. The method of claim 67, wherein the one or more gas outlet orifices are disclosed adjacent to the electrospray ionization orifice on an edge of the substrate.

69. The method of any one of claims 61 to 68, wherein an electrospray ionization performance achieved when the microfluidic chip is configured to introduce a sample into a mass spectrometer is characterized by a less than a 1.0% standard error fluctuation in total mass spectrometric signal intensity.

70. The method of any one of claims 61 to 69, wherein an electrospray ionization performance when the microfluidic chip is configured to introduce a sample into a mass spectrometer is characterized by a less than a 0.1% standard error fluctuation in total mass spectrometric signal intensity.

71. A method for providing stable electrospray ionization performance comprising:
a) providing a microfluidic chip comprising a substrate, wherein the substrate comprises: (i) a fluid channel having a distal end that is in fluid communication with an electrospray ionization orifice, and (ii) a gas channel having a distal end that is in fluid communication with a gas outlet orifice;
b) flowing a solution through the fluid channel;
c) flowing a gas through the gas channel; and
d) controlling a flow rate of the gas and a flow rate of the solution such that a ratio of flow velocity for the gas at the gas outlet orifice and flow velocity for the solution at the electrospray ionization orifice ranges from 100:1 to 1,000,000:1.

72. The method of claim 71, wherein the ratio of flow velocity for the gas at the gas outlet orifice and flow velocity for the solution at the electrospray ionization orifice ranges from 500:1 to 5,000:1.

73. The method of claim 71 or claim 72, wherein the ratio of flow velocity for the gas at the gas outlet orifice and flow velocity for the solution at the electrospray ionization orifice ranges from 1,000:1 to 3,000:1.

74. A microfluidic cartridge comprising:
a) a microfluidic chip comprising at least one fluid port and at least two gas ports disposed on an edge of the microfluidic chip; and
b) a microfluidic cartridge component that is in fluid communication with the microfluidic chip and is configured to encompass at least a portion of the microfluidic chip, the microfluidic cartridge component comprising at least one fluid port and at least two gas ports that align with the at least one fluid port and at least two gas ports of the microfluidic chip.

75. The microfluidic cartridge of claim 74, further comprising one or more elastomeric components disposed between the edge of the microfluidic chip and a surface of the cartridge; and wherein the one or more elastomeric components form a substantially leak-proof seal between the at least one fluid port and at least two gas ports of the microfluidic chip and the at least one fluid port and at least two gas ports of the microfluidic cartridge component upon application of force.

76. The microfluidic cartridge of claim 74 or claim 75, wherein the edge of the microfluidic chip is less than about 2.0 mm thick.

77. The microfluidic cartridge of any one of claims 74 to 76, wherein the edge of the microfluidic chip is about 1±0.4 mm thick.

78. A system comprising:
a) a microfluidic cartridge comprising two or more fluid ports and configured to be removeable from the system; and
b) an instrument comprising two or more fluid interconnects;
wherein each of the two or more fluid interconnects is configured to provide a substantially leak-proof fluid coupling between a fluid line of the instrument and a fluid port of the microfluidic cartridge upon application of force to an assembly comprising the two or more fluid interconnects and the two or more fluid ports of the microfluidic cartridge, and
wherein the substantially leak-proof fluid couplings are maintained when a relative fluid pressure within two of the two or more fluid lines varies by a factor of at least 10-fold.

79. The system of claim 78, wherein the substantially leak-proof fluid couplings are maintained when the relative fluid pressure within two of the two or more fluid lines varies by a factor of at least 100-fold.

80. The system of claim 78 or claim 79, wherein each of the two or more fluid interconnects comprises an independently spring-loaded fitting.

81. The system of claim 80, wherein the independently spring-loaded fittings comprise a flat face-sealing fitting that mates with a fluid port comprising a hole in the microfluidic cartridge.

82. The microfluidic chip of any one of claims 1 to 8, wherein the microfluidic device comprises three or more gas channels each comprising a gas outlet orifice disposed immediately adjacent to the electrospray ionization orifice.

83. The microfluidic chip of claim 82, wherein at least one of the three or more gas channels are disposed within the substrate, and at least one of the three or more gas channels are disposed within an auxiliary component of the microfluidic chip that is positioned immediately adjacent to the substrate such that the at least one gas channels are not located within a same plane as the substrate.

84. The microfluidic chip of claim 83, wherein the at least one of the three or more gas channels disposed within the auxiliary component are positioned such that their gas outlet orifices lie in a plane that is substantially perpendicular to that of the substrate and are positioned symmetrically about and immediately adjacent to the electrospray ionization orifice.

85. The microfluidic chip of claim 84, wherein the at least one of the three or more gas channels that are disposed within the auxiliary component are positioned such that their gas outlet orifices lie in one or more planes that are rotated relative to that of the substrate and are positioned in a radially-symmetric pairwise manner about and immediately adjacent to the electrospray ionization orifice.

86. The microfluidic chip of claim 47, wherein isoelectric focusing is performed while flowing a fluid from the fluid inlet port through the separation channel.

87. The microfluidic chip of claim 48, wherein electro spray ionization is performed while flowing a fluid from the fluid inlet port through the first and second separation channels.
